(19) United States
(12) Patent Application Publication
(10) Pub. No.: US 2011/0161110 A1
(43) Pub. Date: Jun. 30, 2011

(54) System And Method For An Online Platform Distributing Condition Specific Programs Used For Monitoring The Health Of A Participant And For Offering Health Services To Participating Subscribers

(76) Inventor: James R. Mault, Evergreen, CO (US)

(21) Appl. No.: 12/899,522

(22) Filed: Oct. 6, 2010

Related U.S. Application Data
(60) Provisional application No. 61/249,163, filed on Oct. 6, 2009.
(60) Provisional application No. 61/356,448, filed on Jun. 18, 2010.
(60) Provisional application No. 61/356,452, filed on Jun. 18, 2010.
(60) Provisional application No. 61/356,456, filed on Jun. 18, 2010.
(60) Provisional application No. 61/356,509, filed on Jun. 18, 2010.

(51) Int. Cl. G06Q 50/00

(52) U.S. Cl. 705/3

(57) ABSTRACT

A system and method for monitoring are described providing for online and/or remote monitoring of a participant, in accordance with one embodiment of the present invention. The system includes a first network access device providing access to a communication network. The first network access device is associated with a participant or user, and allows the user to access the communication network (e.g., accessing web sites on the interne). Also, the system includes a second network access device providing access the communication network. The second network access device is associated with a monitoring agent. The system includes a library of programs for use in monitoring users. For instance, one program monitors the health of a participant. Also, a program in the library of programs is assigned to the user. The program includes at least one interactive logic tree where upon completion by the user reaches a result. The system also includes a central platform for providing access and control over the library of programs through the communication network. For instance, the user is able to access the program through the central platform for purposes of execution. The system also includes a data store for storing responses and results of the user in association with said program. As such, the monitoring agent is able to monitor any responses and results stemming from the execution of the program through the central platform. Also, the system includes an action module for performing an appropriate action based on the result.

### CROSS REFERENCE TO RELATED APPLICATIONS

The present application claims priority to and the benefit of U.S. Provisional Patent Application No. 61/249,163, entitled “System And Method For An Online Platform Distributing Condition Specific Programs Used For Monitoring The Health Of A Participant And For Offering Health Services To Participating Subscribers,” filed on Oct. 6, 2009, which is herein incorporated by reference in its entirety; claims priority to and the benefit of U.S. Provisional Patent Application No. 61/356,448, entitled “System and Method for Connected Health Scheduling,” filed on Jun. 18, 2010, which is herein incorporated by reference in its entirety; claims priority to and the benefit of U.S. Provisional Patent Application No. 61/356,452, filed on Jun. 18, 2010, entitled “System and Method for a Health Campaign Manager,” which is herein incorporated by reference in its entirety; claims priority to and the benefit of U.S. Provisional Patent Application No. 61/356,456, filed Jun. 18, 2010, entitled “System and Method for a Single Session Assessment Tool,” which is herein incorporated by reference in its entirety; and claims priority to and the benefit of U.S. Provisional Patent Application No. 61/356,509, filed Jun. 18, 2010, entitled “System and Method for a Records Management and Permissioning System,” which is herein incorporated by reference in its entirety.

### BACKGROUND OF THE INVENTION

1. Field of the Invention

The present invention relates to providing health care and more specifically to the implementation of an online platform providing for monitoring conditions of a patient, the sharing of medical information, and the distribution of messages to a community involved in the care of the patient.

2. The Relevant Technology

The medical industry welcomes new ways to provide better care for individuals and for groups of individuals. Some traditional patient/doctor relationships involve having a patient visit his or her doctor for a one-time or on-going treatment of a condition or for performing check-up for purposes of monitoring the health of the patient. While this face-to-face visit importantly furthers the in-person relationship between a patient and the doctor, much time is required both on behalf of the doctor and the patient.

For a doctor who practices this traditional patient/doctor relationship, the doctor is limited in the number of patients to whom he or she can effectively provide health services. In addition, this in-person delivery of health care also limits the types of services that the doctor can provide to the patient.

It is desirous to explore additional services that a doctor can provide to patients. In this way, the patient is able to receive even better care that a traditional in-person visit to the doctor provides.

### SUMMARY OF THE INVENTION

The present invention relates to the field of providing medical services. Specifically, the present invention relates to a revenue-generating, centralized platform, also referred to as the “Healthy Circles Platform,” which enables individuals to subscribe to online, condition-specific Health Programs that monitor signs, symptoms, medications, vitals, etc., and provides automated feedback and alerts based on rules logic criteria developed and branded by trusted medical organizations, in accordance with one embodiment of the present invention. In addition, the Healthy Circles Platform is compatible with and includes a storage system (e.g., HealthVault system) for storing information and data associated with patients and subscribers.

Additionally, the Healthy Circles Platform serves as an enterprise solution for healthcare institutions (hospitals, clinics, disease management organizations, etc.) and healthcare professionals to offer health monitoring and health services delivered over a communication network (e.g., telehealth services) direct to subscribing consumers (e.g., those who subscribe to the “Healthy Circles Health Monitoring Service”) in accordance with one embodiment of the present invention.

In one implementation, a system for monitoring is described that provides for online monitoring of a participant, in accordance with one embodiment of the present invention. The system includes a first network access device providing access to a communication network. The first network access device is associated with a participant or user, such as a patient, and allows the participant to access the communication network (e.g., accessing web sites on the internet). Also, the system includes a second network access device providing access the communication network. The second network access device is associated with a monitoring agent, such as a health care professional (e.g., medical doctor, etc.). The system includes a library of programs for use in monitoring conditions of participants. For instance, one program monitors the health of a participant, and may be assigned to the participant by a health care professional (e.g., medical doctor). The program comprises at least one interactive and rules based logic tree, wherein upon completion by the participant reaches a result. The system also includes a central platform for providing access and control over the library of programs through the communication network. For instance, the participant is able to access the program through the central platform for purposes of execution. The system also includes a data store for storing responses and results of the user in association with said program. As such, the monitoring agent is able to monitor any responses and results from the execution of the health program by a participant trough the central platform. Also, the system includes an action module for performing an appropriate action based on the result.

In another embodiment, a method for monitoring is disclosed that is implemented through a central platform supporting the coordinated care of patients by members of a health care team. The method includes receiving a request for a health program over a communication network by a network access device associated with a user. The health program comprises a rules based logic tree intended for interaction by a participant (e.g., patient) and is used for purposes of monitoring a condition of the participant. In addition, the method includes providing the health program to the network access device for interaction by the participant. One or more responses are received from the network access device through the course of interaction by the participant. A result is determined based on the one or more responses received through participant interaction. The one or more responses and the result are provided to the monitoring agent for purposes of monitoring a condition of the participant.

In still another embodiment, a platform for providing medical information is disclosed. The platform includes a records manager for managing a first health record of a patient. The records manager obtains information used in the health record from at least one of a plurality of information sources related to the patient and/or members of a health care team providing coordinated care to the patient. Further, the platform includes a data store for storing the first health record. A data exchange hub is included in the platform for providing access to the health record to the patient and members of said health care team for purposes of providing coordinated care to the patient.

Another embodiment discloses a method for providing care to one or more patients, and more specifically to a method for generating an interactive health program used for monitoring a condition of one or more patients. The method includes providing access to an account associated with a health care professional through a professional portal. Access to the account is implemented through a central platform (e.g., Health Circles Platform) accessible by a patient and members of a health care team involved in the coordinated care of the patient. The method includes receiving at least one definition through the account to generate a health program comprising a rules based logic tree for purposes of monitoring a condition of a responder, such as a patient. A result is established based on a set of proposed responses to the logic tree. The health program is made available to a responder through a patient portal supporting the central platform.

Still another embodiment discloses a system for providing care to one or more patients, and more specifically to a system for generating an interactive health program used for monitoring a condition of one or more patients. The system includes a professional portal for providing access to health care professionals to a central platform supporting a patient and members of a health care team for purposes of providing coordinated care to the patient. The system also includes a patient's portal for providing access to patients to the central platform. An account manager is included for providing access to an account associated with a health care professional through the professional portal. In addition, a program authoring tool is included for receiving at least one definition through the account to generate a health program comprising a rules based logic tree, wherein the logic tree is used for purposes of monitoring a condition of a responder, such as the patient. A result is defined based on a set of proposed responses to the logic tree. In addition, the patient's portal makes the health program accessible to the responder, such as the patient.

Another embodiment discloses a method for providing care to one or more patients, and more specifically to a method for facilitating communication between a patient and members of a health care team providing coordinated care to the patient. The method includes defining the health care team comprising one or more members, such as a health care professional, a family care giver, etc. The method also includes establishing a bulletin board associated with the patient. The bulletin board facilities communication between the patient and members of the health care team. Access privileges are defined for the members of the health care team that establish which members can access the bulletin board. The method also includes receiving a message from one of a group consisting of the patient and members of the patient's health care team. The message is posted to the bulletin board. Access to the message posted on the bulletin board is provided to member of the health care team having access privileges.

Still another embodiment discloses a system for providing care to a patient, and more specifically to a system for facilitating communication between a patient and members of a health care team providing coordinated care to the patient. The system includes the health care team providing coordinated care to the patient. A bulletin board is included in the system that is associated with the patient. The bulletin board is managed by the central platform accessible by a patient and members of the health care team, wherein the central platform facilitates coordinated care of the patient. The system includes one or more access privileges defining access to the bulletin board for the members of the health care team. The system also includes a message center for providing access to the bulletin board to members of the health care team having access privileges.

In another embodiment, a platform is disclosed for providing care to a patient, and more specifically to a platform for facilitating communication between the patient and members of a health care team providing coordinated care to the patient. The platform includes the health care team providing coordinated care to the patient. The system also includes a records manager for managing a health record of the patient. The records manager obtains information used in the health record from at least one of a plurality of information sources related to the patient and/or members of the health care team. For instance, the health record may be maintained by the patient, and as such, the patient delivers the information to the records manager for inclusion in the health record. In another instance, the health record is maintained by a health care professional, or a related organization supporting the health care professional. Information may be sent to the records manager by the health care professional for inclusion into the health record. In addition, the records manager may access a records management system implemented by the health care professional in order to access information for inclusion into the health record. Further, the platform includes a data store for storing the health record. The system also includes a message for providing access to a message sent to a recipient, wherein the message is sent between a group consisting of the patient and members of the patient's health care team.

In still another embodiment, a platform is disclosed for providing medical information, and more specifically for providing granular access to medical information. The platform includes a records manager for managing a health record related to a patient. The health record is created by an originator, such as the patient, or a health care professional providing care to the patient. The records manager obtains information used in the health record from at least one of a plurality of information sources related to the patient and/or members of the health care team. For instance, the health record may be maintained by the patient, and as such, the patient delivers the information to the records manager for inclusion in the health record. In another instance, the health record is maintained by a health care professional, or a related organization supporting the health care professional. Information may be sent to the records manager by the health care professional for inclusion into the health record. In addition, the records manager may access a records management system implemented by the health care professional in order to access information for inclusion into the health record. The health record includes at least one data type comprising information. That is, information in the health record is categorized into data types, such as blood type, lab results, etc. In addition, the platform includes a data store for storing the health record. Also, a data exchange hub is included for providing access to the health record to said patient and members of a health care team providing care to said patient, wherein access is controlled by said originator.

A method for providing medical information, and more specifically for providing granular access to medical information is disclosed. The method includes managing a health record of a patient, wherein the health record is created by an originator. For instance, a records manager obtains information used in the health record from at least one of a plurality of information sources related to the patient and/or members of the health care team. In one case, the health record may be maintained by the patient, and as such, the patient delivers the information to the records manager for inclusion in the health record. In another instance, the health record is maintained by a health care professional, or a related organization supporting the health care professional. Information may be sent to the records manager by the health care professional for inclusion into the health record. In addition, the records manager may access a records management system implemented by the health care professional in order to access information for inclusion into the health record. The method includes defining at least one data type comprising information included in the health record. That is, information in the health record is categorized into data types, such as blood type, lab results, etc. The method also includes storing of the health record in a data store. Also, access to the health record is provided to the patient and/or members of the health care team providing coordinated care to the patient, wherein the access is controlled by the originator of the health record.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1A is an illustration of a system including a central platform for use in monitoring participants, in accordance with one embodiment of the present invention.

FIG. 1B is an illustration of the implementation of a health monitoring system, in accordance with one embodiment of the present invention.

FIG. 2A is a flow chart illustrating a method for monitoring, in accordance with one embodiment of the present invention.

FIG. 2B is a flow chart illustrating a method for monitoring as implemented within an automated health monitoring program, in accordance with one embodiment of the present invention.

FIG. 2C is a flow chart illustrating a method for HCPs to utilize the Healthy Circles Platform to provide health care services and monitoring of patients, in accordance with one embodiment of the present invention.

FIG. 3 is a block diagram illustrating a central platform for monitoring participants, in accordance with one embodiment of the present invention.

FIG. 4 is a diagram of a dashboard 400 providing the monitoring of one or more patients in relation to one or more conditions, in accordance with one embodiment of the present invention.

FIG. 5 is a block diagram of a platform including a program authoring tool used for monitoring a condition of a participant in a health program, in accordance with one embodiment of the present invention.

FIG. 6 is a screen shot of an interface allowing a user to create a program within the Program Authoring Tool (PAT), in accordance with one embodiment of the present invention.

FIG. 7 is a screen shot illustrating the interface by which the HCP is able to edit the above information, in accordance with one embodiment of the present invention.

FIG. 8 is a screen shot illustrating a query group interface, in accordance with one embodiment of the present invention

FIG. 9 is a screen shot illustrating the selection of the vital signs category, in accordance with one embodiment of the present invention.

FIG. 10 is a screen shot illustrating a sample question response and follow-up comments, in accordance with one embodiment of the present invention.

FIG. 11 is a screen shot illustrating a program manager interface allowing for an overall view into the questions in a query group, in accordance with one embodiment of the present invention.

FIG. 12 is an illustration of a query group and the tree logic associated with that query group, in accordance with one embodiment of the present invention.

FIG. 13A is a screen shot of a session preview widget, in accordance with one embodiment of the present invention.

FIG. 13B is a screen shot of a session calendar widget, in accordance with one embodiment of the present invention.

FIG. 14 is a flow chart illustrating a method for providing care, and more specifically, for generating a health program used for monitoring a condition of a participant, in accordance with one embodiment of the present invention.

FIG. 15 is a block diagram of a system capable of providing a bulletin board posting messages, and providing access to those having access privileges in a group including a patient and members of a health care team providing care to the patient, in accordance with one embodiment of the present invention.

FIG. 16 is a flow chart illustrating a method for providing care, and more specifically for establishing a bulletin board to which messages are posted, wherein access to the bulletin board is provided to members of the health care team having access privileges, in accordance with one embodiment of the present invention.

FIG. 17 is a block diagram of a system capable of providing a message center facilitating communication between members of a group including a patient and members of a health care team providing care to the patient, in accordance with one embodiment of the present invention.

FIG. 18 is a diagram illustrating a bulletin board associated with a patient, in accordance with one embodiment of the present invention.

FIG. 19 is a block diagram of a system providing granular access to information in a health record, in accordance with one embodiment of the present invention.

FIG. 20 is a flow chart illustrating a method for providing granular access to information in a health record, in accordance with one embodiment of the present invention.

FIG. 21 is a diagram illustrating access privileges for invitees to access information in a granular fashion in a health record, in accordance with one embodiment of the present invention.

FIGS. 22A-C illustrate patient charts, in accordance with one embodiment of the present invention.

FIG. 22D is a complete view of the programs associated with a particular user, in accordance with one embodiment of the present invention.

FIG. 23 is a screen shot of a patient chart dashboard, in accordance with one embodiment of the present invention.

FIG. 24 is a screen shot of an interface with the Patient Notes Manager, in accordance with one embodiment of the present invention.

FIG. 25 is a screen shot of the Patient Search feature available within the Healthy Circles Platform, in accordance with one embodiment of the present invention.

FIG. 26 provides a screen shot of a sample question in a session, in accordance with one embodiment of the present invention.

FIG. 27 is a screen shot showing a question from a vital signs session, in accordance with one embodiment of the present invention.

FIG. 28 is a screen shot showing a summary of the session completed by the patient, in accordance with one embodiment of the present invention.

FIG. 29 is a screen shot of a care coordination message center landing page for a particular patient, in accordance with one embodiment of the present invention.

FIG. 30A is a screen shot of a sample HCP directory listing doctors and clinics available to a patient, in accordance with one embodiment of the present invention.

FIG. 30B is a screen shot of an interface providing an avenue for presenting a message for entry within the care coordination message center landing page, in accordance with one embodiment of the present invention.

FIG. 31 is a screen shot of a health reports and report summary, in accordance with one embodiment of the present invention.

FIG. 32 is a screen shot of a report summary, in accordance with one embodiment of the present invention.

FIG. 33 is a screen shot of a health profile and quick update for a particular patient, Mary Gomez, in accordance with one embodiment of the present invention.

FIG. 34 illustrates wallet sized cards providing health profile information for Mary Gomez, in accordance with one embodiment of the present invention.

FIG. 35 is a screen shot of content providing information about blood pressure basics, as an example of the information contained within the Knowledge Center, in accordance with one embodiment of the present invention.

FIG. 36 is a screen shot of a registration interface, in accordance with one embodiment of the present invention.

FIGS. 37A-D are illustrations of a system for implementing a disease monitoring system, in accordance with one embodiment of the present invention.

### DETAILED DESCRIPTION OF THE PREFERRED EMBODIMENTS

Reference will now be made in detail to the preferred embodiments of the present invention, to include a system and method for performing online monitoring of participants, such as patients. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for a system and method for providing remote monitoring of participants. For example, the present invention provides for the remote monitoring of the health of individual or groups of individuals. Other embodiments of the present invention provide for a program authoring tool allowing authors to create and make available health programs that facilitate the remote monitoring of individuals. Still other embodiments of the present invention provide for a central platform that facilitates the monitoring of individuals within a prescribed social network providing coordinated care. Still other embodiments of the present invention provide for a messaging center to facilitate communication between a patient and members of a health care team providing coordinated care to the patient. Another embodiment of the present invention provides for access to health records of a patient by the patient and members of a health care team providing coordinated care for the patient, and more specifically provides for granular access to information in the health records.

While embodiments of the present invention are described within the context of providing online health services for purposes of monitoring the health of patients, and for monitoring compliance of those patients in performing health related tasks (e.g., the taking of medication), other embodiments are well suited to providing any type of service and the implementation of those services, as well as the monitoring of the condition or performance of a participant through the online monitoring platform. For instance, the platform is able to provide coaching of individuals in a wide range of applications. As examples, the services may provide for wellness coaching (e.g., dieting, etc.), or for teaching a specific sport (e.g., monitoring the completion of exercises for teaching a specific technique in a martial arts class). In still another example, the platform is capable of providing financial services to participants by facilitating the monitoring of a participant's financial transactions for a given period, or the status of the overall portfolio of the participant. Also, the platform can be utilized in the classroom environment to monitor the progress of a student by a teacher (e.g., monitor the completion of homework on a daily basis). In addition, the platform can be extended to provide health services to more than one individual. As an example, the online monitoring system can be used for disease management of a group of individuals.

### Notation and Nomenclature

Embodiments of the present invention can be implemented on software running on a computer system. Other embodiments of the present invention can be implemented on specialized or dedicated hardware running on a computer system, or a combination of software and hardware running on a computer system. The computer system can be a personal computer, notebook computer, server computer, mainframe, networked computer, handheld computer, personal digital assistant, workstation, and the like. This software program or its corresponding hardware implementation is operable for providing online monitoring of a condition of one or more patients, secure messaging between a group including a patient and members of a health care team providing care to the patient, a program authoring tool used for generating a health program capable of monitoring a condition of a participant (e.g., patient), for providing granular access to medical information contained within a health record of a patient, as well as providing other features of embodiments of the invention. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “determining,” “providing,” “receiving,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Further, throughout the application, the term “database” may be used to describe a location for storing information or data, and/or a mechanism for storing information or data. As such, “database” is interchangeable with the following terms: storage, data store, etc.

### System and Method for Providing Online Monitoring

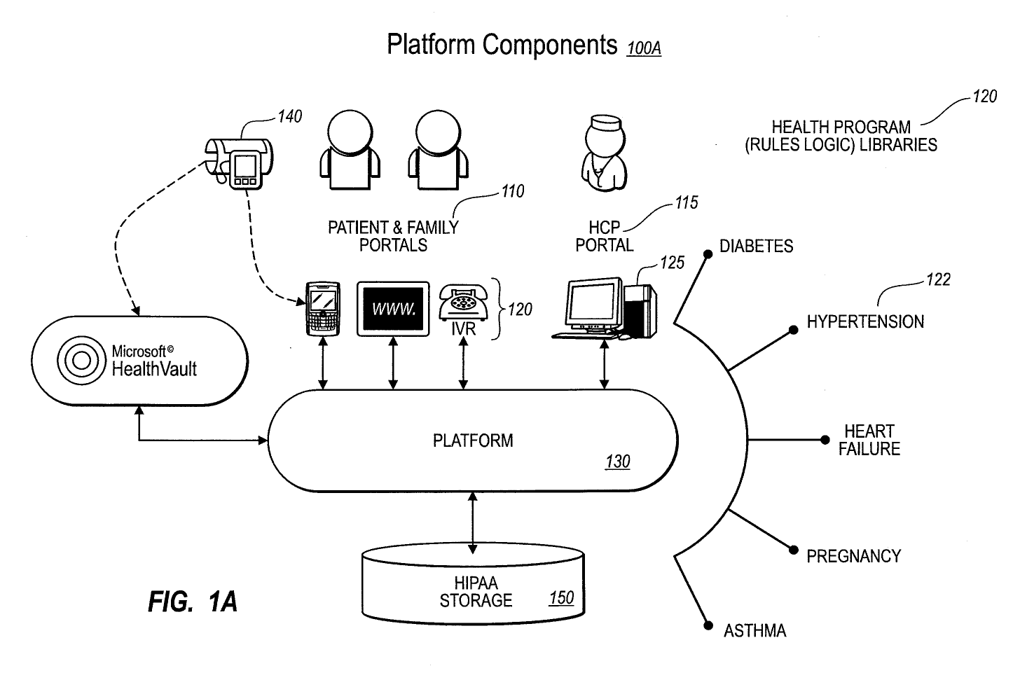

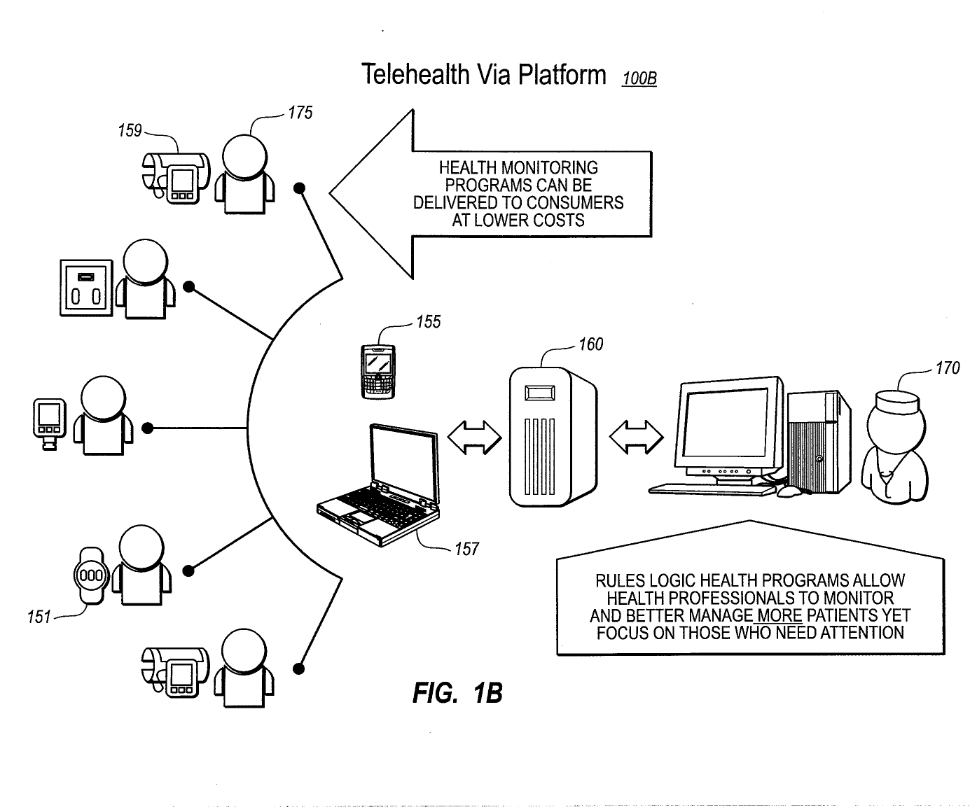

FIG. 1A is a diagram illustrating the a system 100A providing online health services for purposes of remotely monitoring the health of patients, and for monitoring compliance of those patients in performing health related tasks, in accordance with one embodiment of the present invention. As previously mentioned, while the system 100A in FIG. 1A is described within the context of providing health services, the system 100A is well suited to monitoring the condition and/or performance of participants in any context outside of providing health services (e.g., wellness coaching, coaching of any activity, compliance of a program, etc.).

As shown, system 100A includes a central platform 130 supporting the coordinated care of a patient. The central platform 130 throughout this application is also referred to as the Healthy Circles Platform

The system 100A includes four portals for accessing the system. These portals include the Patient/FCG (“family caregiver”) portal 110, Public portal (not shown), Healthcare Professional (“HCP”) portal 115, and Admin portal (not shown). Portals are defined primarily by the features available within them but also by the users which may have access to them. Each portal within the system has a unique look and feel.

For instance, the following user types, listed beneath portals to which they belong, are typical actors within the central platform 130 of system 100A, in one embodiment. These roles have been defined by the corresponding portal a user may access and also which sub-portal features may be available to them. For instance, institutional administrative users can create many combinations of access-level permissions, and therefore user types not listed below are also possible. An institution is a client of the Healthy Circles Platform 130 who manages a custom and isolated instance of the system 100A. An institution has full control over all data from patients enrolled through the institution. These institutions may be identified through a private label, and may have purchased a private label enterprise license, which allows them to have their own Healthy Circles Platform site instance, as well as their own HCP users and patients.

The system 100A in FIG. 1A includes a first network access device 120 that provides access to a communication network (not shown). The first network access device 120 is associated with a user or participant which is capable of accessing the first portal (e.g., patient portal 110) to take advantage of the online monitoring system 110A. Within a health services context, the participant is a patient or the patient's caregiver, the family caregiver (FCG). For instance, the patient is the target user of one or more sessions of a health program described below. In general, a session includes assembled questions and responses from a given program presented to the patient on a scheduled basis.

Within the online monitoring system, the core features available to a patient include Patient Sessions, the Patient Profile/PHR, Health Reports and Knowledge Center, in embodiments of the present invention. Also, FCGs are individuals invited by the patient to receive alerts and notifications generated by one of the many health programs 120 available within the system 100A. In general, a health program 120 includes a series of questions and responses defined by a health condition, area of interest or theme.

The FCG experience is identical to the patient's experience, except a FCG may have access to multiple records within one account. For instance, FCGs can also be patients, and would have their own patient profile.

As shown in FIG. 1A, the patient and FCG portals include various network devices 120 for accessing the centralized platform 130 through a communication network. These network devices 120 include a land line telephone, a mobile phone, a personal digital assistant, a computer, etc. In addition, these network access devices 120 may include an interactive voice response (IVR) system to facilitate the collection and dissemination of information between the participant and the system.

In another embodiment, the system 100A is also capable of providing health services to the general public. For instance, an anonymous user that is unauthenticated is able to access the system using a second portal (e.g., public portal) for purposes of accessing health services. In one case, the anonymous user has access to the public content. For instance, this public content could provide information related to health topics (e.g., how the heart works). More generally, this information could provide a general overview of topics of interest to the public. However, in one embodiment, to access additional and more detailed services, the user would have to register with the system, or be a subscriber to the system, in one embodiment.

The system 100A in FIG. 1A also includes a second network access device 125 that provides access to the communication network. The second network access device 125 is associated with a monitoring agent who is capable of accessing the third portal, the HCP portal 115, to take advantage of the online monitoring system. For instance, within the health services context, the monitoring agent includes a health care professional (HCP), such as a medical doctor and staff. In still another embodiment, the monitoring agent could be the FCG.

The portal 115 for the HCP is designed for patient monitoring and management. As such, the HCP, through a series of tools and reports allows the HCP's to search and sort patients based on session and program results and rules logic. For instance, one tool is the exception manager that provides a full view into patients in a given program and can be related to a given institution. Another tool available to the HCP is the encounter tracker, which tracks, displays, and documents encounter history and records for patients. Also, the patient health reports generating tool allows clinicians to create Health Reports for individual participants. In one particular case, the health reports incorporates Staywell Krames Online customized patient education materials that are delivered to respective HealthVault accounts.

An HCP monitoring agent can be further broken down into a personal HCP, or an enterprise HCP. A personal HCP is an individual HCP who is invited by a patient to receive alerts and notifications generated by a health program. Upon acceptance of the invitation, a personal HCP is granted access to a limited version of the information maintained by the health care monitoring system of FIG. 1A, in one embodiment. For instance, the personal HCP is able to access a data store maintaining information related to the patient. In one embodiment, the data storage device is compliant with the Health Insurance Portability and Accountability Act of 1996 (HIPAA). In one case, the personal HCP is able to access the data store to passively review data related to the patient. In addition, personal HCP users are unique in that they have access to HCP Tools and can receive promotions to upgrade their account to Enterprise status.

As a service, the Enterprise HCP (“EHCP”) operates under a license to offer and provide professional services to selected patient populations (e.g., subscribing patients) using the Monitoring Center and Health Program Authoring Tool, both of which are more fully described below. Enterprise HCPs are grouped under the following sub-categories: individual HCP, institutional HCP, and EHCP admin. For instance, the individual HCP receives a fee for the services they perform within the system (e.g., monitoring patients, authoring programs used for monitoring patients, providing diagnosis on conditions, etc.). Payment is based on the number of active patients enrolled who utilize the services provided by the individual HCP, in one embodiment. Also, individual HCPs offering monitoring services are able to promote themselves through an HCP Directory. Individual HCPs authoring Health Programs are credited within the Health Program Directory.

Also, as EHCPs, institutional HCPs operate on behalf of an institution. These institutional HCPs include staff of the institution, and may not be compensated directly by the Healthy Circles System for their services. Rather, the institution will have an agreement with the Healthy Circles System, and can be listed within the HCP Directory. Further, the enterprise HCPs include an Institutional Admin User (e.g., enterprise-license), or EHCP admin. In addition, as EHCPs, the institutional Admin is responsible for managing settings, application content (OMS) as well as Enterprise HCP & Health Program Authors within their own respective institution.

The system 100A of FIG. 1A also includes a super administrator (not shown) that accesses the Healthy Circles system through the fourth portal, the administrative portal (not shown). The super administrator could be a Healthy Circles system staff member and has the highest level of system permissions, in one embodiment. For instance, super administrators create and set permissions for Enterprise Licensees.

The system 100A of FIG. 1A includes a library of programs 120. Within the health context, programs could be used to monitor specific physical conditions of a patient. For instance, one health program, the hypertension health program 122) shown in FIG. 1A obtains the daily blood pressure of the individual patient to monitor the patient for hypertension. This monitoring feature can be used for purposes of providing preventive care. These readings could be collected automatically through a medical device 140 compatible with the centralized health platform, or could be entered within the system by the patient, or the patient FCG. As multiple readings are obtained over a period of time, a history of blood pressure readings can be analyzed to determine the overall health of the patient. In this way, the system is used for providing preventive care for the patient.

In addition, a program can be used by a patient to monitor for compliance with a health regimen. For instance, when a patient leaves the doctor's office, the doctor may have prescribed or assigned a health regimen for the patient to follow. One program is targeted to monitor the activities of the participating user to determine compliance with the health regimen. As an example, the health regimen may be for the patient to take one or more prescribed medications. As such, the program may be used to determine if the patient is taking the medications with the prescribed frequency, or is out of compliance.

In still another embodiment, the program may be used to monitor the health of a group of individuals. For instance the program can be used to monitor the spread of disease through a community. This program may be accessed by individuals in the community, and used to monitor the condition of the overall community. In one case, a series of kiosks may be placed in an area (e.g., college campus) for users within the community to execute the program. As each individual completes the program, a health condition of the user is obtained, and as more and more users complete the program, an overall condition of the community can be obtained.

In addition, the program can be used to monitor the progress or performance of the user within any context. For purposes of illustration only, in an instructional context, the program can be used as a learning tool to teach and monitor the progress of a user. For instance, the program may be used to monitor how well the user is learning a kicking technique used in martial arts. If it is determined that the user needs more instruction, based on the responses provided when interacting with a program, an appropriate action may include showing an instructional video on proper technique, or providing reminders to entice the user to practice the kicking technique. Accordingly, it is to be understood that a program can be directed to a wide variety of subject matter, including health monitoring, fitness monitoring and training, sports coaching, educational monitoring and tutoring, financial monitoring, and adult entertainment, to name but a few.

In one embodiment, a program in the library of programs is assigned to the user (e.g., participant or patient). For instance, during care of the user as a patient, the HCP may require participation in a health program. As an example, the health program may be used to monitor the blood pressure of the patient, or to ensure that the patient is taking medication regularly. As such, when the user or patient is accessing the system in FIG. 1A, those programs assigned to the user are readily available to that user. In addition, those programs that need attention from the user become readily available to the user for execution. For instance, the user may be enrolled into the program, and as such, is assigned to the user. Enrollment may be performed by the user, the user's FCG, or the user's HCP.

As will be further described below, the program includes one or more sessions. A session includes at least one rules based logic tree configured for interaction with a participant. For instance, as will be described below, the tree includes queries arranged according to logic for purposes of monitoring the health of the participant. The logic tree may be further partitioned into one or more query groups, wherein each query group includes one or more rules based queries. One or more query groups are arranged to form a session of the program. Execution and completion of a query group reaches a result through logic. Also, one or more sessions make up a health program. A participant is expected to interact with one session before interacting with another session. For instance, one session may be scheduled for execution on day-1, and another session may be scheduled for execution on day-2. As such, execution and completion of a query group, a session, numerous sessions, or the entire health program, reaches a corresponding result.

These sessions can be completed in a sequence, according to a given plan (e.g., perform sessions sequentially with a given frequency). For instance, in a program that monitors for hypertension, a session in the program may provide information to determine if the patient has taken the appropriate dosage and combination of medications for a given day, and over a prescribed period.

In addition, the system 100A may include a third party content provider, in one embodiment. For instance, the third party may provide advertising that is included within the program that is delivered to the user for viewing. In other instances, additional content, other than advertising may be provided.

Also shown in FIG. 1A, a central platform 130 provides access and control over the library of programs 120 through the communication network (not shown). That is, users are able to access the central platform through one of the previously described portals. For instance, the user patient or FCG accesses a program through the central platform 130 for purposes of execution. In addition, any one of the parties (e.g., patient or member of a health care team providing care to the patient, such as a FCG, or HCP) is able to access the central platform 130 to review and analyze information (e.g., responses and results) collected during execution of the sessions of a health program. As previously described, the data store 150 is used to store responses and results of the user in association with the health program.

Also, as shown in FIG. 1A, the Healthy Circles Platform or system 100A is compatible with other third party health services. For instance, a third party health service may provide additional information obtained from medical devices. In one case, a medical device 140 may continually monitor the blood pressure of a patient throughout the day. The blood pressure readings can be incorporated into the Healthy Circles Platform or system 100A directly through a patient/FCG portal 110, or through another portal dedicated to that third party service. In either case, the information collected and obtained through the third party service can be stored in the data store 150 in association with the patient.

FIG. 1B is an illustration of one implementation of the health monitoring system 100A of FIG. 1A, in accordance with one embodiment of the present invention. As shown, a patient 175 is able to access the Healthy Circles Platform 130 of system 100A in order to provide information to a back end server 160 supporting the system 100A. For instance, the patient can communicate using a mobile device 155, stand-alone computer 157, telephone, dedicated medical devices (e.g., blood pressure monitor) 159, watch 151, or any device enabling communication with the back end server 160.

In addition, the HCP 170 is able to access the Healthy Circles Platform 130 of system 100A to monitor responses and results from health programs executed by their one or more patients. In that way, the health programs and overall system allow health care professionals to monitor and better manage more patients effectively, without compromising any quality of healthcare services, and in fact, expanding the amount and type of services that a HCP 170 can provide, thereby providing even better care to the patient.

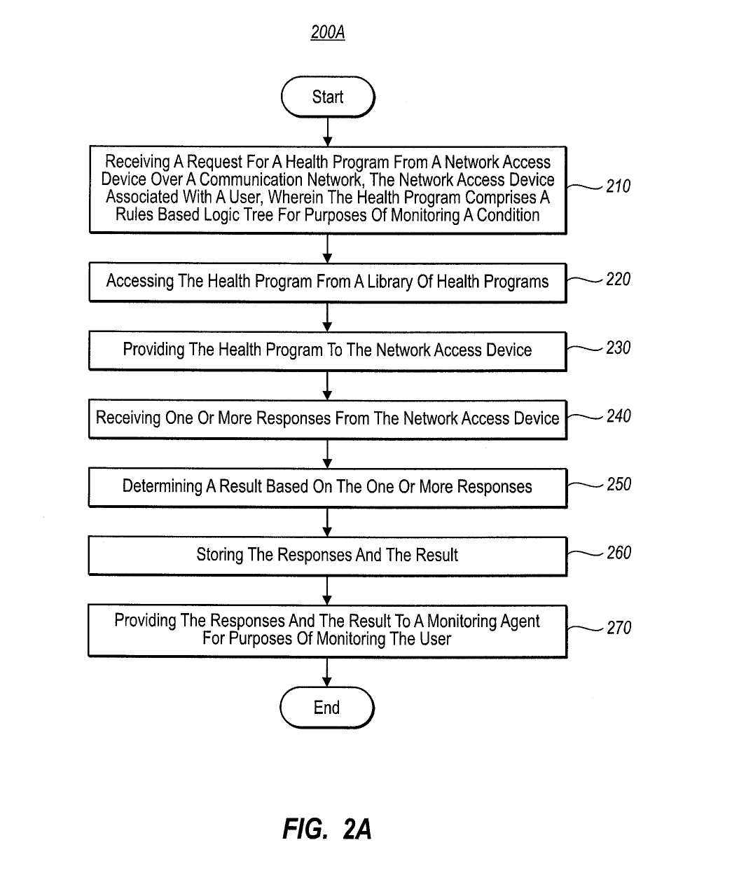

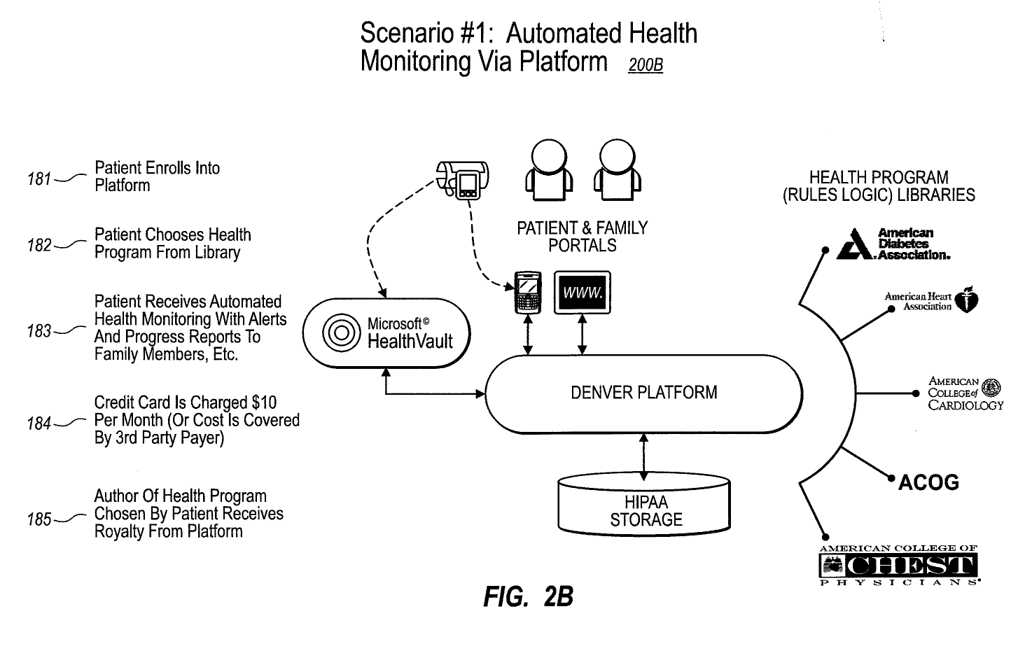

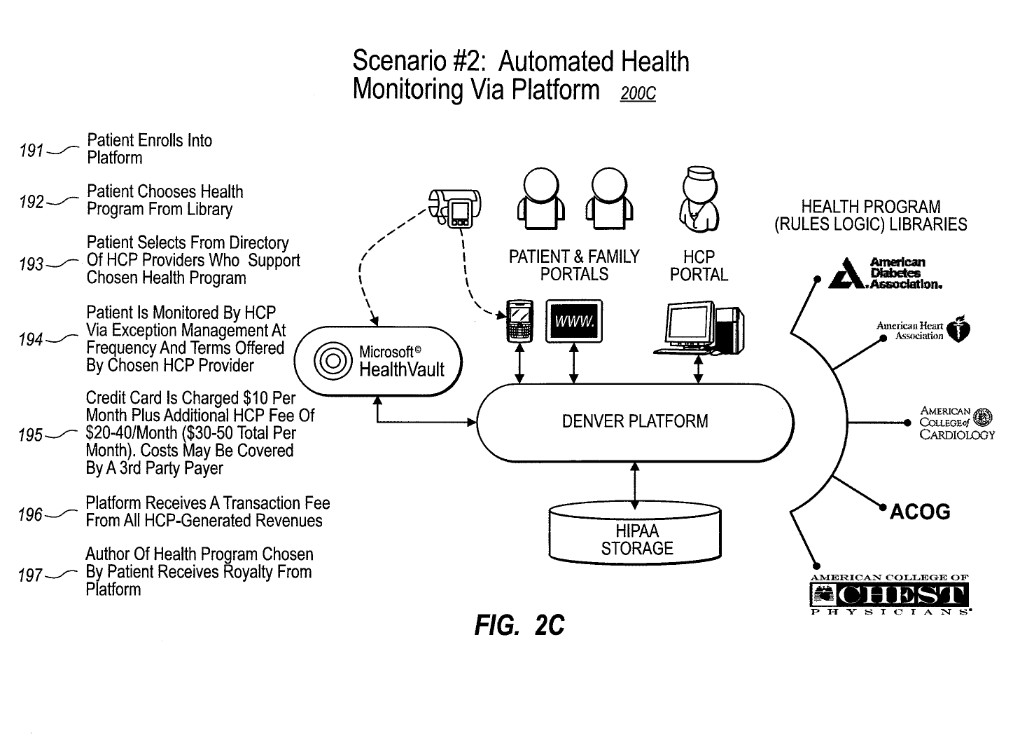

FIG. 2A is a flow chart 200A illustrating a method for monitoring, in accordance with one embodiment of the present invention. The flow chart 200A can be implemented within the system 100A of FIG. 1A to monitor a participant that may be a patient, such as for purposes of monitoring the health of a patient, or monitoring the completion of a health regimen prescribed to the patient. In other implementations outside of the health context, the method outlined in the flow chart 200A is capable of monitoring the performance of the participant. For instance, the program may be used to determine the progress of the participant in learning a new martial arts technique, or for monitoring how many homework assignments have been completed by the participant.

At 210, a request is received for a health program. The request is received from a network access device over a communication network. The network access device is associated with a participant interacting with system 100A for purposes of monitoring. In some implementations, a third party may be acting on behalf of other participant when interacting with system 100A for purposes of monitoring a condition of the participant. For instance, the third party may be a family care giver (FCG), described previously.

In one embodiment, the health program has been previously assigned to the user for purposes of monitoring a condition of the participant. As described previously, a HCP may want to monitor a condition of the participant through a health program. As such, the HCP may prescriptively enroll the participant into the health program. Immediate participation in the health program may also be required, such that that participation events may be scheduled upon enrollment by the HCP.

In another embodiment, the participant independently enrolls into a health program for purposes of monitoring a condition through self evaluation, or through the expertise of a HCP. In the latter case, the participant may establish a relationship with a HCP that is able to perform monitoring services for that health program, so that the HCP is able to monitor the condition of the participant through execution and participation of the health program.

In addition, the program may be customized to the user. That is, the program can be personalized for the user, or configured to accommodate the user's needs.

At 220, the health program is accessed from a library of programs. Each of the health programs in the library includes at least one corresponding logic tree that is configured for monitoring a corresponding condition of a participant by a monitoring agent.

The health program is then provided or delivered to the network access device associated with the participant at 230. As described before, the health program includes at least one rules based logic tree configured for interaction with a participant, and upon completion of the logic tree reaches a result. The result from one logic tree may be combined with other results from other logic trees in a session, between sessions, or for the entire health program to reach another result. These results are used for purposes of monitoring the health of the patient.

It is intended that various means for delivering the session and/or program to the user for execution are contemplated, though not explicitly outlined herein. For instance, the queries in a session may be delivered one at a time to the user from the central platform 130. In that manner, the central platform 130 is exposed to and controls how information is delivered and received. In that manner, if one query has not been completed, the central platform 130, and more specifically, a health program manager 350 will hold up delivery of follow-on queries, until completion of that query. In another instance, the entire session may be delivered to the network access device associated with the participant as a prepackaged application or widget, with instructions on collecting information and delivering that information back to the central platform 130.

In another embodiment, the program as delivered includes advertising content. For instance, a third party advertising service or server may provide advertising content within the program or session of a health program that is delivered to the participant. In that manner, advertising revenue may be generated from participation with the Healthy Circles Platform.

At 240, one or more responses are received from the network access device associated with the participant. That is, during execution and participation with the health program through the central platform 130, responses provided by the participant are delivered back to and received by the central platform 130.

At 250, according to the logic within the logic tree of the health program, the one or more responses lead to a result. As such, a result is determined by following the defined logic based on the one or more responses provided by the participant.

Optionally, at 260, those responses and results are stored within the monitoring system for later access. For instance, the responses and results are stored in the data store 150 of FIG. 1A.

At 270, the responses and results are provided to the monitoring agent for purposes of monitoring the user. For instance, within the health context, the monitoring agent, such as a HCP or doctor, may maintain a patient record for the participant. That patient record may also be referred to as a clinical record associated with the participant throughout this application. As such, the responses and results from executing a program, or a session of a program may be delivered to a network access device associated with the monitoring agent so that the information may be integrated and included within that clinical record.

Additionally, as will be further described below, that health record, or clinical record may be further accessible to the patient as well as members of the health care team so that all in the group are aware of the condition. In that manner, coordinated care can be provided to the patient by the members of the health care team.

Further, once a result is determined from performing the method of FIG. 2A, an appropriate action is determined and performed, in another embodiment. For instance, a risk level of the condition may be determined based on the result. That is, the result may be categorized as being of low, medium, or high risk. Depending on the risk level determined, one action may include providing a notification of the result and risk level assessment to the monitoring agent if the system determines that such notification is necessary to protect the health of the user. As an example, in the program that monitors for hypertension, if the result indicates that the patient has a blood pressure reading that is alarming, an appropriate action could be to notify that patient's monitoring agent (e.g., patient's HCP, or doctor). As such, a notification message could be delivered to the monitoring agent via a message center associated with the Healthy Circles Platform Service, as will be more fully described below.

Additionally, an appropriate action may be to provide additional health or education services to the participant. For instance, depending on the result, a treatment for the condition may be forwarded as an instruction to the participant as an action. In another case, if the condition is lack of knowledge on a particular subject, the action may include sending information related to the subject, or further instruction on how to obtain additional information.

FIG. 2B is a flow chart 200B illustrating a method for monitoring as implemented within an automated health monitoring program, in accordance with one embodiment of the present invention. As shown, the Healthy Circles Platform 130 allows patients and FCGs access to programs in the library of programs. For instance, the patient enrolls into the Healthy Circles Platform 191 in order to interact with one or more health programs.

The patient chooses a program 182 from the library of programs and enrolls in that program. Enrollment may be encouraged or prescribed by a HCP, in one case. In another case, enrollment in a program is initiated by a subscribing participant (e.g., individual, patient, patient's FCG, etc.) who is interested in having a third party monitor the participant in reference to the topic of that program. In another case, enrollment in a health program is initiated by a HCP on behalf of a patient during the course of providing care to the patient.

Additionally, the patient receives automated health monitoring 183 in association with execution of the program, and sessions of the program. As such, alerts and progress reports are delivered to FCGs and to corresponding HCP, etc. As will be described below, these alerts may be presented through a message center that supports and facilitates communication within a group including the patient and members of a health care team providing care to the patient.

Revenue back to the HCP can be implemented 184. In one embodiment, the patient is charged a fee for participating in the program. For instance, the patient may be charged on a monthly basis (e.g., $10.00 per month). In other instances, the patient is charged through a third party payer (e.g., insurance company). As part of the distribution of revenue, the author of the corresponding health care program chosen by the patient receives a royalty 185 from the fee received in association with enrollment in that health program.

FIG. 2C is a flow chart 200C illustrating a method for HCPs to utilize the Healthy Circles Platform 130 of FIG. 1A to provide health care services and monitoring of patients, in accordance with one embodiment of the present invention. As shown, the HCP is able to access the Healthy Circles Platform through its own dedicated portal, such as a professional portal. In one case, the HCP is accessing the portal to input a health program into a library of programs 120. In another case, the HCP is accessing the Healthy Circles Platform 130 to provide services to a patient, or for monitoring the patient's health.

For instance, the patient enrolls into the Healthy Circles Platform 191 to access a program from the library of programs. In one case, the program is newly selected by the patient 192. For instance, if the patient is suffering from a group of symptoms indicative of a condition, the patient may select a program that monitors that condition. In addition, the patient may request a third party (e.g., HCP) to perform the monitoring 193. As an example, the patient may select the monitoring agent from a directory of Healthy Circles Platform affiliated HCP providers, who are able to support the chosen health program. Once the monitoring agent is selected, the patient is monitored by that agent 194 through the Healthy Circles Platform. Monitoring occurs at a frequency, as specified in the terms of the provider.

Again, revenue back to the HCP can be implemented 195. In one embodiment, the patient is charged a fee for participating in the program. For instance, the patient may be charged on a monthly basis (e.g., $10.00 per month) to access the Healthy Circles Platform. In addition, a HCP fee is requested on top of the monthly subscription fee (e.g., $20-40 per month). A group discount to account for a user participating in multiple programs may also be applied. In other instances, the patient is charged through a third party payer (e.g., insurance company). As part of the distribution of revenue, the author of the corresponding health care program chosen by the patient receives a royalty 197 from the fee received in association with that program. In addition, the Healthy Circles Platform may charge and receive a transaction fee from all HCP generated revenue 196.

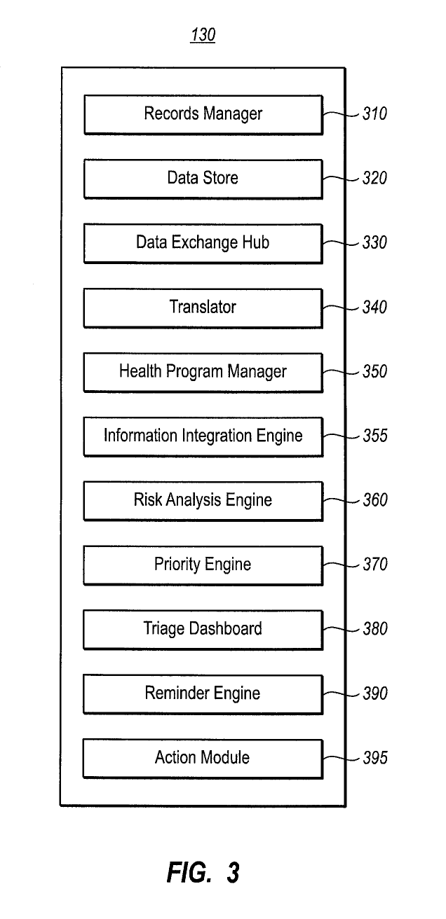

FIG. 3 is a block diagram illustrating the central platform 130 of FIG. 1A providing online health services for purposes of remotely monitoring the health of patients, and for monitoring compliance of those patients in performing health related tasks, in accordance with one embodiment of the present invention.

In particular, the central platform 130 includes a records manager 310 for managing a first health record of a patient. The records manager is configured to obtain information used in the first health record from at least one of a plurality of information sources related to the patient and/or members of a health care team providing coordinated care to the patient. For instance, the first health record (e.g., personal health record) may be maintained by the patient, and as such, the patient delivers the information to the records manager for inclusion in the health record. In another instance, the health record (e.g., clinical record) is maintained by a health care professional, or a related organization. Information may be sent to the records manager by the health care professional for inclusion into the health record. In addition, the records manager may access the records management systems implemented by the health care professional in order to access information for inclusion into the health record.

In another instance, the central platform includes a health program manager 350 for providing access to a first health program by the patient who is participating in the program. As previously described, the first health program comprises at least one corresponding interactive logic tree used for purposes of monitoring a first condition. A first result is reached based on the logic provided and the one or more responses delivered by the patient. As such, an information integration engine 355 integrates the information comprising the one or more responses and the first result into the health record.

In addition, as previously described, an action module 395 is included that performs an appropriate action based on the one or more responses provided by the patient, and the result achieved through the logic tree of a corresponding health program. That is, the central platform 130 is able to identify when a situation involving a patient, or user, requires some action. For instance, the action may include providing notification of the results of the session to the patient's identified monitoring agent (e.g., HCP or FCG). Notification may be provided by a notification engine (not shown). Further, once a result is determined from performing the method of FIG. 2A, an appropriate action is determined and performed, in another embodiment. For instance, a notification of the result may be provided to the monitoring agent if the system determines that such notification is necessary to protect the health of the user. As an example, in the program that monitors for hypertension, if the result indicates that the patient has a blood pressure reading that is alarming, an appropriate action could be to notify that patient's monitoring agent (e.g., patient's HCP, or doctor). As such, a notification message could be delivered to the monitoring agent via a message center associated with the Healthy Circles Platform Service, as will be more fully described below.

Further, the platform includes a data store 320 for storing the first health record. For instance, the data store may be the storage unit 150 of FIG. 1A, and handles information contained therein according to HIPPA guidelines. Specifically, storing and access of the information are handled according to HIPPA guidelines.

A data exchange hub 330 is included in the platform for providing access to the health record to the patient and members of said health care team. That is, the central platform provides access to information contained in the health record for purposes of providing coordinated care to the patient.

The central platform 130 includes a translator 340 for translating information obtained for integration into the first health record into a common format. That is, as information is collected from various services providing record management, each of which may be of varying formats, the collected information is converted into a common format before integrating into the health record stored in the data store 320. As such, the information in the health record that is stored in the data store 320 is of a common format that can be utilized throughout the platform 130.

In one implementation, the records manager 310 manages a second health record of the patient. Again, the records manager obtains information integrated into the second health record from at least one of the plurality of information sources associated with the patient and the health care team Thereafter, the translator 340 translates information used in the second health record into the common format, wherein the data store is configured to store the information in the second health record using the common format.

In addition, the central platform includes a triage dashboard 380 that is configured to monitor one or more patient simultaneously. As an example, the patients are monitored by a particular HCP in relation to a common condition. Monitoring is achieved through participation in a health program. In particular, the program manager provides access to the first health program to the first patient, and to a second patient. Responses are received both from the first and second patients. A first result is reached upon completion of the health program by the first patient. A second result is reached upon completion of the health program by the second patient. As such, two patients (e.g., the first and second patients) are participating in the health program.

In addition, a risk analysis engine 360 is included for assigning a risk level to corresponding results achieved by the first and second patients when performing the first health program. As previously described, they could be low, medium, or high risk levels, or any other suitable risk level. In addition, a priority engine 370 is included for prioritizing the corresponding conditions associated with the patient according to corresponding risk levels. The triage dashboard 380 lists the corresponding results of the participation with the health program by priority of risk, along with patient information. For instance, high levels of risk determined for the first patient is given higher priority over a lower level of risk determined for the second patient. In addition, these results and responses may be provided to a monitoring agent comprising a government agency for purposes of monitoring the health of the public, in one embodiment.

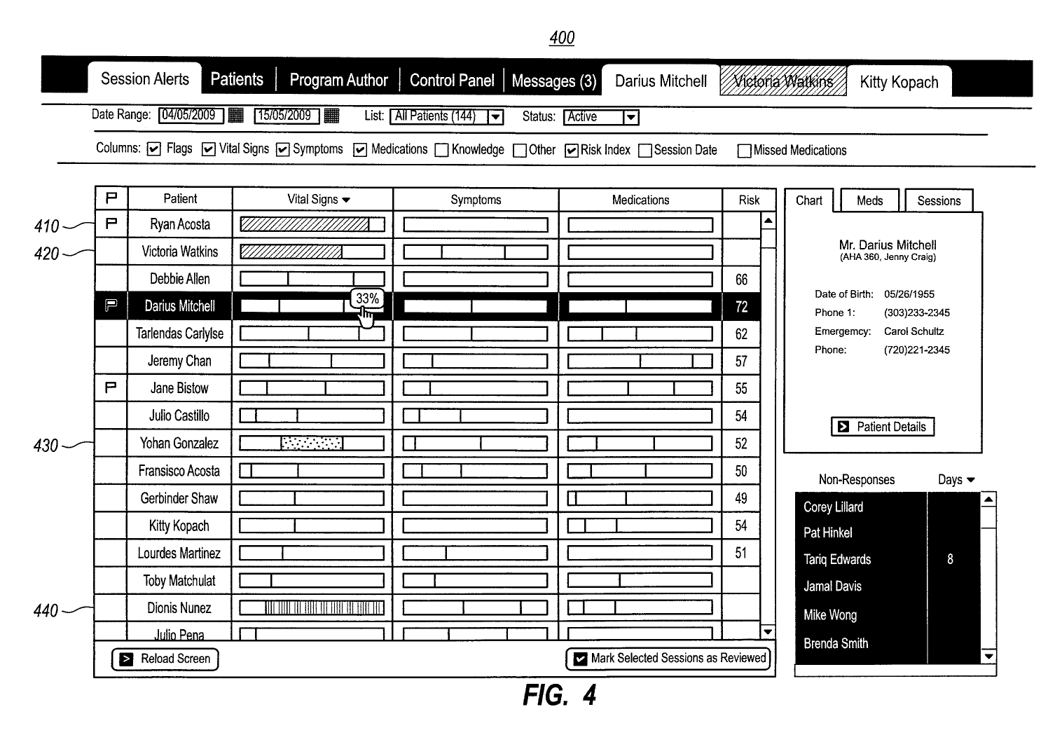

FIG. 4 is a diagram of a dashboard 400 providing the monitoring of one or more patients in relation to one or more conditions, in accordance with one embodiment of the present invention. As shown, various conditions are presented for viewing by a HCP, such as vital signs, symptoms, medication, and overall risk. These conditions may also represent categories of programs for responses to query groups in a rules based logic tree. In addition, patients are listed in relation to the risk levels associated with the various conditions. As previously described, the patients, and their corresponding risk levels are listed by order of priority.

For instance, for purposes of clarity and illustration, the condition for vital signs is discussed as representative of how the dashboard can be used for monitoring conditions in general. As shown in FIG. 4, the condition status 410 for Ryan Acosta is given high priority, as the corresponding bar shaded with backslashes is representative of high risk. The condition status entry for Ryan Acosta 410 is presented above the condition status entry 420 for Victoria Watkins because the level of risk is higher, as shown by the larger shaded area for Ryan Acosta. In addition, the condition status entry for Yohan Gonzalez 430 is presented below the entries 410 and 420 for Ryan Acosta and Victoria Watkins as the corresponding bar shaded with dots is representative of medium risk. Further, the condition status entry for Dionis Nunez 440 is presented at the bottom of the dashboard and below the entries 410, 420 and 430 as the corresponding bar shaded with straight lines is representative of low risk. In this manner, the HCP by viewing the dashboard 400 is able to perform a quick assessment of all the patients under his or her care.

As shown in FIG. 4, condition statuses may be included for other conditions. The conditions may also be assigned a priority, in that the dashboard presents information relating to the condition with the highest priority, such as vital signs in FIG. 4. As an example, the program manager 350 provides access to a second health program by one or more patients. The second health program comprises at least one corresponding interactive logic tree used for purposes of monitoring a second condition. The at least one corresponding interactive logic tree of the second health program reaches results based on corresponding responses by the patients, which are then assigned a risk level and presented in the dashboard 400. In addition, corresponding responses and results are integrated within corresponding health records for related patients.

In addition, the central platform 130 may include a reminder engine 390 for sending out a reminder to a designated device (e.g., mobile phone, computer) associated with a participant that a health program is scheduled for execution by that participant. That is, the health program can be associated with a frequency of execution and interaction outlining when the participant is to access and execute the program, or more particularly, sessions of the program. The health program is also associated with a duration, after which the program in association with the participant expires, in another embodiment. As such, at the appropriate time, the reminder notice is generated and delivered to the designated device.

In one embodiment, a prompt or reminder notice is delivered to the network access device associated with the user. For instance, the program is associated with a frequency of interaction. As examples, sessions may be required for execution once a day, multiple times a day, once a week, etc. At the appropriate time, a reminder notice may be delivered by the system in any format and to any device associated with the user (e.g., mobile phone, email, text message, etc.).

### Health Program Authoring Tool

The Health Program Authoring Tool (PAT) allows various HCPs, such as enterprise HCPs, to create and manage unique health programs. The PAT is an administrative utility providing interfaces to create, assemble and publish program content. In that manner, the HCP is able to monitor a condition of a patient through the use of a corresponding health program. The PAT is utilized within the central platform 130 of the system 100A of FIG. 1A, in one embodiment. In addition, implementation of the PAT is consistent with FIGS. 1-4 and supporting specification providing online health services for purposes of remotely monitoring the health of patients, and for monitoring compliance of those patients in performing health related tasks.

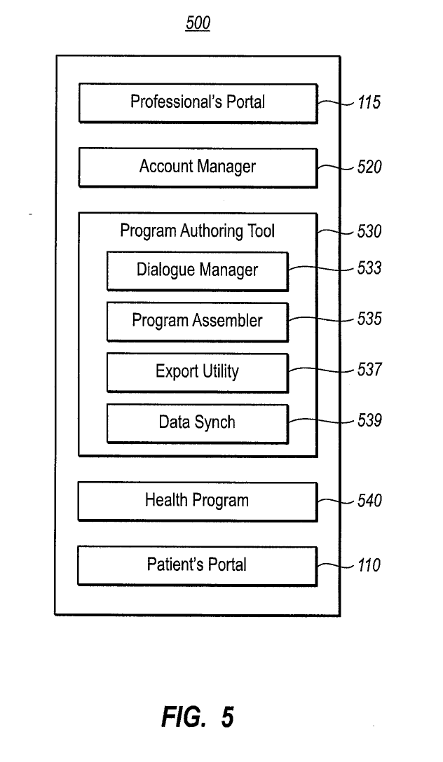

FIG. 5 is a block diagram of a platform 500, such as central platform 130 of FIG. 1A, including a program authoring tool 630 used for monitoring a condition of a participant in a health program, in accordance with one embodiment of the present invention. The platform 500 includes a professional portal 115, as previously described in FIG. 1A. Specifically, HCPs are able to access the professional portal 115 for purposes of using the PAT to generate a health program. In addition, platform 500 includes a patient's portal 110, as previously described in FIG. 1A. Specifically, patients or participants are able to access corresponding health programs through the patient's portal 110. In addition, platform 500 includes an account manager 620 for providing access to an account associated with a HCP accessing the PAT 630 through the professional portal 115.

Also shown in FIG. 5, the PAT 630 includes a dialogue manager 633 which is a utility used to create and manage dialogues, wherein dialogues consist of questions/responses and respective branching logic. The PAT 630 also includes a program assembler 635, which is a utility used to create libraries and programs. The program assembler 635 also allows for the publication and/or release of program content. The PAT 630 also includes an export utility 637 which is a tool designed to create exports of dialogues for the purposes of archiving or managing data offline. Also, the PAT 630 includes a data synch 639, which provides for data synchronization or bridge functionality to transfer program data to technology partners (e.g., AllOne Mobile), in one implementation.

In addition, the platform 500 includes a health program that is generated by the PAT 530. The health program comprises a rules based logic tree that is used for purposes of monitoring a condition of a participant in the health program. The rules based logic tree reaches a result based on a set of proposed responses to the logic tree. As such, the logic tree provides pre-programmed results for corresponding sets of proposed responses.

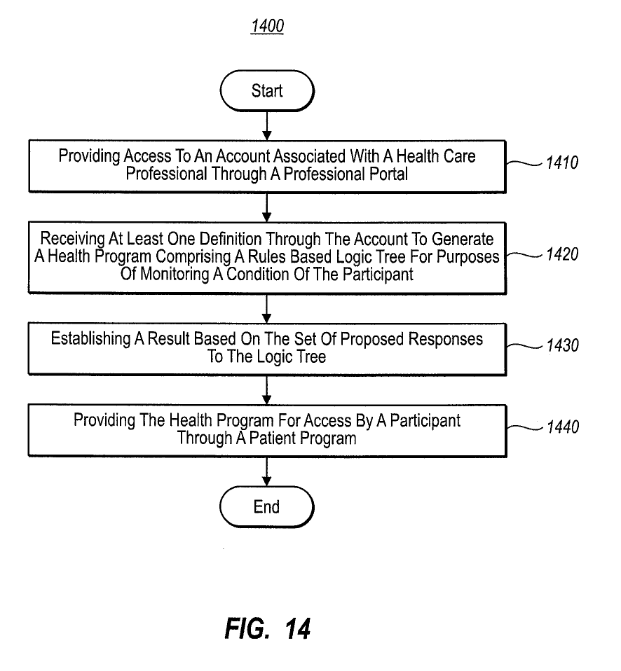

FIG. 14 is a flow chart 1400 illustrating a method for providing care, and more specifically, for generating a health program used for monitoring a condition of a participant, in accordance with one embodiment of the present invention. In particular, the method includes providing access to an account that is associated with a HCP 1410. Access is provided through a professional portal. A definition is received 1420 that defines rules based logic for a logic tree that is generated for purposes of monitoring a condition of the patient. The definition of the rule is received through the account accessed through the professional portal. A result is established based on a set of proposed responses defined within the logic tree. Once the rules based logic is completed for the logic tree, the health program is also completed. Then, the health program is provided for access through a patient portal in the central platform 130 by a participant.

HCPs can either: 1) create health programs de novo, 2) create health programs from a template, 3) edit their existing health programs or 4) modify the health programs of other HCPs (if permission is granted). As such, the Healthy Circles Platform is able to make available these health programs to all subscribers. For instance, health programs authored by one HCP may be made available to patients of that HCP, as well as to any other participant or other HCPs who are interested in that particular program.

As previously described, a health program may be used to monitor for compliance with a health regimen or treatment by a participant/patient. That is, an HCP requires that the patient participate in a health program generated by the HCP as part of the recommended treatment of the patient. As an example, the health program may monitor the taking of medications by the patient, and as such the health program is able to determine if the patient is taking medications with the prescribed frequency. Also, a program may be used to monitor performance of the participant, such as fulfilling a training requirement. Specifically, the program may be used within an instructional context, as a learning tool that tracks performance, and for providing additional instruction if needed. In addition, a health program may be used to monitor the health of a group of individuals. For instance, the program may be used to monitor the spread of disease through a community through public participation in the health program.

Each health program consists of statements and/or questions and potential responses arranged in at least one logic tree. Additionally, queries in a logic tree may be arranged in query groups, such that the logic tree includes one or more query groups. Each of the query groups is associated with its own logic, and may reach corresponding results for corresponding sets of proposed responses.

Further, responses made by the participant may be categorized or defined according to data type. As such, when storing those responses, a corresponding data type is also stored. Information categorized by data type may be stored in the data store 150 of FIG. 1A. In that manner, one or more responses for any health program fitting a particular data type may be populated with a proper value stored in the data store 150 by data type without having a participant enter in that information. For instance, blood pressure taken over the last 24 hours may be of a certain data type, and is requested quite frequently in health programs. As such, whenever a response is requested for blood pressure, the corresponding data type is cross-referenced through the data store 150 by a population engine (not shown) to retrieve the proper information, if available, and used or applied as a proper response having the same data type in association with a query.

A set of questions delivered on a particular day to a patient for interaction is called a session. Once questions and responses have been created, the program author can then list their program in the Health Program Directory, thus making it available to patients or other participants.

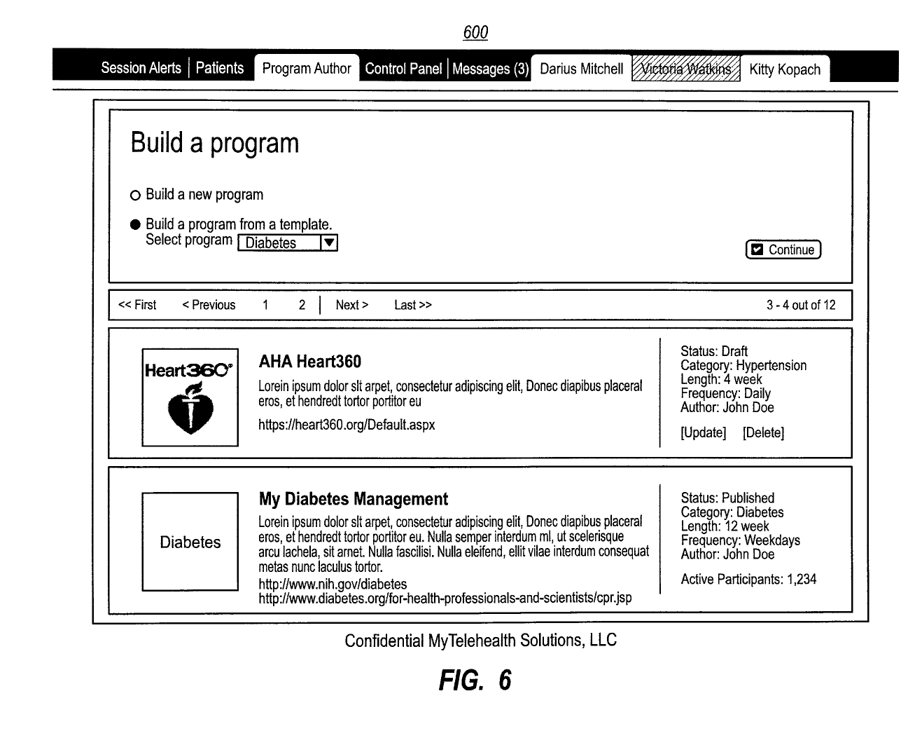

FIG. 6 is a screen shot of an interface allowing a user to create a program within the Program Authoring Tool (PAT), in accordance with one embodiment of the present invention. Specifically, the interface allows a user to add or edit programs using the PAT.

Immediately after entering the PAT 530, the HCP is presented with a screen where options for creating or editing an existing program are offered, as shown in FIG. 6. In particular, FIG. 6 shows a screen shot 600 illustrating the initial step for adding and editing programs. This section provides a view into the Health Program Directory with programs that are authored by the HCP who is accessing the PAT. In general, the directory lists all the programs offered by the Healthy Circles Platform. Also indicated is a status of each of the programs (e.g., draft, completed or published). In this manner, the HCP is able to access a particular program for further editing, or to start from the beginning to author a new program.

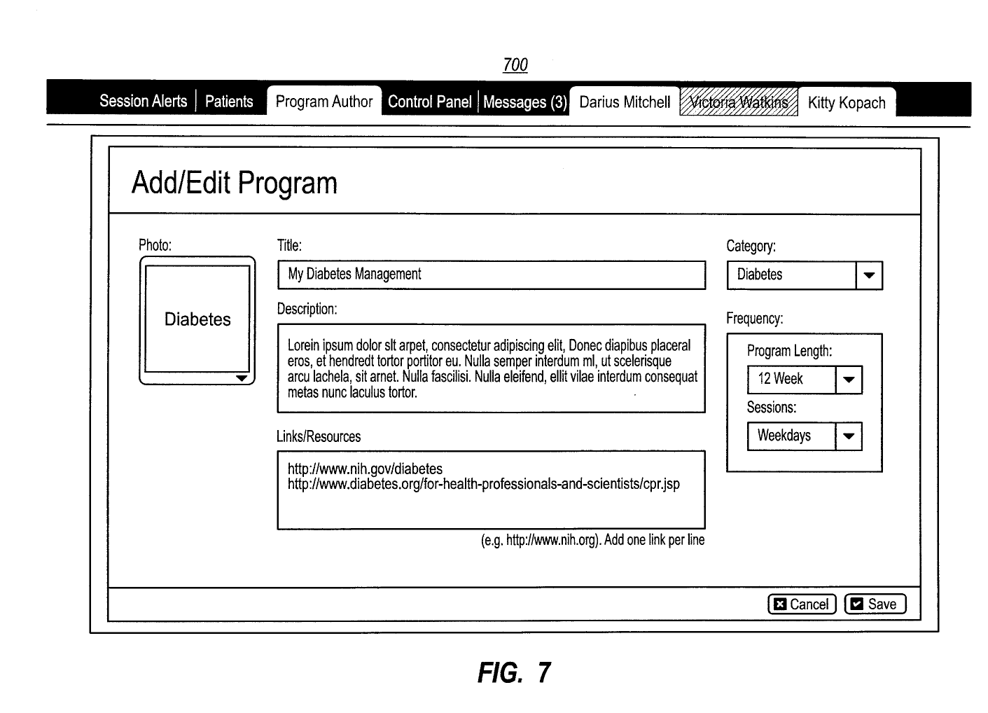

The second step in creating a Health Program is to assign a name and a description summary of the program. FIG. 7 is a screen shot 700 illustrating the interface by which the HCP is able to edit the above information (e.g., title, description, resources, etc.), in accordance with one embodiment of the present invention. This information will be listed in the Health Program Directory, in one embodiment.

More particularly, properties of a health program include: Title; Health Program Category (fixed list); Author Name; Graphic (Logo) Upload; Program Length/Duration (e.g., 4 weeks, 12 weeks, etc.); Session Frequency (daily, every other day, MWF, weekdays, weekends, weekly, etc.); and Links to source references/guidelines.

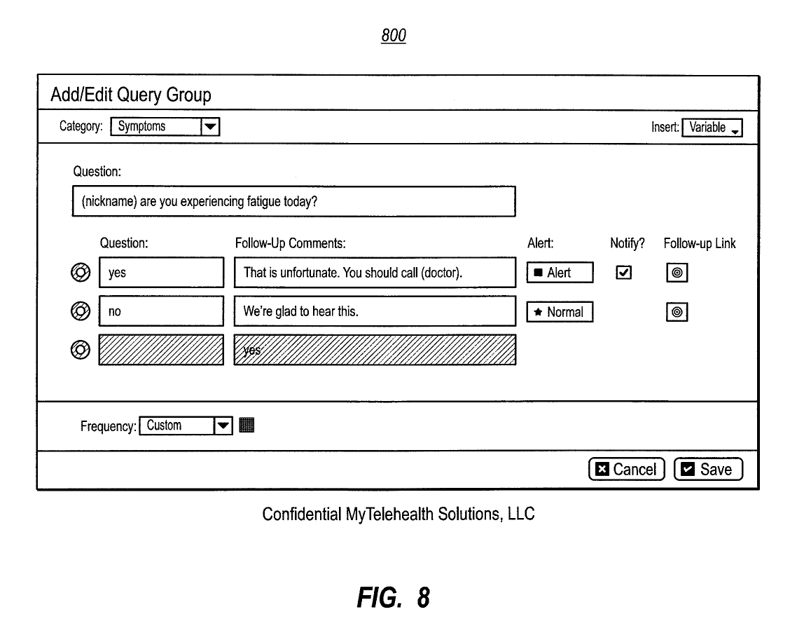

FIG. 8 is a screen shot 800 illustrating a query group interface, in accordance with one embodiment of the present invention. This interface allows the author to make an association between a group of queries. For instance, after saving the program name and description, the next step is to create a query group. A query group is a building block for health programs consisting of questions, responses and follow-up comments. Query groups have other properties such as which program category they belong to, which is a categorical organization of query groups, and in some implementations their corresponding responses, for the purposes of sorting in the Session Alerts Viewer, or dashboard 400. Program categories are limited to vital signs, symptoms, behaviors, knowledge, medication and education, in one embodiment.

In one case, for a program to be considered complete, and then published as a health program, it must contain a minimum of three root-level query groups (question/response groups) and a maximum of forty queries total. A maximum is set so that the participant's interest does not wane. In another case, each question contains a maximum of three (i.e. multiple choice) responses, one of which could be “no response.” Questions requiring no response are also referred to as “statements,” and are selectable from the program category menu.

The PAT 530 may also assign a risk level to each potential response, in one embodiment. In addition, risk levels may also be assigned to results of responses to query groups, sessions, multiple sessions, or a health program all including portions of or the entirety of an interactive logic tree. Risk levels are associated with patient activity data, and can be aggregated and displayed within a session alerts viewer, or dashboard 400, and other health reports.

In that manner, the responses for multiple patients may be grouped together according to the risk level. That is, those responses at high risk are grouped together, and may indicate that immediate attention from the HCP is needed. As an example, the following risk levels are available, and have an association with a color: “normal” (green) indicating minimal or no risk (e.g., vertically lined bar in FIG. 4); “caution” (yellow) indicating intermediate risk (e.g., dotted bar in FIG. 4); and “alert” (red) indicating high risk (e.g., backslashed lined bar in FIG. 4).

In particular, in association with a sessions alerts viewer, such as the dashboard 400, a collector (not shown) is included within the central platform 130 for collecting all sets of proposed responses in a particular program category for one or more health programs. The collected information is then listed, such as in a dashboard providing a view to related information for a plurality of participants/patients. More particularly, the sessions alerts viewer lists sets of proposed responses from a plurality of participants responding to the health program. Information may be listed by program category, such as vital signs, symptoms, medication, behavior, etc. In addition, the sets of proposed responses are listed according to associated levels of risk, as previously described. Specifically, responses and/or results from responses are assessed a risk value. Then, those responses and/or results are listed in the session alerts viewer according to priority of risk.

A frequency options allows program Authors to assign a frequency to a query group. Available options will include “all” and “custom”. Selecting “custom” will trigger a calendar picker allowing the Health Program Author to select a custom set of days the particular query group will fall under. For example, a calendar picker (not shown) allows for a program author to determine the frequency of interactions with a program or sessions of the program, or periods in which sessions must be completed, in accordance with one embodiment of the present invention. Additionally, if there is any tree logic assigned to the responses of a question associated with a prescribed frequency, then the follow up question will automatically inherit this frequency.

As part of a program validation step, in order to control the length of sessions, system rules will restrict how often a program author can use the frequency option, in accordance with one embodiment of the present invention. This is to allow for a consistent stream of questions in every daily patient session and prevent empty and/or excessively lengthy sessions.

In one embodiment, to personalize sessions of a program, when authoring a query group, a program author can insert a variable to output one of the following values: nickname; physician name; and primary FCG name. As such, the program is configurable at a later date to personalize the program to the individual patient. Also, if none of these values have been specified, default values will be used, such as “your doctor.”

Within the program authoring tool 530, query groups are assigned to program categories. These program categories allow for the sorting of patient responses, when aggregated and presented in the monitoring center. That is, responses are sorted by category, irrespective of the patient. Available program categories from the Add/Edit Query Group window are as follows, in one embodiment: symptoms (e.g. Are you experiencing fatigue?”); behaviors (e.g. “Are you wearing your seatbelt regularly?”); knowledge (e.g. “Asthma and emphysema are synonymous. True or False.”); other (e.g. “Do you have a family history of high blood pressure?”); vital signs (e.g. “What is your systolic blood pressure?”); and medication (e.g. “Are you receiving your medication reminders?”).

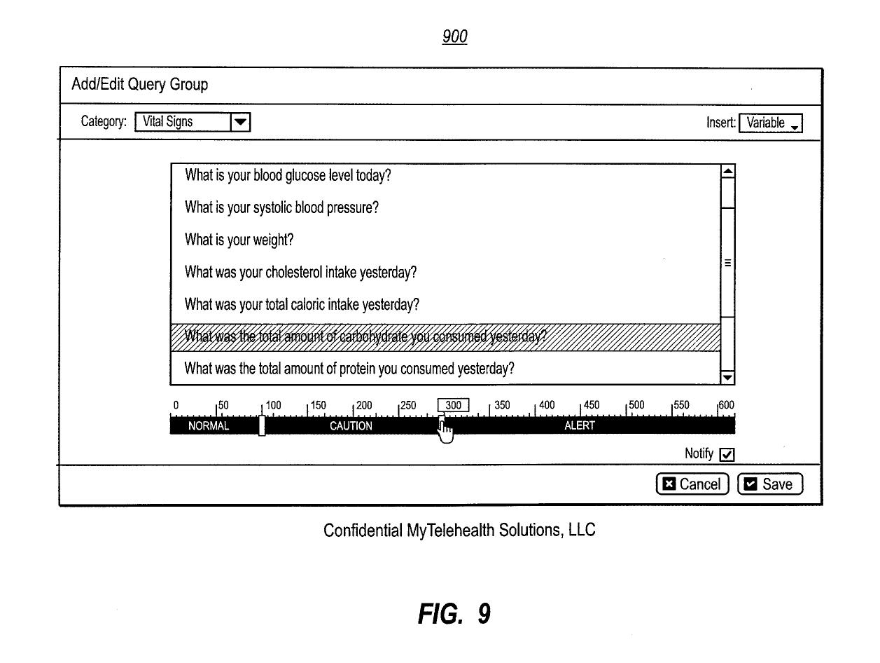

FIG. 9 is a screen shot 900 illustrating the selection of the vital signs category in association with a particular query group, in accordance with one embodiment of the present invention. As such, if the program author chooses the vital signs category within the Add/Edit Query Groups window, the program author is presented with the selection screen 900 that provides sample vital signs questions.

Vital signs (“VS”) questions by definition are pre-programmed and can draw existing data from a patient's HealthVault record, or managed health record, in one embodiment. Within a session, answers to a VS question are presented to a patient to confirm. VS questions are also defined by the following rules, in one embodiment: 1) VS questions & follow-up comments are predefined and drawn from a library; 2) VS questions cannot be reworded; 3) VS responses are in numerical, direct-input format or drawn from existing data in a Patient's Health Vault account; and 4) VS risks are set by creating ranges within the limit of acceptable numerical input.

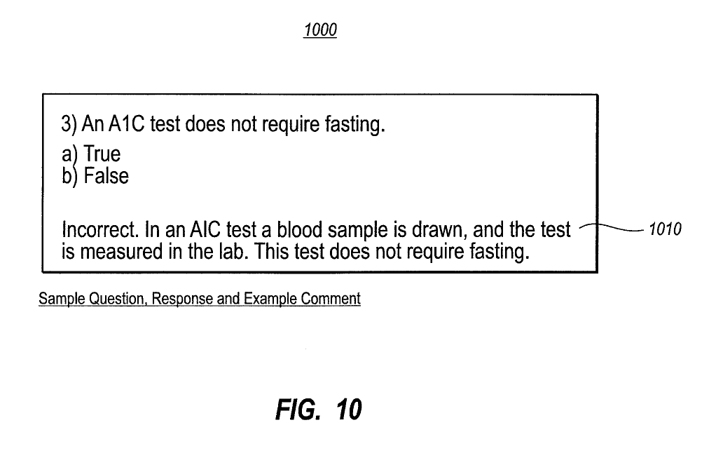

In addition, each response may include a follow-up comment. A follow-up comment is a pre-authored system response to a way a Patient responds to a question during a session. Follow-up comments are optional and provide feedback to the patient responses. For instance, in the following screen shot 1000 shown in FIG. 10, a follow-up comment 1010 is triggered by a proposed response of “false”. The follow-up comment 1010 in FIG. 8 provides an explanation as to why the answer of “false” was incorrect.

As an example, after selecting a linked response, the patient will be presented with a follow-up comment similar to the one shown below that is associated with the response: “Medication can only help to better control your COPD symptoms.” The follow-up comment indicates that a reward will be given to the patient for participating in the session. As such, the positive comments and/or rewards given to the patient actually encourage the patient to perform prescribed tasks, or to execute the program. For instance, a follow-on comment could be, as follows: “Congratulations! You've earned a reward that will be presented to you upon completion of your session.”

To ensure query groups can be supported on all platforms (mobile, web, IVR, etc.), after clicking “save,” but before actually committing the query group, a program author, by way of an alert, will be warned if the entry is invalid. For instance, a sample alert may indicate that upon exiting PAT 530, all previous work will be lost since there is a compatibility problem with the query group selected.

In addition, at the time a response to a query is created, the PAT tool 530 provides the ability to create a follow-up link that is associated with a specific response or responses. These links may consist of health education content, rewards and coupons, encouraging and/or entertaining messages, pictures, videos, targeted advertisements, HCP practice guidelines, etc. As such, one of these links may provide educational content that is used to educate the participant, depending on what responses are made.

The PAT 530 provides for the process of selecting and adding session follow-up links to a response to a query in a session, in accordance with one embodiment of the present invention. For instance, links to one or more private and government sites that disclose information on diabetes may be provided. These various links resulting from patient responses during a session will be presented to the patient upon completion of that session. Additionally, the session follow-up links generated upon completion of a session will be added to the Healthy Circles Platform Care Coordination Message Center in association with that patient for later review by member of the patient's health care team, in one embodiment, and as presented below.

The PAT 530 also gives the option of specifying appropriate actions to be taken for a given response. For instance, health program authors, when adding responses to questions, can specify whether the corresponding health team members should be notified for a given response, when chosen. These notifications are sent through the Care Coordination Message Center, in one embodiment, provided that the health team member has opted-in to this through registration/enrollment or the control panel, and as described below.

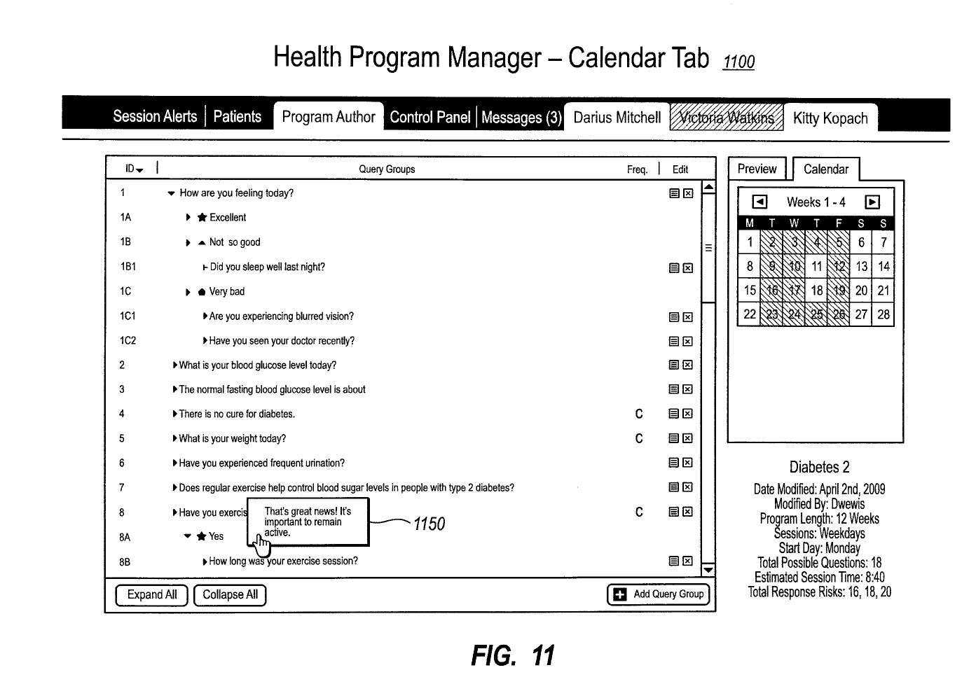

FIG. 11 is a screen shot illustrating a health program manager interface 1100 allowing for an overall view into the questions in a query group, in accordance with one embodiment of the present invention. Once the initial query group has been created, the program author will be redirected to the program manager screen, shown in FIG. 11. It is here that all query groups within a given program are displayed and can be edited, deleted or sequentially organized.

Also shown in FIG. 11 is a calendar feature. The calendar provides information on the frequency and duration of the user's scheduled interaction with a particular query group.

As shown in FIG. 11, query groups, both authored and/or imported from the vital signs or any other category library, are displayed in the order that they will be output within a session. Program authors can click and drag questions to rearrange them in sequence and/or associate them to specific query group responses which, in turn, creates the tree logic for that query group. For instance, query group 1 includes 7 queries, numbered from 1 to 1C2. The next query groups only include 1 query.

Also shown in FIG. 11 is a reward feature integrated within the PAT. Specifically, in response to a positive response to a query asking whether the patient has exercised, a follow-up message 1150 is provided congratulating the patient on his or her diligence in exercising. This feature provides third party feedback to the user when remotely monitoring the health and/or performance of the user.

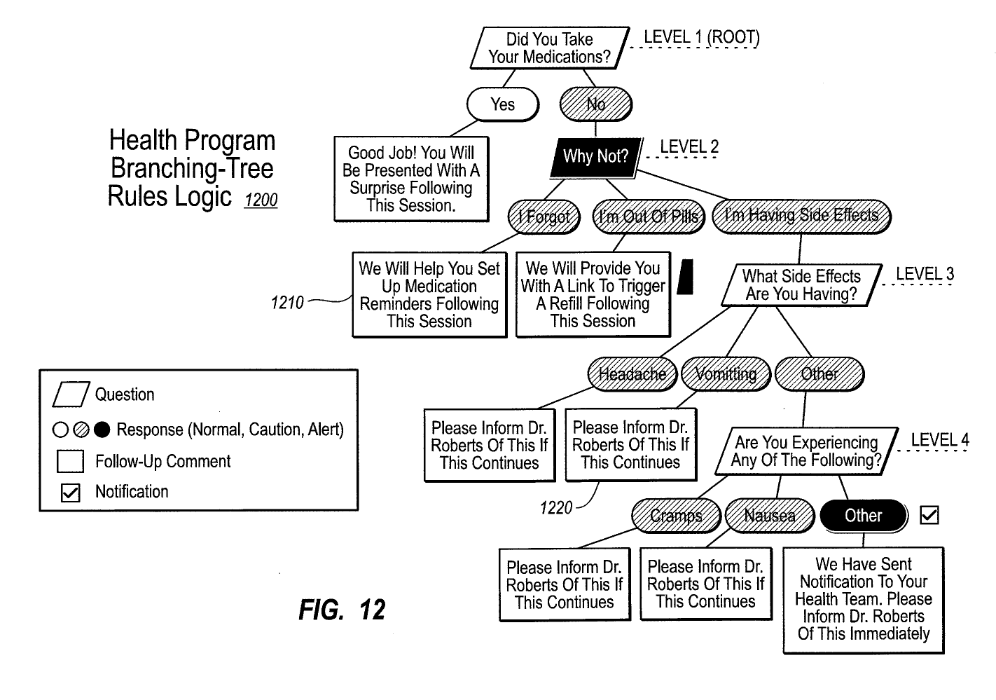

FIG. 12 is an illustration of a query group 1200 and the tree logic associated with that query group 1200, in accordance with one embodiment of the present invention. Generally, tree logic consists of custom rules based on user responses. Specifically, a query group can be linked to proposed responses so that during a patient session of a health program, when (and only when) a specific response is chosen, a follow-up question, or series of questions, will be asked. These follow-up questions are designed by the author through the PAT. For instance, in FIG. 12, the tree logic centers around the determination of whether the patient has taken his or her medicine, and if not, whether there are some side-effects. D

Also, depending on the path through the logic tree, sets of proposed responses reach different results at various levels. For instance, at level 3, result 1210 indicates that medication reminders will be generated following the session. In another example, at level 4, if the patient is proposing a response of experiencing nausea, then a result 1220 requiring the participant to inform the doctor of the side effect is requested.

In one embodiment, a maximum of three levels of tree logic per response is allowed. This equates to four levels of questions, including the root level, as shown in FIG. 12. Moreover, if no tree logic is assigned to a response, the next question in the root sequence will be presented to the patient.

Of particular note, an alert is generated through the PAT if one of the responses indicates that the patient may be in danger. That is, through the tree logic, a determination can be made if the patient is at risk. If it is determined that the patient could be at risk, appropriate action by the central platform can be taken. In one embodiment, the alert may be posted to a message board, or bulletin board supported by a message center in the central platform 130.

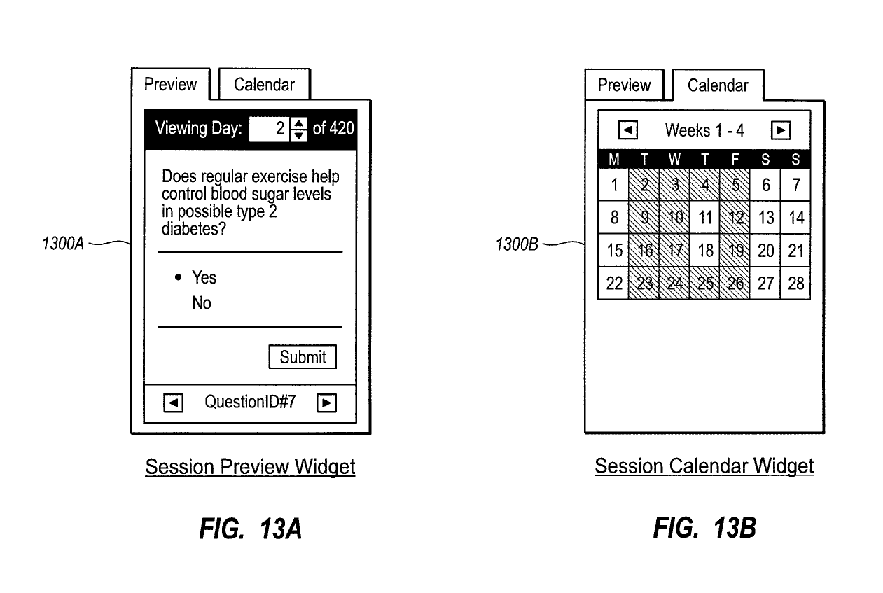

FIG. 13A is a screen shot of a session preview widget 1300A, in accordance with one embodiment of the present invention. As shown, and implemented within the program manager interface, a widget presented on the left, will present the program author with a preview of the session itself, on any given day. Metrics including the total possible questions (dependent on tree logic) and the average length of the session will also be available. This information will be updated immediately whenever a change is made to the program content, in one embodiment.

FIG. 13B is a screen shot of a session calendar widget 1300B, in accordance with one embodiment of the present invention. The session calendar widget is made available within the program manager interface. The session calendar provides an indication to the frequencies of one or more sessions within the length of the program. Highlighted days may indicate when a session is scheduled. In addition to indicating which days have sessions and which do not, cells within the session calendar will also indicate which query groups fall on which days.

1. A method for providing care, comprising:

providing access to an account associated with a health care professional through a professional portal;

receiving at least one definition through said account to generate a health program comprising a rules based logic tree for purposes of monitoring a condition of a responder; and

establishing a result based on a set of proposed responses to said logic tree; and

making said health program available to a participant through a patient portal.

2. The method of Claim 1, wherein said establishing a result comprises:

defining a query group within said rules based logic tree associated with said set of proposed responses;

defining a data type for said set of proposed responses; and

applying one or more received responses comprising said set of proposed responses to all queries requesting said data type.

3. The method of Claim 2, further comprising:

defining a program category for said set of proposed responses to said query group; and

collecting all sets of proposed responses in said program category for listing.

4. The method of Claim 3, wherein said program category is taken from a group consisting essentially of:

symptoms;

behaviors;

knowledge;

vital signs; and

medications.

5. The method of Claim 1, further comprising:

establishing a second result based on a second set of proposed responses to said logic tree.

6. The method of Claim 1, further comprising:

defining an action based on said result.

7. The method of Claim 1, further comprising:

defining a risk level based on said result.

8. The method of Claim 1, further comprising:

breaking out said rules based logic tree into a plurality of sessions.

9. The method of Claim 8, further comprising:

establishing a set of periods for completion of sessions within said plurality of sessions.

10. The method of Claim 1, further comprising:

storing said health program in a library of health programs, each of which is used for purposes of monitoring a corresponding condition.

11. A system for providing care, comprising:

a professional portal;

an account manager for providing access to an account associated with a health care professional through said professional portal;

a program authoring tool for receiving at least one definition through said account to generate a health program comprising a rules based logic tree for purposes of monitoring a condition of a participant;

a result based on a set of proposed responses to said logic tree; and

a patient portal for making said health program available to a participant.

12. The system of Claim 11, wherein said logic tree further comprises:

a query group within said rules based logic tree, said query group being associated with said set of proposed responses;

a data type defining said set of proposed responses, wherein one or more received responses comprising said set of proposed responses are applied to all queries requesting said data type.

13. The system of Claim 11, further comprising:

a program category defining said set of proposed responses to said query group; and

a risk analyzer for establishing a level of risk for said result.

14. The system of Claim 13, further comprising:

a collector for collecting all sets of proposed responses in said program category for said health program for listing.

15. The system of Claim 14, further comprising:

a sessions alerts viewer for listing sets of proposed responses from a plurality of participants responding to said health program, wherein said sets of proposed responses are listed according to associated levels of risk.

16. The system of Claim 12, further comprising:

a data store for storing said set of proposed responses according to said data type; and

a population engine for populating said set of proposed responses for a second query group within a second health program requesting said data type.

### Message Center

A Care Coordination Message Center provides care to one or more patients, and more specifically provides methods and systems for facilitating communication between members of a group including the patient and members of a health care team in order to provide coordinated care for the patient. The message center is utilized within the central platform 130 of the system 100A of FIG. 1A, in one embodiment. In addition, implementation of the message center is consistent with FIGS. 1-14 and supporting specification providing online health services for purposes of remotely monitoring the health of patients, and for monitoring compliance of those patients in performing health related tasks.

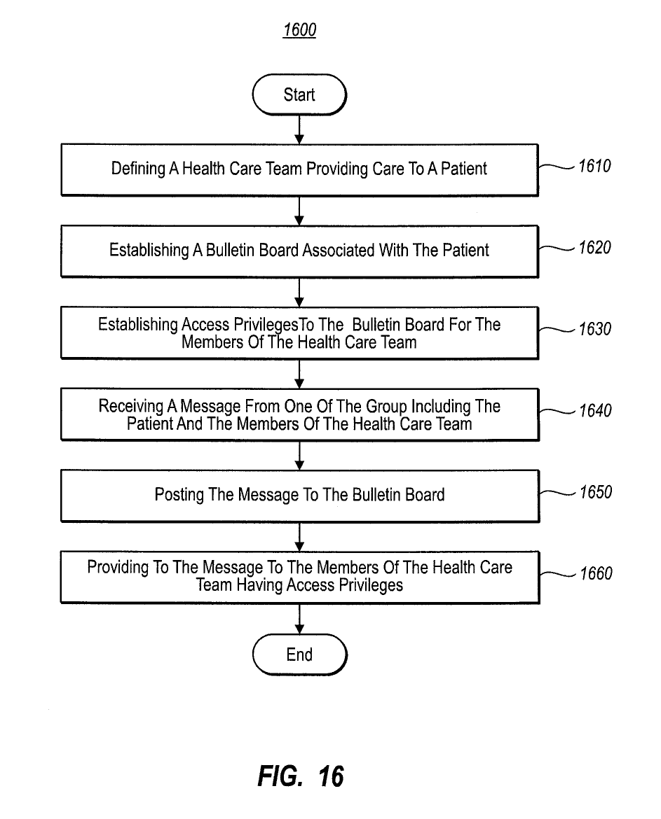

FIG. 16 is a block diagram of a system 1500 for providing care to a patient, and more specifically for facilitating communication between a patient and members of a health care team providing coordinated care to the patient.

Communication is implemented through a bulletin board 1510 supported and managed through the central platform 130 of FIG. 1A, in one embodiment. The bulletin board is associated with the patient, as it facilitates coordinated care for the patient. The central platform is accessible to the patient and members of the health care team, however, only those members with access privileges can access the bulletin board. As such, the patient and members of the health care team are able to access messages intended for the entire group, or at least those with access privileges, so that coordinated care is provided to the patient. As such, one message is propagated to everyone in the group.

The system 1500 includes one or more access privileges 1520 defining access to the bulletin board for the members of the health care team. In one implementation, access privileges are defined by the patient. That is, the patient controls who can access the bulletin board in general. In that manner, the bulletin board becomes a community board accessible by all who have privileges as controlled by the patient.

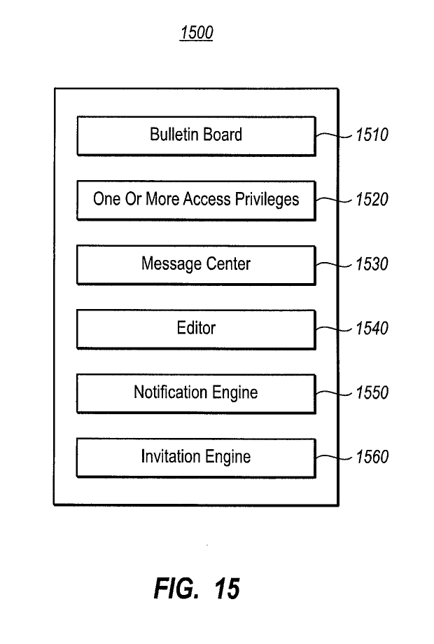

The system 1500 also includes a message center for providing access to the bulletin board 1510 to members of the health care team having access privileges. That is, the message center is included within the central platform 130 providing online health services, and in particular, the message center controls access to a bulletin board associated with a patient. A permissioning engine (not shown in FIG. 15) is also included for establishing access privileges to the bulletin board. In one embodiment, the editor 1540 also provides permissioning functionality

In one embodiment, the message center automatically grants privileges to the patient to access the bulletin board, since the bulletin board is provided for the benefit of the patient. In other embodiments, the message center imposes additional restrictions on access to a private portion of the bulletin board, as will be detailed below.

The system 1500 also includes an editor 1540 for interfacing with a poster of the message. Specifically, the editor interfaces with the poster in order to facilitate creation of the message. Typically, the poster of the message is one of the group including the patient and the members of the health care team. As such, the message center facilitates communication between members of the group interested in and providing care to the patient.

A notification engine 1550 is also included within system 1500 for providing generic notification of the posting of the message to the bulletin board, and more specifically, for delivering the generic notification to the patient and to members of the health care team having access privileges. In one embodiment, the generic notification is not sent to the poster of the message. In another embodiment, the generic notification is delivered through a data delivery system that this separate from the central platform 130 and the message center 1530 of system 1500.

To comply with HIPPA guidelines regarding handling of sensitive information, the message center provides for secure messaging through the use of the generic notification. Specifically, the generic notification does not include information indentifying the poster of the message, and does not include information identifying the contents of the message. That is, the generic notification just informs the recipient that a message has been posted to a bulletin board for a particular patient. Access to the board is presumed to be compliant with secure guidelines (e.g., HIPPA guidelines) since authorization must be provided before accessing the central platform 130 and the bulletin board.

In addition, system 1500 also includes an invitation engine 1560. The invitation engine provides for inviting potential members to join the health care team, and to establish access privileges to the bulletin board for those members who join. In one implementation, the patient controls who joins the health care team, and who is able to access the bulletin board. In one embodiment, an invitation to join the health care team is created by the patient and is intended for a potential member. The invitation may include a permission for the potential member to access the bulletin board associated with the patient, in one case. In another case, the invitation does not include a permission for the potential member to access the bulletin board associated with the patient. After completion, the invitation engine delivers the invitation to the potential member through an alternate data delivery system (e.g., email).

The invitation engine is configured to receive acceptance of the invitation from the potential member. In that case, the potential member is added as an authorized member to the health care team. Permission to access the bulletin board is also provided if extended in the invitation. Otherwise, permission to access the bulletin board is not provided if not extended. Also, an acceptance may be detailed in a message that is posted to the bulletin board on behalf of the patient.

Also, the invitation engine is configured to receive rejection of the invitation from the potential member. In this case, the potential member is not added to the health care team, and permission to access the bulletin board is also not extended. The rejection of the invitation may also be detailed in a message that is posted to the bulletin board on behalf of the patient.

Moreover, the invitation engine is configured to receive a withdrawal of a permission to access the bulletin board for a specific member of the health care team. For instance, the patient may withdraw a permission for the authorized member to access the bulletin board. In this case, although the entity is still a member of the health care team, no access privileges to the bulletin board are granted. As such, the message center prevents access to the bulletin board by that member.

It is important to note that the message center is also configured to distribute system messages through the bulletin board. For instance, the central platform 130 is able to monitor a condition of the patient through a monitor. If an alert is generated by an alert engine in relation to the monitoring, then that alert is distributed through the bulletin board by the message center. For instance, a program manager manages a health program, and access to the health program by the patient. The health program includes an interactive rules based logic tree that generates a result based on responses by the patient. The alert engine is capable of generating the system message based on the result, wherein the system message is delivered through the message center and bulletin board.

FIG. 16 is a flow chart 1600 implementing a method for providing care, and more specifically for facilitating communication between members of a group including a patient and members of a health care team providing care to the patient. Moreover, the flow chart 1600 illustrates a method for establishing a bulletin board to which messages are posted, wherein access to the bulletin board is provided to members of the health care team having access privileges, in accordance with one embodiment of the present invention.

Flow chart 1600 begins by defining a health care team 1610 comprising one or more members, such as a health care professional, a family care giver, etc. The health care team provides coordinated care to the patient. In addition, a bulletin board is established 1620 that is supported by the central platform 130 of FIG. 1A. The bulletin board facilities communication between the patient and members of the health care team. That is, the bulletin board is associated with the patient, and as such, messages posted to the bulletin board may be viewed by one or more members of the health care team, thereby providing coordinated care to the patient.

In addition, access privileges are established 1630 for members of the health care team, as previously described. In one implementation, the patient sets the access privileges. As such, the patient maintains control over how has access to the bulletin board, and in one embodiment always has access to the bulletin board.

Further, a message is received 1640 from one of a group including the patient and the members of the health care team. The message is posted to the bulletin board 1650, as being relevant to the care of the patient. Thereafter, the message center 1530 provides access 1660 to those members of the health care team having access privileges, as defined and granted by the patient.

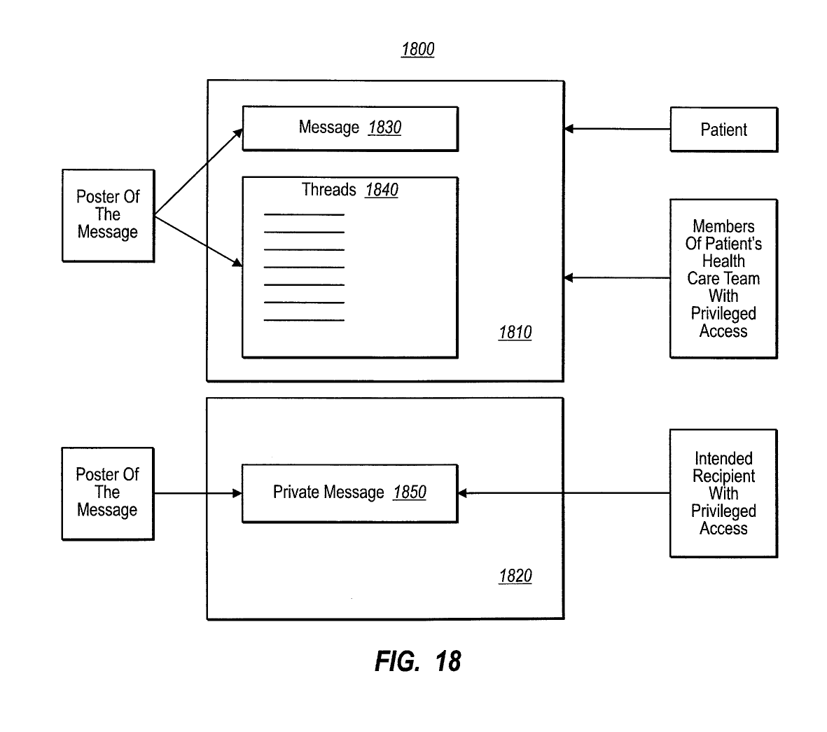

FIG. 18 is a diagram illustrating a bulletin board 1800 associated with a patient, in accordance with one embodiment of the present invention. As shown, the bulletin board is partitioned out into two sections, a community bulletin board 1810 and a private bulletin board 1820.

As shown in FIG. 18, the community bulletin board 1810 allows a poster to post a message 1830 to the bulletin board. In addition, the community bulletin board 1810 allows a poster to post a message within a thread of communication 1840. For instance, first and second messages are received from the group. Both the messages are posted to and integrated within the thread of communication 1840. Notification of the first and second postings are also provided to those who have access privileges to the bulletin board. Access is provided to those how have access privileges. In both cases, the messages are accessible through the bulletin board to all members of the health care team having access privileges. In addition, the patient is able to access the bulletin board to view the two messages.

Further, FIG. 18 also includes a private bulletin board 1820. In this case, a private message 1850 is intended only for viewing by identified recipients. As before, the poster generates the private message using the editor 1540, but also provides additional information that identifies the recipients. As such, when the message is generated, one or more recipients of the message are also identified. The identified recipients may be less than the number of members who have access privileges, to include the patient. In addition, the recipients must have access privileges to the bulletin board. Those recipients not having access privileges will not be able to access the message on the bulletin board.

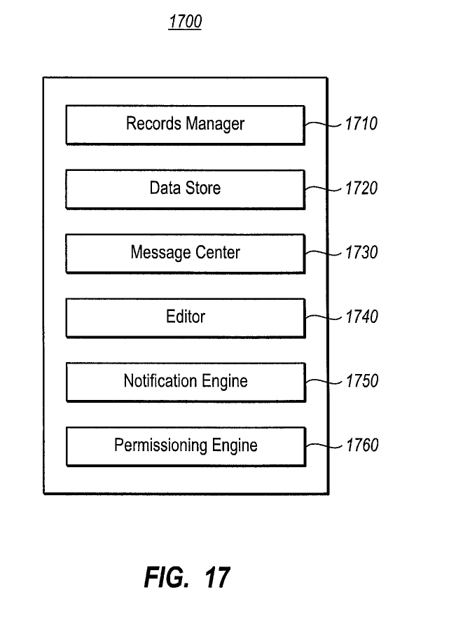

Turning now to FIG. 17, a platform 1700 is disclosed for providing care to a patient, and more specifically to a platform for facilitating bi-lateral communication between members of a group including the patient and members of a health care team providing coordinated care to the patient. The platform also includes a records manager 1710 for managing a health record of the patient. The records manager obtains information used in the health record from at least one of a plurality of information sources related to the patient and/or members of the health care team. For instance, the health record may be maintained by the patient, and as such, the patient delivers the information to the records manager for inclusion in the health record. In another instance, the health record is maintained by a health care professional, or a related organization supporting the health care professional. Information may be sent to the records manager by the health care professional for inclusion into the health record. In addition, the records manager may access a records management system implemented by the health care professional in order to access information for inclusion into the health record. Messages related to the health record may be communicated through the bulletin board. Further, the platform 1700 includes a data store 1720 for storing the health record. The system also includes a message for providing access to a message sent to a recipient, wherein the message is sent between a group consisting of the patient and members of the patient's health care team. In addition, the platform 1700 includes a message center for providing access to a message to a recipient comprising one of a group including the patient and the members of the health care team.

Platform 1700 is configured to distribute system messages through the bulletin board. For instance, the platform 1700 is able to monitor a condition of the patient through a monitor, such as the health program. If an alert is generated by an alert engine in relation to the monitoring, then that alert is distributed through the bulletin board by the message center 1730. For instance, a program manager manages a health program, and access to the health program by the patient. The health program includes an interactive rules based logic tree that generates a result based on responses by the patient. The alert engine is capable of generating the system message based on the result, wherein the system message is delivered through the message center and bulletin board. In that case, the notification engine 1750 provides notification to those members of the group having access privileges that a notification has been posted to the bulletin board associated with the patient. Access to the message is provided to those how have access privileges, as determined by the permissioning engine 1760 in conjunction with the message center 1730.

In addition, platform 1700 is configured to provide messages through the private bulletin board, in that a message is posted to the bulletin board, and intended only for an intended recipient that is one of the group including the patient and health care team members. More specifically, the editor allows the poster to create the message, and generate an access permission to the message for one or more recipients. That is, the recipients are identified. The message is then posted to the bulletin board associated with the patient, and the message center provides access to the message to intended recipients.

1. A method for providing care, comprising:

establishing a bulletin board associated with a patient;

establishing access privileges to said bulletin board for members of a health care team providing care to the patient;

receiving a message from one of a group including said patient and said members of said health care team;

posting said message to said bulletin board; and

providing access to the message to members of said health care team having access privileges.

2. The method of Claim 1, wherein said defining a health care team comprises:

sending an invitation to a potential member to join said health care team, wherein said invitation includes a permission to access said bulletin board;

receiving an acceptance of said invitation from said potential member to join said health care team;

adding said potential member as an authorized member to said health care team; and

granting access to said bulletin board to said potential member.

3. The method of Claim 2, further comprising:

receiving a withdrawal of said permission for said authorized member to access said health care team; and

preventing access to said bulletin board by said authorized member.

4. The method of Claim 2, further comprising:

sending notification of said acceptance to members of said health care team and to said patient.

5. The method of Claim 1, wherein said defining a health care team comprises:

sending an invitation to a potential member to join said health care team, wherein said invitation includes a permission to access said bulletin board;

receiving a rejection of said invitation from said potential member; and

preventing access to said bulletin board by said potential member.

6. The method of Claim 1, further comprising:

providing access to said bulletin board to said patient

7. The method of Claim 1, further comprising:

providing generic notification of said message to said patient and to said members of said health care team having access privileges through a separate data delivery system.

8. The method of Claim 7, wherein said notification does not include information identifying the poster of said message, and does not include information identifying contents of said message.

9. The method of Claim 1, further comprising:

receiving a second message from one of said members of said health care team;

receiving permissions for access to said message by said patient and members of said health care team;

posting said second message to said bulletin board;

sending notification of said second message to those having permissioned access to said second message; and

providing access to said second message to those having permissioned access to said second message.

10. The method of Claim 1, further comprising:

integrating said message into a thread running on said bulletin board.

11. The method of Claim 1, further comprising:

monitoring a condition of said patient; and

generating said message that comprises a system message based on said monitoring of said condition for posting on said bulletin board.

12. The method of Claim 11, wherein said monitoring a condition comprises:

receiving a request for a health program over a communication network by a network access device associated with said patient, wherein said health program comprises at least one interactive logic tree used for purposes of monitoring said condition;

providing said health program to said network access device;

receiving one or more responses from said network access device;

determining a result based on said one or more responses to said at least one interactive logic tree; and

generating said system message.

13. A system for providing care, comprising:

a health care team providing care to a patient;

a bulletin board associated with said patient;

one or more access privileges defining access to said bulletin board to said members of said health care team; and

a message center providing access to said bulletin board to members of said health care team having access privileges.

14. The system of Claim 13, further comprising:

an editor for interfacing with a poster of a message, comprising one of said patient and said members of said health care team, in order to create said message, to establish said access privileges, and to post said message to said bulletin board.

15. The system of Claim 14, further comprising:

a notification engine for providing a generic notification of a posting of a message to said bulletin board, and for delivering said generic notification to said patient and to said members of said health care team having access privileges.

16. The system of Claim 15, wherein said generic notification does not include information identifying a poster of said message, and does not include information identifying contents of said message.

17. The system of Claim 15, wherein said generic notification is delivered through a separate data delivery system.

18. The system of Claim 13, further comprising:

an invitation engine for creating an invitation by said patient to join said health care team, wherein said invitation includes a permission to access said bulletin board, wherein said invitation engine is configured to send said invitation to a potential member.

19. The system of Claim 18, wherein said invitation engine is configured to receive acceptance of said invitation from said potential member and add said potential member as an authorized member to said health care team.

20. The system of Claim 19, wherein said invitation engine is configured to receive a withdrawal of said permission for said authorized member to access said health care team, wherein said message center prevents access to said bulletin board to said authorized member.

21. The system of Claim 13, further comprising:

an editor for interfacing with a poster of a message, comprising one of said patient and said members of said health care team, in order to create said message and post said message to said bulletin board;

a set of permissions for access to said message by said patient and members of said health care team, wherein said message center provides access to said message to those having permissioned access to said message.

22. The system of Claim 13, further comprising:

a monitor for monitoring a condition of said patient;

an alert engine for generating a message that comprises a system message based on said monitoring of said condition for posting on said bulletin board.

23. The system of Claim 22, further comprising:

a program manager for providing access to a health program by a network access device associated with said patient, wherein said health program comprises at least one corresponding interactive logic tree used for purposes of monitoring said condition, wherein said at least one corresponding interactive logic tree reaches a result based on one or more responses from said patient, and wherein said alert engine generates said system message based on said result.

24. A platform for facilitating communication, comprising:

a health care team providing care to a patient;

a records manager for managing a health record of said patient, wherein said records manager obtains information used in said health record from at least one of a plurality of information sources related to said patient and members of said health care team;

a data store for storing said health record; and

a message center for providing access to a message to a recipient comprising one of said patient and said members of said health care team.

25. The platform of Claim 24, wherein said message center further comprises:

an editor for allowing a poster comprising one of said patient and said members of said health care team to create said message, generate an access permission for said recipient, and to post said message to a bulletin board associated with said patient, wherein said message center provides access to said message to those having access privileges.

26. The platform of Claim 24, wherein said message center further comprises:

a notification engine for providing a generic notification message to said recipient of a delivery of said message.

### Granular Access to Information Contained in Health Records

In still another embodiment, a system is disclosed for providing medical information, and more specifically for providing granular access to medical information contained in a health record. The system is utilized within the central platform 130 of the system 100A of FIG. 1A, in one embodiment. In addition, implementation of the system for providing granular access to information in a health record is consistent with FIGS. 1-14 and supporting specification providing online health services for purposes of remotely monitoring the health of patients, and for monitoring compliance of those patients in performing health related tasks.

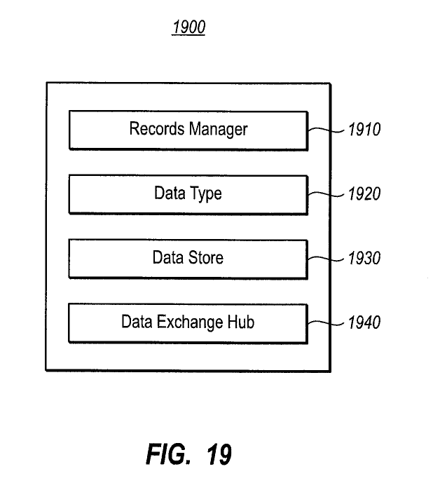

FIG. 19 is a block diagram of a system 1900 providing granular access to information in a health record, in accordance with one embodiment of the present invention. The system 1900 includes a records manager 1910 for managing a health record related to a patient. The health record is created by an originator, such as the patient in the case of managing a personal health record, or a health care professional that provides care to the patient in the case of managing a clinical health record of the patient. The records manager obtains information used in the health record from at least one of a plurality of information sources related to the patient and/or members of the health care team. For instance, the health record may be maintained by the patient as a personal health record, and as such, the patient delivers the information to the records manager for inclusion in the health record. In another instance, the health record is maintained by a health care professional, or a related organization supporting the health care professional, as a clinical record. Information may be sent to the records manager by the health care professional for inclusion into the health record. In addition, the records manager may access a records management system implemented by the health care professional in order to access information for inclusion into the health record.

Further, the health record in the system 1900 includes at least one data type 1920 comprising information. That is, information in the health record is categorized into data types, such as blood type, lab results, etc. Essentially, the health record is partitioned according to data types, for purposes of providing granular access to the information, in one embodiment.

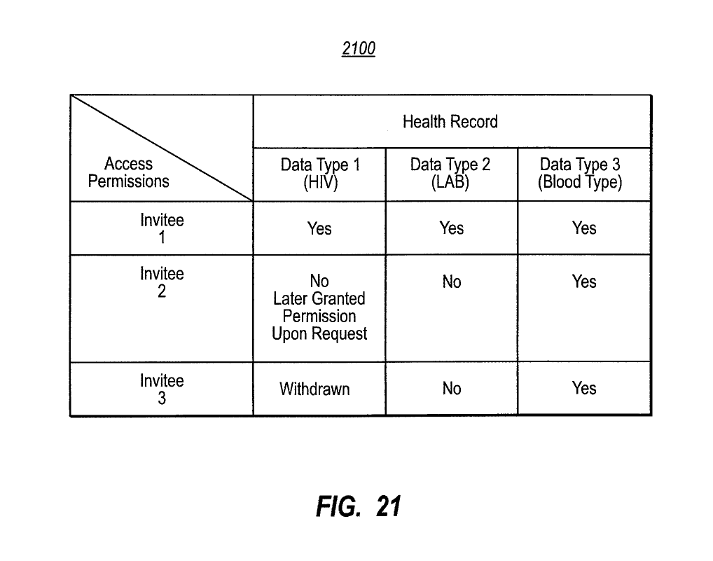

For illustration, FIG. 21 is a table 2100 illustrating a health record and the categorization of information by data type in the health record, in accordance with one embodiment of the present invention. As shown, the health record 2110 includes three data types: data type 1 related to HIV status; data type 2 related to lab results; and data type 3 related to blood type. Accordingly, information in the health record can be partitioned according to data type. In addition, the data type is similar to the data type used in linking data across the central platform 130 of FIG. 1A.

In addition, the platform includes a data store 1930 for storing the health record. Data store is similar to the data store 150 of FIG. 1A. Also, a data exchange hub 1940 is included for providing access to the health record to said patient and members of a health care team providing care to said patient, wherein access is controlled by said originator.

More particularly, the data exchange hub 1940 provides for granular access to the information in the health record according to permissions defining access privileges for each of the data types in the health record. Specifically, a permissioning engine (not shown) facilitates the defining of one or more permissions via access privileges for an invitee to access a corresponding health record. Access privileges are defined by the originator of the health record.

A situational example is provided for illustration purposes. A patient is involved in a relationship with HCP-1, such as a general practitioner. HCP-1 is a member of the health care team providing coordinated care to the patient. In addition, HCP-1 also maintains a health record containing information related to the patient. For instance, that information may be extensive, and include HIV status, blood type, physical disorders, lab results, etc. The health record is maintained by the central platform 130 of FIG. 1A throughout the duration. At a particular time, the patient breaks a leg, and requires surgery by an orthopedic surgeon, HCP-2. The patient invites the orthopedic surgeon to join his or her health care team. The orthopedic surgeon may be interested in information contained in the health record maintained by the family practitioner, HCP-1. While, HCP-1 is obliging, the family practitioner may elect to withhold certain information from the orthopedic surgeon, HCP-2, due to the sensitive nature of the information. Embodiments of the present invention provide for that granular access to information in the health record by HCP-2, as defined by the originator of the record, HCP-1, the family practitioner.

Other situational examples are envisioned. For instance, the originator of the health record is a HCP, wherein the invitee is the patient, or a representative of the patient, such as the FCG. In another instance, the originator of the health record is the patient, or a representative of the patient, such as the FCG. The invitee is a HCP, who may be treating the patient, and would like to view and/or modify the past medical history of the patient that is recorded in the personal health record of the patient. In still another instance, the originator is a HCP, and the invitee is another HCP, as is illustrated in the above example.

For instance, continuing with the example above, the orthopedic surgeon requests from the family practitioner, HCP-1, access to the health record. As such, as the originator of the health record, HCP-1 interfaces with an invitation engine (not shown) to send an invitation to the orthopedic surgeon, HCP-2, to share access to the health record, subject to one or more permissions. The invitee (e.g., HCP-2) is included in a group including the patient and members of the health care team providing care to the patient, in one embodiment. In another embodiment, the invitee is asked to join the health care team in the invitation.

Looking at table 2100 of FIG. 21, HCP-1 may invite HCP-2, as invitee-2 to share access to the health record 2110. Contained within the invitation are permissions arranged according to data type. For instance, the health record may contain information related to HIV status in data type 1, lab results in data type 2, and blood type in data type 3. As shown in Table 2110, the invitation grants permission to access data type 3 (blood type), but not to the other data types 1 and 2.

HCP-2, the orthopedic surgeon accepts the invitation. The invitation engine is configured to receive the acceptance, whereupon the data exchange hub provides access to the health record based on the one or more permissions. In this case, HCP-2 is able to access at least data type 3 in the health record. In addition, the invitation engine is also configured to receive a rejection of the invitation, whereupon the data exchange hub denies access to the health record by the invitee.

Upon further request and review, HCP-2, the orthopedic surgeon requests data type 1, the HIV status, since surgery is involved and extra care need be taken when the blood of a patient is infected with HIV. At this time, the family practitioner, HCP-1 may now grant permission to access data type 1 for HCP-2, the orthopedic surgeon, as shown in table 2100. No further invitation need be sent to accomplish this result.

In one embodiment, the invitation for sharing access to the health record includes a permission that allows the invitee to view a corresponding data type of information. That is, the invitee may only read the information, and possibly transport that information. For instance, the originator of the health record may want to maintain clinical integrity of the health record.

In another embodiment, the invitation for sharing access to the health record includes a permission that allows the invitee to modify a corresponding data type of information. That is, the invitee may read, and modify the information contained within the health record that is maintained in the data store 1930.

In still another embodiment, a filter is provided to provide additional granularity for accessing information within a particular data type. For instance, the permissions may further partition out the categories of information contained within a data type of information. As such, an invitee may be able to access only selected information within a data type, as defined in a corresponding permission.

Continuing with table 2100, access privileges are provided for invitees to access information in a granular fashion in a health record, in accordance with one embodiment of the present invention. As shown, invitee 1 is granted full access to the information contained in the health record 2110. That is, invitee 1 can access data types 1, 2, and 3. The permissions may further define whether that access is limited to viewing the information only and/or including the ability to modify a corresponding data type entry.

In addition, just as permissions may be further added, permissions may also be withdrawn. Looking at table 2100, invitee is initially given access to data types 1 (HIV) status, and data type 3 (blood type). For instance, the patient may be undergoing surgery by invitee 3. After completion of the surgery, the originator of the health record withdraw certain permissions as they are no longer needed for purposes of aiding the surgery. As shown in FIG. 2100, the permissions to access data type 1 (HIV status) has now been withdrawn, while the permission for data type 3 remains in place. No invitation is needed to perform this withdrawal, however, a message of the withdrawal may be generated by the system and presented on the bulletin board associated with the patient.

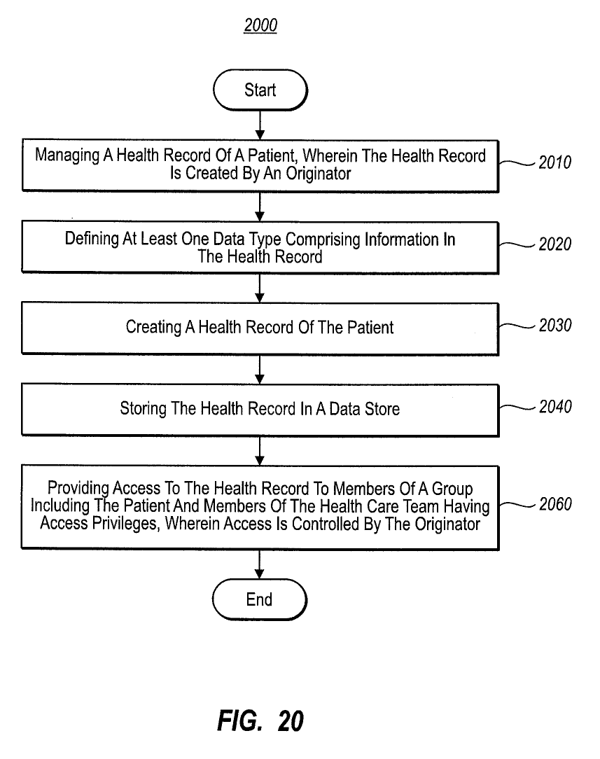

FIG. 20 is a flow chart illustrating a method for providing granular access to information in a health record, in accordance with one embodiment of the present invention. For instance, the method includes managing a health record of a patient 2010, wherein the health record is created by an originator. In one implementation, a records manager obtains information used in the health record from at least one of a plurality of information sources related to the patient and/or members of the health care team. In another implementation, the health record may be maintained by the patient, and as such, the patient delivers the information to the records manager for inclusion in the health record. In another instance, the health record is maintained by a health care professional, or a related organization supporting the health care professional. Information may be sent to the records manager by the health care professional for inclusion into the health record. In addition, the records manager may access a records management system implemented by the health care professional in order to access information for inclusion into the health record.

The method includes defining at least one data type comprising information 2020 included in the health record. That is, information in the health record is categorized into data types, such as blood type, lab results, etc. A health record of the patient is created by the originator, as previously described. The method also includes storing 2040 of the health record in a data store.

Also, access to the health record is provided 2050 to the patient and/or members of the health care team providing coordinated care to the patient, wherein the access is controlled by the originator of the health record through the use of permissions defining access privileges relating to corresponding data types of information in the health record. In particular, one or more permissions are defined for a particular invitee for accessing one or more corresponding data types of information in the health record.

An invitation to share the health record is generated at the request of the originator of the health record, and delivered to the invitee. The invitation invites the invitee to share access (view and/or modify) to the health record subject to any permissions. The originator and the invitee are typically members of a group including the patient and/or members of the health care team providing care to the patient, or may be provisionally contained within the group until acceptance of the invitation. Upon acceptance, access to the health record is provided subject to the permissions. Upon rejection of the invitation, access to the health record is defined. Also, one or more permissions may be withdrawn after acceptance of the invitation, as previously discussed.

1. A platform for providing medical information, comprising:

a records manager for managing a health record of a patient, wherein said health record is created by an originator;

at least one data type comprising information in said health record;

a data store for storing said health record; and

a data exchange hub for providing access to said health record to said patient and members of a health care team providing care to said patient, wherein access is controlled by said originator.

2. The platform of Claim 1, further comprising:

a permissioning engine for defining by said originator one or more permissions for an invitee to access one or more corresponding data types of information; and

an invitation engine for sending an invitation, at a request of said originator, to said invitee to share access to said health record subject to said one or more permissions, wherein said invitee is one of said patient and said members of said health care team.

3. The platform of Claim 2, wherein said invitation includes an invitation to join said health care team.

4. The platform of Claim 2, wherein a permission further comprises:

a filter for filtering access to selected information as defined in a corresponding permission for a corresponding data type of information.

5. The platform of Claim 2, wherein a permission allows said invitee to view a corresponding data type of information when accessing said corresponding data type of information.

6. The platform of Claim 2, wherein a permission allows said invitee to modify a corresponding data type of information when accessing said corresponding data type of information.

7. The platform of Claim 2, wherein said invitation engine is configured to receive an acceptance of said invitation, wherein said data exchange hub provides access to said health record based on said one more permissions to said invitee.

8. The platform of Claim 2, wherein said invitation engine is configured to receive a rejection of said invitation, wherein said data exchange hub denies access to said health record to said invitee.

9. The platform of Claim 1, wherein said originator comprises a health care professional, and wherein said invitee comprises said patient or a representative of said patient.

10. The platform of Claim 1, wherein said originator comprises said patient or a representative of said patient, and wherein said invitee is a health care professional.

11. The platform of Claim 1, wherein said originator comprises a first health care professional, and said invitee comprises a second health care professional.

12. The platform of Claim 1, wherein said health record is a personal health record maintained by a patient, or a clinical record maintained by a health care professions that is a member of said health care team.

13. A method for sharing medical information, comprising:

managing a health record of a patient, wherein said health record is created by an originator;

defining at least one data type comprising information in said health record; creating a health record of a patient;

storing said health record; and

providing access to said health record to said patient and members of a health care team providing care to said patient, wherein access is controlled by said originator.

14. The method of Claim 13, further comprising:

defining one or more permissions for an invitee to access one or more corresponding data types of information in said health record.

15. The method of Claim 14, further comprising:

sending an invitation, at a request of said originator, to said invitee to share access to said health record subject to said one or more permissions, wherein said invitee is one of said patient and said members of said health care team.

16. The method of Claim 15, further comprising:

including an invitation to join said health care team

17. The method of Claim 15, further comprising:

receiving an acceptance of said invitation; and

providing access to said health record subject to said one or more permissions.

18. The method of Claim 17, further comprising:

withdrawing access to said health record by said invitee.

19. The method of Claim 15, further comprising:

receiving a rejection of said invitation; and

denying access to said health record subject to said one or more permissions.

20. The method of Claim 14, further comprising:

defining a permission that allows said invitee to view a corresponding data type of information when accessing said corresponding data type of information.

21. The method of Claim 14, further comprising:

defining a permission that allows said invitee to modify a corresponding data type of information when accessing said corresponding data type of information.

### Other Features of the Healthcare Professionals Portal

The portal for the HCP is designed for patient monitoring and management. As such, the HCP, through a series of tools and reports allows the HCP's to search and sort patients based on session and program results and rules logic. For instance, features available through the HCP Portal include the Session Alerts Viewer (SAV), Patient Charts, Dashboard, Patient Search, Outcomes Management Tools, HCP-Assisted Patient Enrollment, Education Prescription, HCP Tools, HCP Enterprise Application, HCP Control Panel, and Care Coordination Message Center.

Returning back to FIG. 4, a screen shot 400 of a session alerts viewer or dashboard 400 is shown, in accordance with one embodiment of the present invention. The session alerts viewer (SAV) provides an Enterprise HCP with the ability to monitor and manage up to 2,000 Patients associated with their institution. This exception-management tool is used to identify patients who need the most attention according to the alert level criteria established by a particular health program.

As shown in FIG. 4, the SAV can be in a tabular format, consisting of rows and columns. Each row in the SAV contains data on a particular session. As such, the patient with the highest priority, or needing the most immediate attention is listed at the top of the screen of the SAV. For instance, Ryan Acosta's information indicates that his vital signs are at a dangerous level, and as such, he needs the most attention among all of the doctor's patients.

In FIG. 4, columns represent session category data, and include vital signs, medications, symptoms, behavior, knowledge and other. Additional columns include the following: flags, which allows a user to selectively flag patients and then organize them accordingly; risk index, which gives the number of actual patient red level responses divided by the potential patient red level responses; session date, which gives the date of when the session was taken; and medications missed, which indicates missed medications based on data drawn from the medication reminders

HCPs can select which columns they want to show within their view and, by clicking the column headings, sort the data accordingly. In addition, other filters an HCP can use to organize the SAV rows include the following: date range, which gives the range of sessions between a start and end date; list (available to institutional enterprise HCPs only), which lists patients for a particular doctor, or lists all patients (e.g., patients are assigned to an HCP by the institutional Admin); status: “Active”, “Reviewed” or “Needs Follow Up.” In one case, when a row is single-clicked, the Patient Mini-Chart will reload with new data.

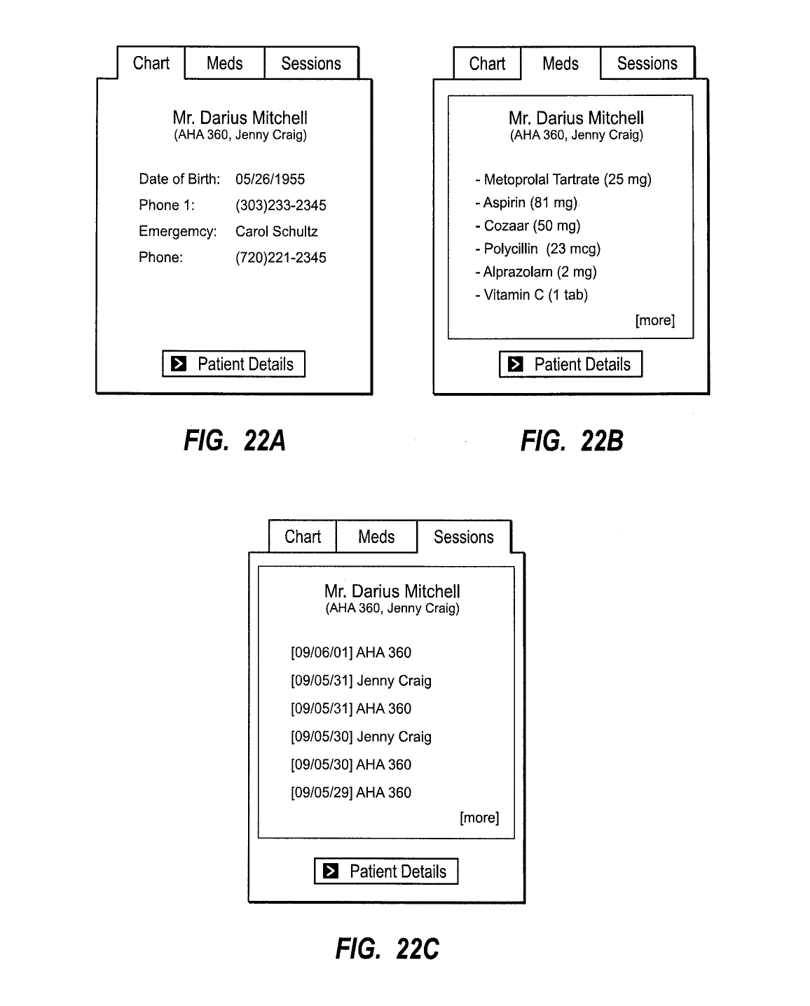

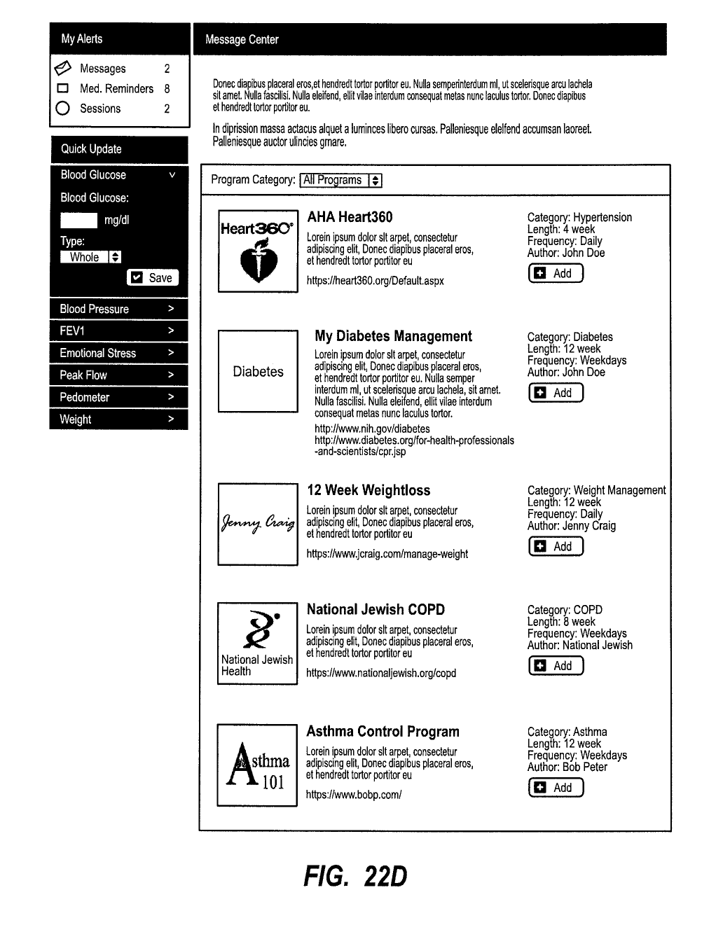

FIGS. 22A-C illustrate patient mini charts, in accordance with one embodiment of the present invention. The patient mini chart widget offers three at-a-glance views into the patient chart. These encompass the basic patient info “Chart” of FIG. 22A, which includes name and contact information, the medications mini chart (“Meds”) of FIG. 22B which lists the medications taken by a patient, and the “Session” mini chart of FIG. 2C, which lists the programs and sessions associated with that user or patient.

FIG. 22D is a complete view of the programs associated with a particular user, in accordance with one embodiment of the present invention. For instance, the programs and sessions listed in FIG. 22C could also be presented in FIG. 22D in a format that provides more information about each of the programs. As shown, a particular user is associated with at least 5 programs: AHA Heart360, My Diabetes Management, 12 Week Weightloss, National Jewish COPD, and Asthma Control Program.

To notify the HCP of those Patients missing sessions, HCPs can reference a widget positioned in the dashboard, in one embodiment. This widget, with similar behavior to the SAV, provides the list of non-responding patients and the respective amount of days missed. Days are color coded to provide a visual reference of the associated risk. For instance, green can indicate that everything is normal in terms of responding to programs, yellow can indicate a caution regarding responding to programs, and red can indicate an alert regarding the non-responsiveness to executing programs for a patient.

The Patient Details offer a view into patient data including session, registration and PHR information. Patient Charts are Patient-specific, meaning that all data within is specific to one individual Patient. In addition, patient charts are activated when one of two actions is performed: 1) when the patient details button is clicked within the patient mini-chart, or alternatively a row within the session alerts viewer can be double clicked; and 2) when a linked result from an executed patient search is clicked. Up to three Patient Charts can be loaded within the HCP portal at a given time. Each Chart is accessible via a corresponding tab on the main navigation, which is created on request, in one embodiment. For instance, tabs include Session Alerts; Patients; Program Author; Control Panel; and Messages (3).

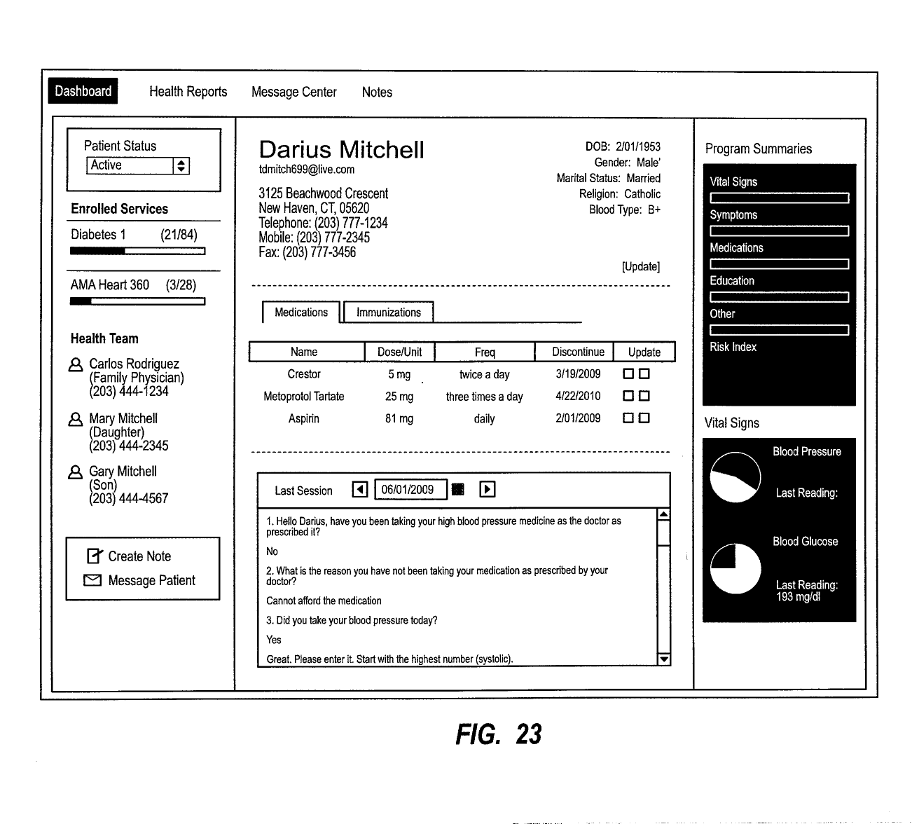

FIG. 23 is a screen shot of a patient chart dashboard for a patient named Darius Mitchell, in accordance with one embodiment of the present invention. The patient chart dashboard provides a rich view into the patient's data within one single page. Data visible on this page includes the following: Patient Status (active, reviewed or needs follow-up); the patient's enrolled services (enrolled programs and/or monitoring); health team information; personal information (e.g., name, email, contact, demographic information, etc.); medications taken by the patient (e.g., Crestor, etc.); program summaries (similar view to SAV) which provides a quick view into important result information related to a program; vital signs report summaries giving a summary of vital signs (e.g., blood pressure, etc.); and past sessions. In addition, additional controls are available that allow the HCP to update data as well as create notes or provide messages to the patient through the message center.

HCPs will also have access to a select number of health reports for a given Patient. Health reports, by default, will only draw data from Healthy Circles-verified session data, in accordance with one embodiment of the present invention. Other reports may be generated from HealthVault data should the HCP elect to see these, in other embodiments.

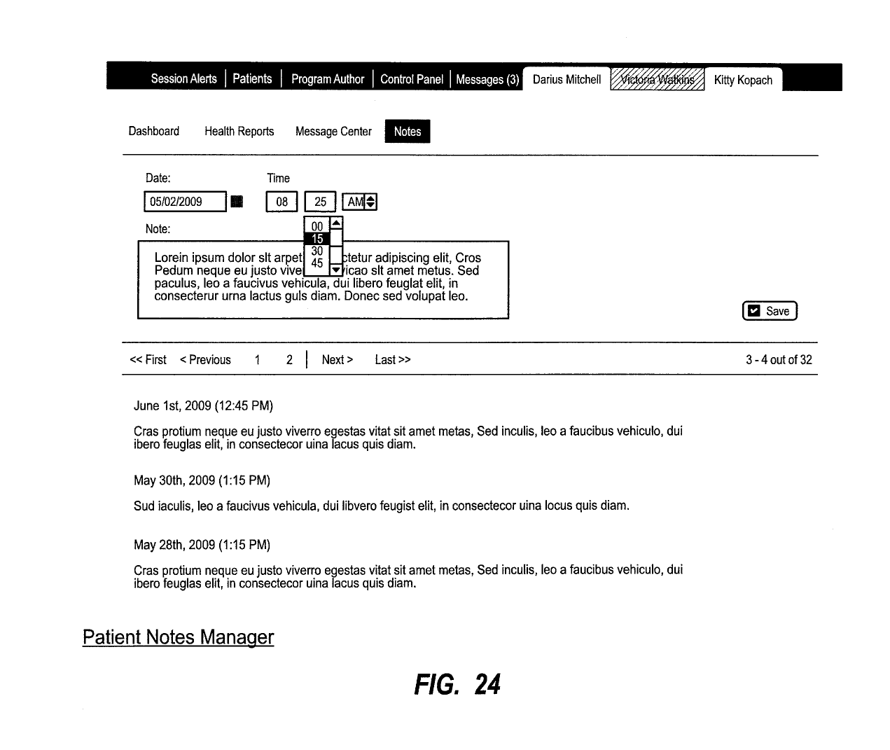

FIG. 24 is a screen shot of an interface with the Patient Notes Manager, in accordance with one embodiment of the present invention. As an example, the notes manager within the Monitoring Center dashboard allows an enterprise HCP to create and manage free-text notes on a patient to document a patient encounter. As shown in FIG. 18, with each note, there is included date and time data, which will be used to sort them accordingly in a table list view.

By default, all data presented with the Patient Details pages is drawn from the local database (e.g., HIPAA-compliant database), in accordance with one embodiment of the present invention. The HCP however can consent to view data drawn directly from HealthVault. This option is made available within the HCP Control Panel. When selecting this option, the HCP is presented with a Clickwrap agreement, where the HCP would be notified of the nature of the data within this section (non HIPAA-compliant). HealthVault data will then propagate its way through the Patient Details (i.e. Dashboard & Health Reports), in one embodiment.

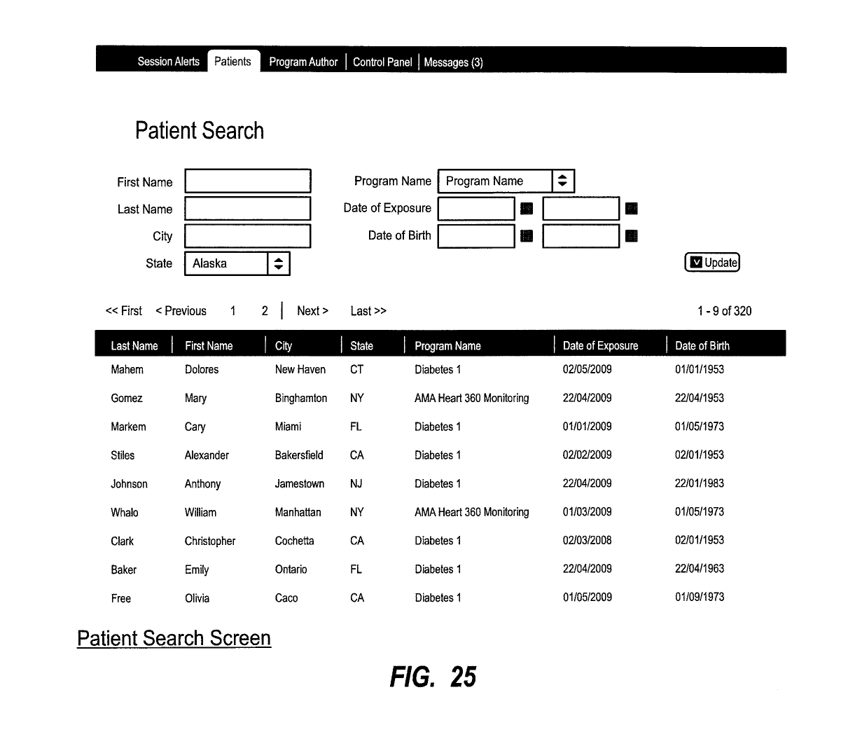

FIG. 25 is a screen shot of the Patient Search tool available within the Healthy Circles Platform, in accordance with one embodiment of the present invention. The Patient Search tool, provides the Enterprise HCP the ability to search for patients within a given institution. By default, a paginated table list view of the entire patient list will be presented. The HCP however can narrow the results list by applying the following search filters: Last Name (free text); First Name (free text); City (free text); State (drop-down menu); Program Name (drop-down menu); Date of enrollment range (double calendar picker); Date of birth range (double calendar picker), etc.

The Outcomes Management Tools offers a set of controls to be used for the purposes of sorting and exporting data. HCPs using sorting and filtering, can select patients, then specify which fields and format they want in the data. Historical reports based on Session data are also available for export.

Enterprise HCPs can enroll members (e.g., patients) into the system. The interface, although containing all the information from the member registration/enrollment, also allows for Enterprise HCPs to rapidly switch back-and-forth between screens. A script widget will also be available to help the Enterprise HCPs communicate with the Enrollee.

In one embodiment, using third-party content (e.g. Krames On-Demand) HCPs can assemble and prescribe educational content in a package format. Packages are assembled based on a patient's condition and/or area of interest and can contain various types of media (PDF, Video, etc.). Packages contain both patient education content and as well as information intended for HCPs. Prescribed educational packages are delivered via the Care Coordination Message Center to Patient, FCG, and the Personal HCP users associated with their profile.

The HCP Tools feature provides information and/or tools available to the HCP member within their respective portal. A tool included is the Encounter Tool, which tracks, displays, and documents encounter history and records. Another tool is the Finance Tool, which tracks and displays real-time revenue generation resulting from professional services provided via the Healthy Circles Platform to Healthy Circles Subscribers. Also, a Database Tool is provided that sorts and exports data for analytics and research. The Practice Guidelines tool includes a library of articles related to current practice guidelines. The Pay for Performance Tools feature documents patient care according to evidence-based health programs. The Performance Improvement Tools feature helps with the maintenance of certification.

Personal HCPs, through their respective portal, are offered promotions to upgrade their membership to Enterprise level, which gives them more access to information, services, and features provided in the Healthy Circles Platform. Clicking one of the promotional links, or clicking a link within their Control Panel, will lead them into the application process.

The HCP Control Panel available through the HCP portal has varying options depending on the HCP user type. The controls (also sections within the Control Panel) described below are categorized as follows: General/All, individual HCP, and institutional HCP. Within the general category, the Account Manager allows HCP Users to update general account settings (see Control Panel under the Patient Portal). Within the individual HCP category, the HCP Enterprise Application allows for the upgrade of an Individual HCP to Enterprise level status (see HCP Enterprise Application). Within the institutional HCP category, the Show HealthVault Data loads HealthVault data into corresponding patient charts & reports (see HealthVault under patient charts). This feature is only available providing an institutional administrator has allowed it.

Also, an institutional administrator includes the HCP User Manager, which allows the HCP User Manager to create, delete, and manage HCP users within an institution. Institutional Administrators can also be created with this tool. The following functions are also available within this feature: Access Level Permissions, which provide permission settings granting HCP users access to individual areas within the HCP portal (e.g., Session Alerts Viewer, Program Authoring Tool, Control Panel sections, etc.); and Patient Assignment, which allows for the assignment of patients to HCPs within an institution.

In addition, the institutional administrator includes a Program Directory, which selects which programs will be endorsed for an institution. A Show HealthVault Data feature allows for the “Show HealthVault Data” function to be made available to Institutional HCPs. The Content Management System allows for the maintenance of site-wide editorial content. The Clinical Reports feature lists reports providing logs on clinical updates throughout the system, and tracks clinical user activity and participant updates, which is compliant with HIPAA requirements, in one embodiment. The Progress Reports provides controls to activate and customize Progress Reports which are sent out by way of the Care Coordination Message Center, in one embodiment. Also, Miscellaneous Controls are provided that relate to display settings, units of measurement, time zone, etc.

A Care Coordination Message Center is also available to HCPs. This allows communication to be delivered through a common message center between a patient, his or her FCGs, and corresponding HCPs. The message center will be further described below.

### Features of the Patient Portal

The patient portal allows for patients to access various features provided by the Healthy Circles Platform, such as Patient Sessions, Health Program Directory, Care Coordination Message Center, Medication Reminders, IVR, Patient Mobile Terminals, HCP Directory, Incentives/Goals, Health Reports, Patient Health Profile, Document Manager, Patient Control Panel, Knowledge Center/Content Syndication, and Widgets.

In the Patient Session feature, a session includes a set of questions and corresponding answer choices generated by a chosen Health Program. This set of questions is then delivered to the patient via a home computer (web-browser or desktop Widget/Gadget) as well as a choice of either Mobile Phone or IVR interfaces, as well as other means for communication. The schedule for a patient session is determined by the author of the health program.

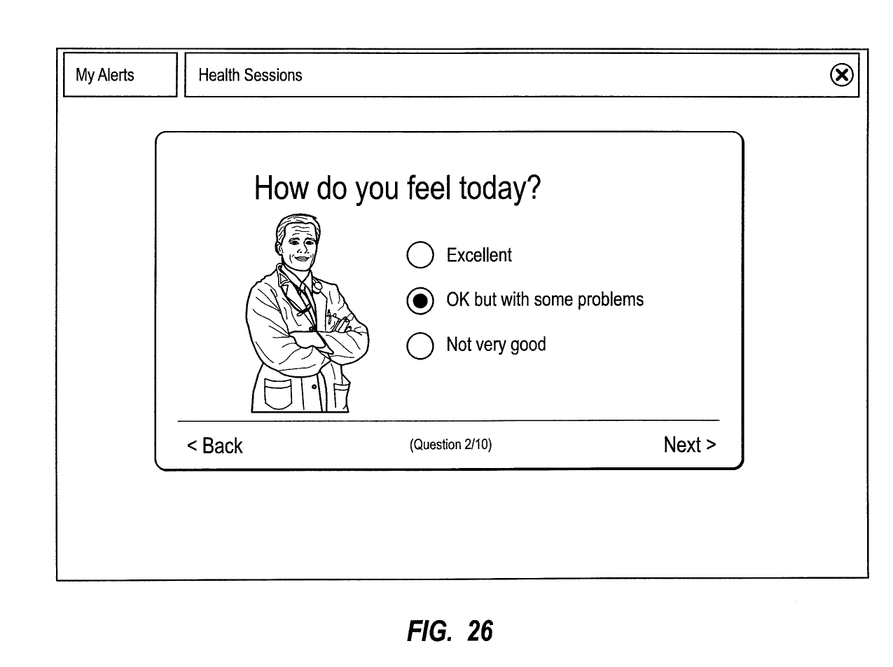

FIG. 26 provides a screen shot of a sample question in a session, in accordance with one embodiment of the present invention. For instance, the query is asking the patient his overall condition. A luke warm response is provided in return by the patient, and inputted via the interface.

As an additional feature, patients may receive a text message via their mobile phone notifying them that a new patient session is available, or that the session is scheduled for execution by the patient.

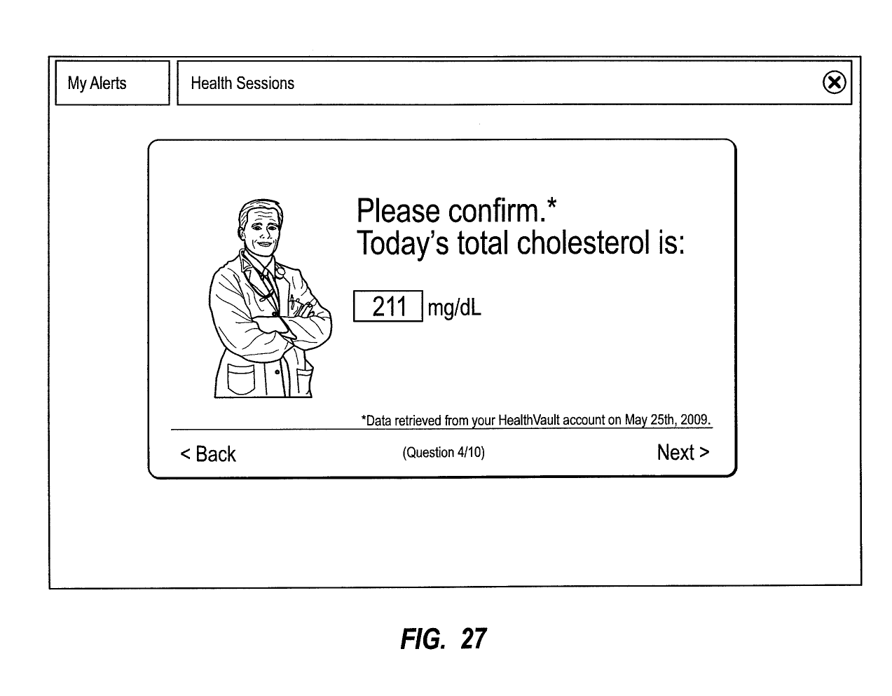

Vital Signs Query Groups are unique in that a Patient is prompted for a direct-input numerical response instead of a multiple-choice selection. Vital signs values can also be retrieved directly from HealthVault, in which case the user is prompted to simply confirm their response instead of entering it. FIG. 27 is a screen shot showing a question from a vital signs session, in accordance with one embodiment of the present invention. The patient is required to input a cholesterol value.

Also, each scheduled patient session not taken within a period greater than 24 hours will be flagged as a Non-Response. Non-Response data is recorded and reported to the FCG and presented within the Sessions Alerts Viewer (SAV) Non-Responders widget, in one embodiment. Non-Responses will also trigger notices to the FCG, Personal HCP, and Enterprise HCP's via the Care Coordination Message Center, in another embodiment.

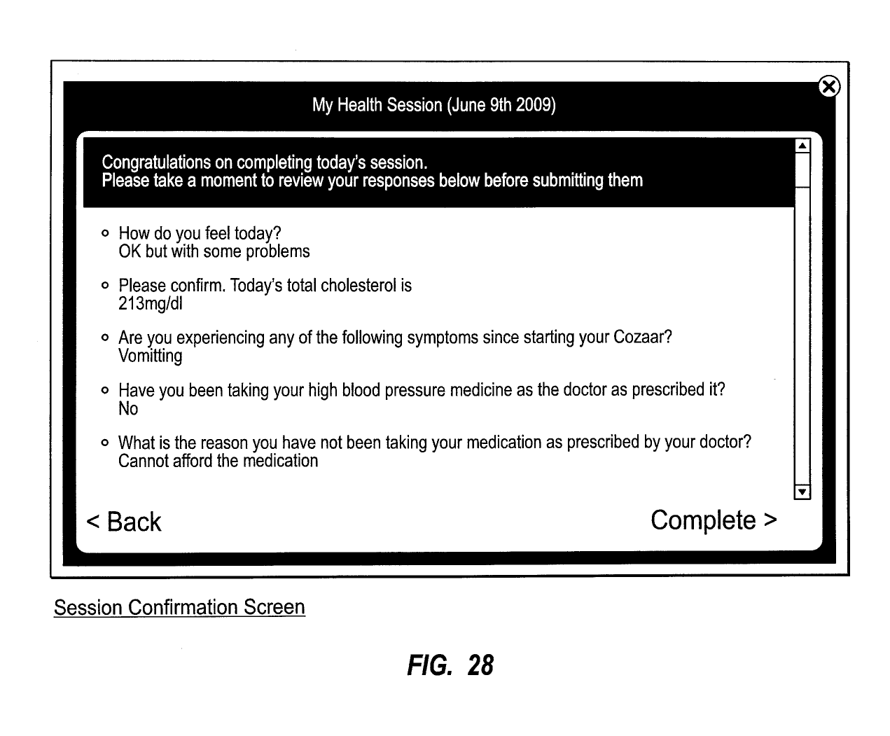

Once a session has been completed, the collected session data is presented to the user for confirmation. For instance, FIG. 28 is a screen shot showing a summary of the session completed by the patient, in accordance with one embodiment of the present invention. These results are tallied and used to produce alerts and/or reports within the Health Reports, Monitoring Center and Healthy Circles Messaging modules.

In the event a Patient doesn't complete a Session, he or she has the option to finish the session at a later time. In another embodiment, Sessions must be completed in sequence and cannot be skipped. In other embodiments, sessions may be completed out of order.

Patients having chosen responses associated with Session Follow-Up Links (see Health Program Authoring Tool) will be presented with a final screen informing them of the content to be delivered to them within the Messaging Center. For instance, the patient is notified that “Based on your responses from today's session, information has been mailed to you and is available within the Message Center.”

The Health Program Directory provides a list of programs available for enrollment by the patient. For instance, patients, upon enrollment, and/or completing a Health Program, can enroll in a new program courtesy of the Health Program Directory.

Enterprise HCPs will also have access to unique versions of the Health Program Directory which will allow them to perform the following functions: access programs they themselves have authored for editing; access programs which are available for templating and/or manipulation; select which programs they wish to monitor against; and select which programs will be endorsed for an institution.

The Care Coordination Message Center facilitates communication between Health Team Members (Patient, FCC, Personal HCP, and Enterprise HCP); or between the users and the system. That is, the message center facilitates centralized communication with the user and the monitoring agent, wherein the message center is accessible by said user and said monitoring agent. This supports bi-lateral communication between the parties.

In one embodiment, users will be presented with a blog-like interface, where they can sort and delete messages. In addition to this, they can reply to threads or create new ones. Threads will allow all Health Team Members to scan over the entire history of conversations including Educational Links sent out through Patient Sessions. As such, the Care Coordination Message Center allows for bilateral communication between the HCP and the patient. For instance, the doctor is able to access the message center for the patient, and input directly comments relating to that patient.

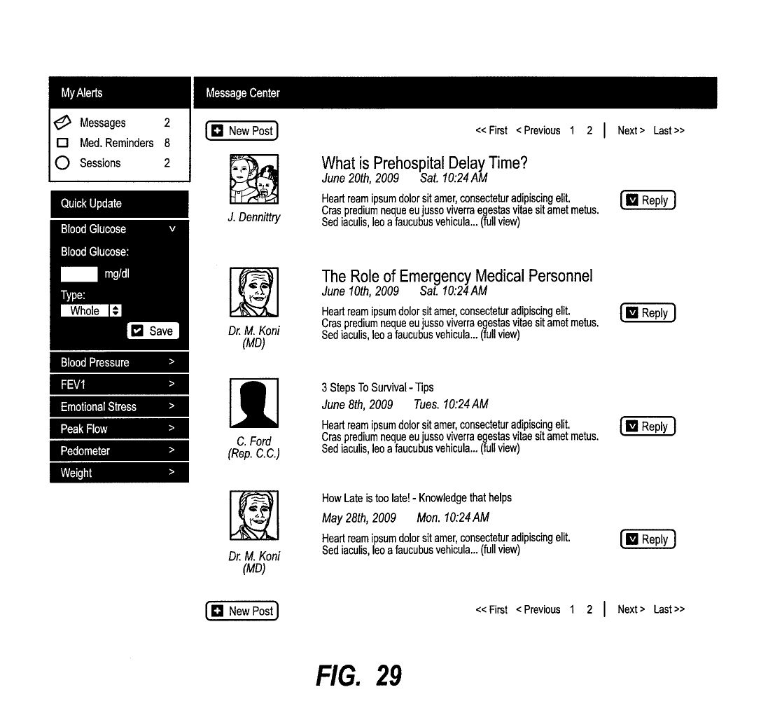

FIG. 29 is a screen shot of a care coordination message center landing page for a particular patient, in accordance with one embodiment of the present invention. For instance, using a user's external email address collected during Enrollment, users will be alerted to new messages and/or replies to existing threads available within the message center. For security purposes, external email alerts will only state that there is a message waiting for them, but not share information as to the contents or sender, in one embodiment. As shown in FIG. 29, various messages are available to the patient, including a message from J. Demittry addressing prehospital delay time.

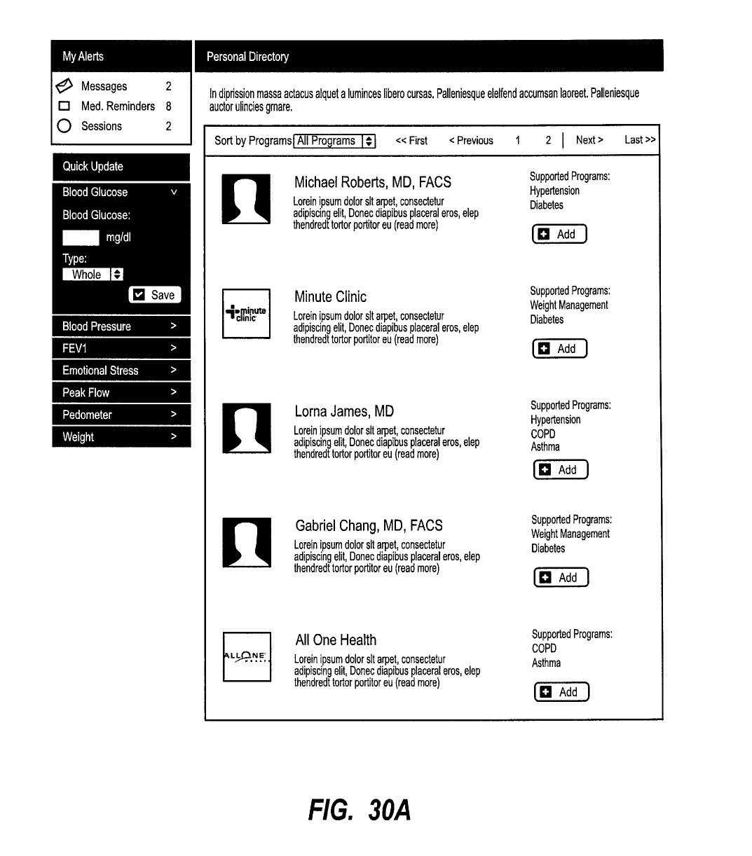

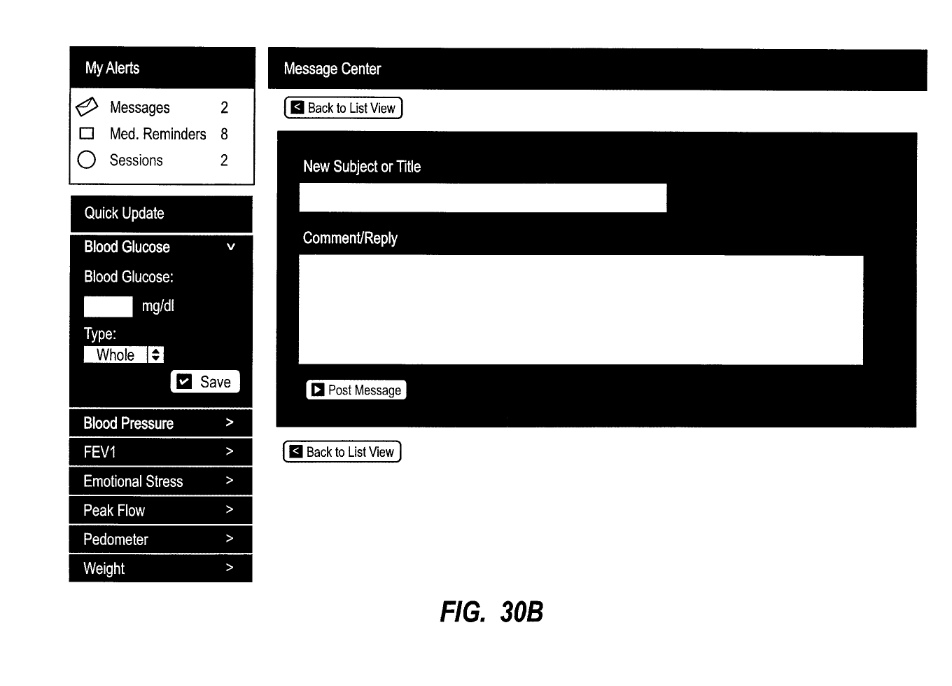

FIG. 30B is a screen shot of an interface providing an avenue for presenting a message for entry within the care coordination message center landing page, in accordance with one embodiment of the present invention.

Additionally, the Healthy Circles Platform can be configured to send periodic Progress Reports to members of the Health Team with information based on Patient Sessions within a given time period, in one embodiment. By default, a Progress Report will be generated every 30 days from the date of Patient enrollment. This feature is configured using the HCP Control Panel.

Progress Reports can include the following Metrics (subject to the HCP Control Panel settings): 1) number of sessions completed; 2) number of missed sessions; 3) session compliance (e.g., the ratio of completed sessions versus total sessions assigned to the user); 4) completed session alert levels summary; and 5) health report summaries.

Another feature provided by the Healthy Circles Platform allows patients to opt-into participation with Medication Reminders through Registration/Enrollment or, alternatively, through the Control Panel. These reminders can be presented to Patients through Health Program Patient Sessions or by Widgets and Gadgets. Medication Reminders are independent of health programs (not counted in missed sessions) and therefore data gathered from them will be presented in a separate column in the Session Alerts Viewer, in one embodiment.

The Healthy Circles Platform also provides for interactive voice recognition (IVR technology. Programs, in the form of sessions, and authored within the Health Program Authoring Tool will be optionally delivered to Patients using IVR technology. As such, as an alternative to using the online Health Program Patient Sessions or the Patient Mobile Portals, a Patient may choose to receive a phone call where an automated service will verify the Patient identity, then ask all Patient Session questions and record all responses. Thereafter, the information will be converted and inputted into textual format for entry into the Healthy Circles Platform.

The Healthy Circles Platform also provides for patient access via patient mobile portals. That is, through a secure and encrypted connection via wireless network, a patient will have the option to receive Patient Sessions or access their Personal Health Profile via a Mobile Phone Device, or any other mobile device (e.g., PDA, satellite phone, etc.).

For instance, secure and encrypted connection via wireless network from AOM to Mobile is provided to the patient. This feature provides the ability for an authenticated user, from a known device, to enter a PIN unlock code that will automatically generate a random 6-digit one-time password to connect to a pre-determined P address and bi-laterally authenticate with the mobile server, in accordance with one embodiment of the present invention. When these conditions are met, the mobile application and mobile server will synchronize.

In addition, the Healthy Circles Platform accommodates users to fax data from mobile devices to fax machines, in one embodiment. Optionally, SMS and email can also be used as a channel if secure services are available.

The Healthy Circles Platform also allows rescue workers and first responders to access User “emergency information” without entering a local PIN onto the mobile phone. This is contemplated in a “break the glass/emergency” context. The user has the ability to opt-in/or opt-out of having this feature enabled on his mobile phone. If the user opts in, any user data elements marked for emergency access would be available to anyone accessing the emergency information. Emergency data elements may be captured in the same card (e.g. Emergency info card) or distributed across several cards. Access of the Emergency Information will leave a VISIBLE MARK (trace) on the Mobile application, so with the next use, a User would know that this had been accessed by someone, and include a date and time stamp. The VISIBLE TRACE can only be reset by the user after logging in securely, in one embodiment.

Also, the Active Link Card feature allows administrators to push specific rich media content and mobile application Internet links to selected users (e.g., find a doctor, check my BMI, view services offered directly by the satellites connected to Microsoft HealthVault). Without leaving the mobile device, Users can access prepared or third party content that may be relevant to their conditions, etc. These temporary links dramatically reduce custom programming at the mobile level and reduce the size of the secure mobile as they need not necessarily have to store any application code or content, in one embodiment. Users also do not have to launch the browser, enter URLs or find bookmarks, in another embodiment.

The thumbnails and images feature allows users to download and view thumbnails on their mobile phones. The original Image Meta data and associated thumbnails will be downloaded and stored on the phone during the Mobile and mobile server data sync. The User may have the option to download and view the original image on some mobile platforms. When the original image is downloaded to the device, it may be viewed within the Mobile application or within the mobile browser. The original image is only downloaded for display and is never stored in the device.

The HCP Directory provides patients with a directory of Enterprise HCPs, each of which is capable of providing monitoring service. Healthcare Professionals will be able to apply for this listing through the HCP Enterprise Application form by way of a link in the HCP Control Panel. For instance, FIG. 30A is a screen shot of a sample HCP directory listing doctors and clinics available to a patient.

In one embodiment, incentives and goals are assigned or given to the patient/user as a means to engage Patients and to encourage their return. This incentive/goal system is based on Patient Activity Data, which includes data collected from the patient through the sessions, device measurements, or directly input into associated health reports. A widget or series of widgets will report on a Patient's progress compared to their goals. Goals are set within individual Health Reports but also by the system for Sessions. The session goal, for example, is for a patient to complete 100% of their sessions each week.

Health Reports includes a series of reports based on dialogue history, as well as device and/or manual input. Reports are fully customizable and available in a number of formats. Consistent with the generation of health reports, an input mechanism is provided that is a measurement entry interface, and includes validation and/or guidelines based on administrator-entered criteria. A Data Table provides non-graphical views into all inputs within a given data range. Controls are provided to update and delete data. A control bar allows users to customize charts by specifying date ranges and/or report types (line graph, bar char, pie graph, etc.). Also, chart functions include export report, full screen view, print report, etc. A report summary is generated that is displayed on a dedicated page or is used discretionally throughout the site. Report summary widgets provide tailored statistics based on aggregate data.

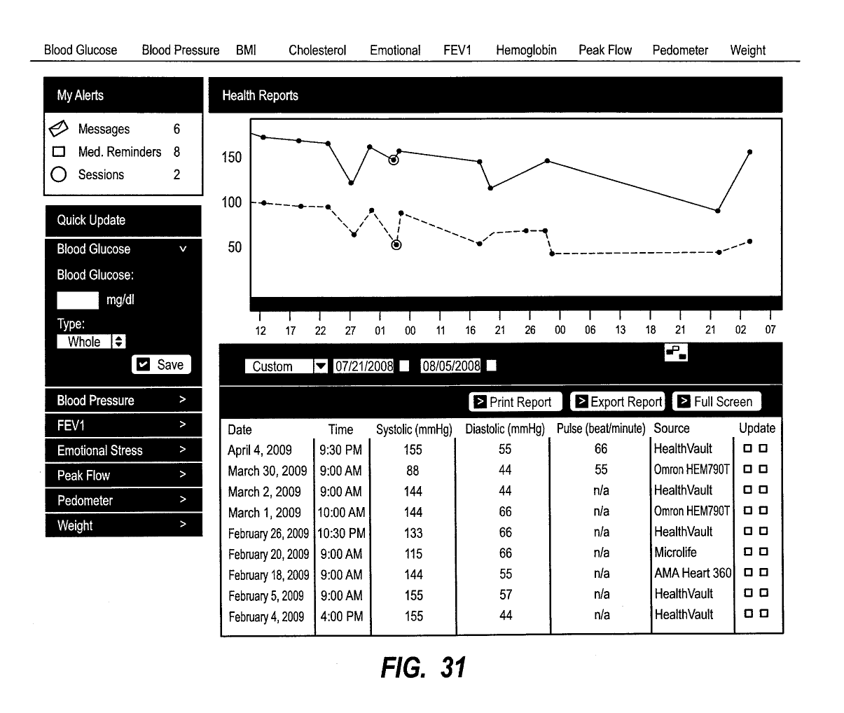

FIG. 31 is a screen shot of a health reports and report summary, in accordance with one embodiment of the present invention. The Health Reports section is a native-HealthVault feature which allows patients to record and display device measurements and/or Health Programs data. Reports are presented in graphical and tabular format and include a number of controls to manage, sort and add data. Risk ranges are drawn from preset system configurations. As shown, readings for blood pressure levels are shown for the year 2009, both in graph form, and in tabular form listing all the individual entries.

The following controls are available within Health Reports. For instance, the Enter New Data control gives patients, not participating in related surveys or not having a supported device, the option of manually recording data. A layer of validation prevents users from adding suspect or erroneous data. This feature is not available to Health Team members other than the Patient. The date select control evaluates data and spots trends over periods of time. Users can select from preset ranges (e.g., 30, 60 days, 1 month, etc.) or by using the interactive calendar functionality, create a custom range. The Print Report control allows for printing of reports to a printer-friendly format (e.g., Adobe .pdf file). The export report control allows for the export of a report. The report is exported in a friendly format (e.g., CSV, Excel-friendly format) and includes all data within the specified report and date range.

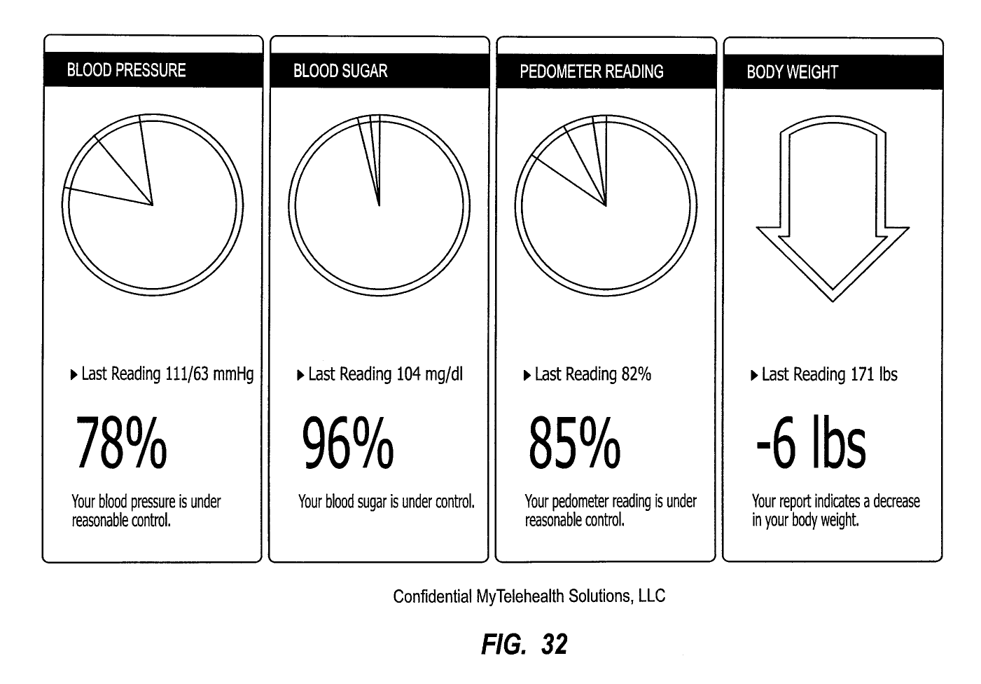

FIG. 32 is a screen shot of a report summary, in accordance with one embodiment of the present invention. The report summary provides a bird's-eye view of the Patient's reports, and can be displayed within the Patient's Dashboard. In one embodiment, reports are based on alert levels from the last 30 days. In addition, session summaries are also available within the Report Summary. As shown in FIG. 26, summaries of blood pressure, blood sugar, pedometer readings, and body weight are presented in a visual format that quickly summarizes findings.

As another feature, the Quick Update widget is designed for Patients who use the Healthy Circles Platform as the primary means of entering Health Reports data. Within the Control Panel, users can elect which reports they wish to assign to the Quick Update widget. The entry forms will then appear stacked in a persistent widget to the left of their dashboard.

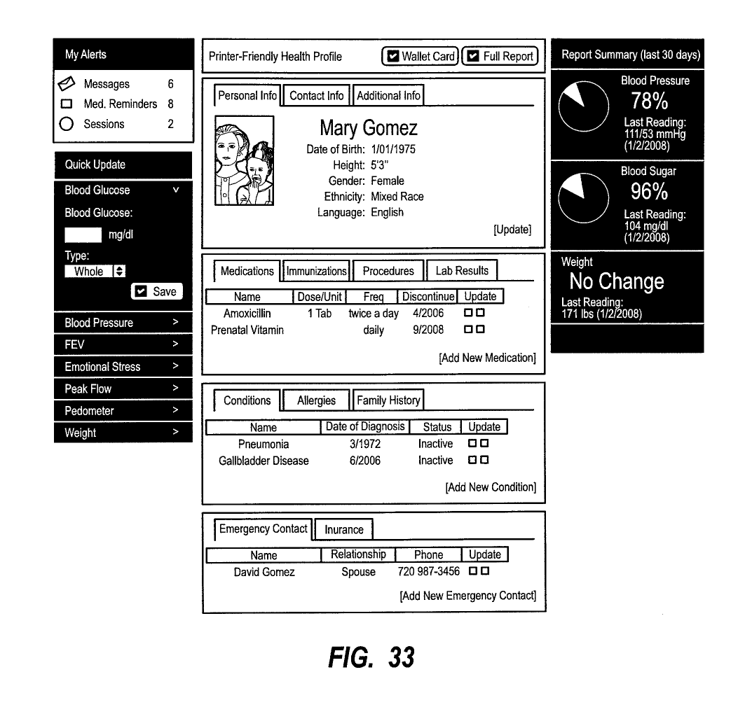

FIG. 33 is a screen shot of a health profile and quick update for a particular patient, Mary Gomez, in accordance with one embodiment of the present invention. The Health Profile, a native-HealthVault feature, provides the Patient with an interactive Personal Health Record (PHR). By way of tools available within the health profile feature, users can view, update, and share health-related information.

For instance, through a series of interactive panels, users can manage the following groups of data: Personal Information, Contact Information, Additional Information, Medications, Immunizations, Procedures, Lab Results, Emergency Contact, and Insurance. These interfaces, when managed, make immediate calls to HealthVault where the data is updated in real-time, in one embodiment.

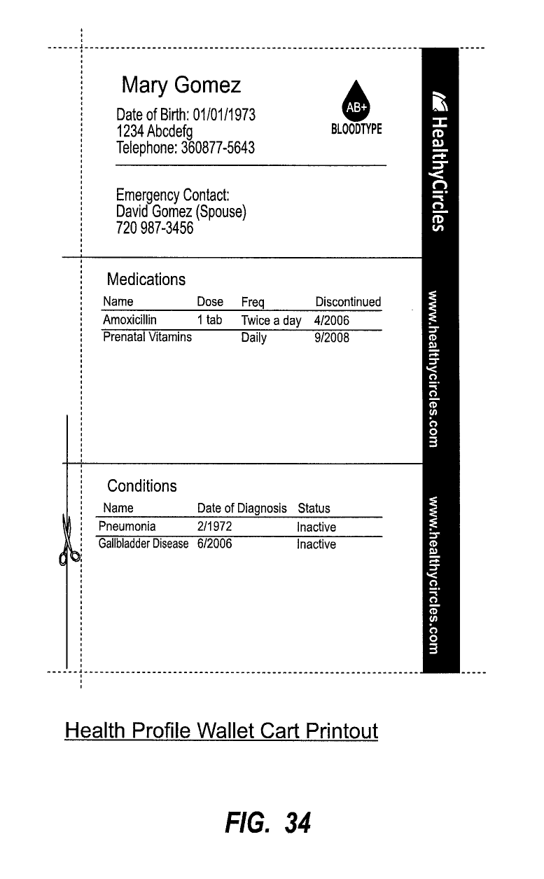

The PHR section includes the ability to create customized printer-friendly exports. These are available in both full page as well as wallet card format, as shown in FIG. 34. The wallet cards provide HCP contact information for Mary Gomez, as well as medications taken, and conditions associated with Mary Gomez.

The document manager feature allows users to upload and manage health-related documents. When added, documents can be defined by Name, Description and Category. Document data is stored and retrieved courtesy of HealthVault. Example formats that are supported, include, but are not limited to, the following: .avi, .bmp, .ccd, .ccr, .cda, .doc, .docm, .docx, .gif, .jpg, .mp3, .one, .pdf, .png, .ppsm, .ppsx, .ppt, .pptm, .pptx, .pub, .rpmsg, .rtf, .tif, .tiff, .txt, .vsd, .wav, .wma, .wmv, .xls, .xlsb, .xlsm, .xlsx, .xml, and .xps. In one embodiment, the maximum supported file size is 2 MB.

The Patient Control Panel allows Patient-portal users to set preferences (e.g. Measurement units) as well as to assign Health Reports and related settings. For instance, the Patient Control Panel allows Patients to invite and manage members of their Health Team. These are Users within the system that are directly associated with their profile, and can include FCGs or Personal HCPs.

As such, Patients can add members by way of invitation during Enrollment or in the Control Panel. The invitation process requires an email address for each FCG or Personal HCP, in one embodiment. The system will send an email with information about the Healthy Circles Platform, the Health Program chosen by the patient, and instructions with a link to a page with a User Agreement. Upon acceptance of the FCG or Personal HCP User Agreement, they may accept the Patient's invitation to participate in their Healthy Circles Platform Circle of Care. If the FCG or HCP is already registered on the Healthy Circles Platform, they simply log in with their User ID and Password, and the new Patient will be added to their list of Healthy Circles Platform Patients. First time FCGs and Personal HCPs will be presented with the Healthy Circles Platform Registration Site.

Health Team members, when opting-in to the invitation, can also specify if they wish to receive alerts through the Care Coordination Message Center, in one embodiment. Alerts can include alerts to responses in the Patient Sessions as well as missed medications and/or missed Sessions.

Patients, at any time, can remove Health Team Members from their profile, in one embodiment. Health Team Members can also opt-out of Patient associations. Either action will trigger a message to the remaining Health Team Members using the Care Coordination Message Center.

Also within the Patient Control Panel is the Report Specifications feature. As such, users can set preferences related to their Health Reports. This includes the ability to configure which reports appear under the Health Reports area, as well as the Quick Update and Report Summary widgets. Users can also set a Report as the default report which will load once the Health Reports tab is clicked.

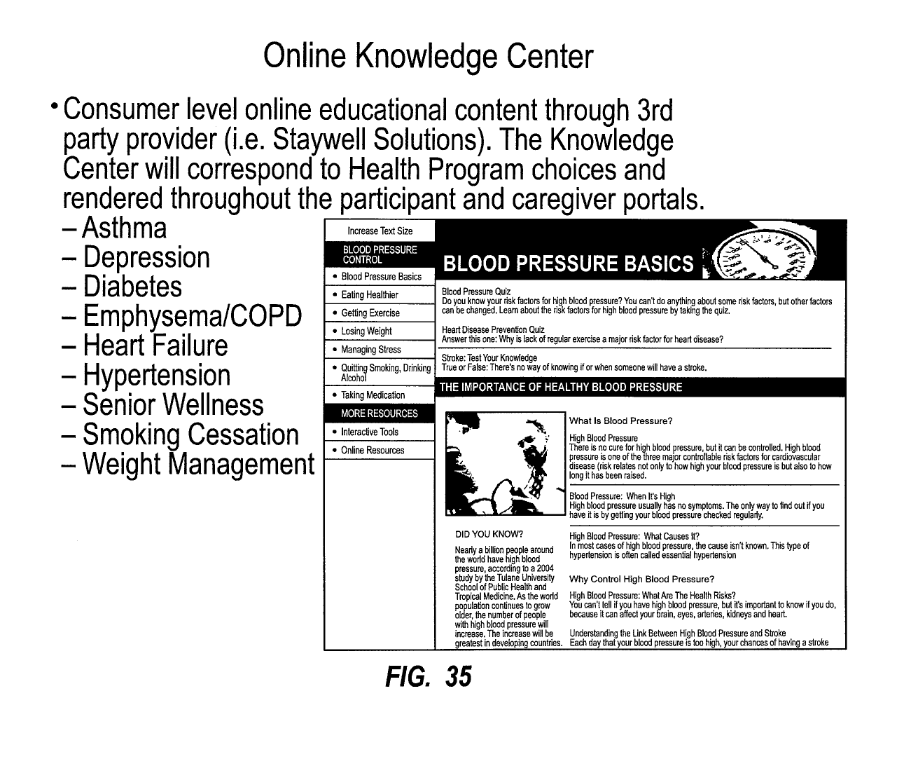

As an added feature, the Knowledge Center provides consumer level educational content through a third-party provider. The Knowledge Center can be available within the Patient/FCG and Personal HCP portals. In addition, the knowledge Center can correspond to Health Program choices and be rendered throughout the participant and caregiver portals. Content can also be displayed pervasively throughout the participant and caregiver portals and/or linked from Health Program Patient Sessions. As examples, educational content could include the following topics: asthma, depression, diabetes, emphysema/COPD, heart failure, hypertension, senior wellness, smoking cessation, and weight management, to name a few. FIG. 35 is a screen shot of content providing information about blood pressure basics, as an example of the information contained within the Knowledge Center, in accordance with one embodiment of the present invention.

Also, in another embodiment, Gadgets (e.g., supported by Windows Vista) and Widgets (e.g., supported by Mac OSX) are designed to offer Healthy Circles Platform services to Patients in their desktop environment. Both applications would require sign-on and would offer the following features: Sessions, Health Reports & Medication Reminders.

### Features of the Public Portal

The public portal is available to individuals who are not subscribers to the Healthy Circles Platform. General information and services are available to participants through the public portal.

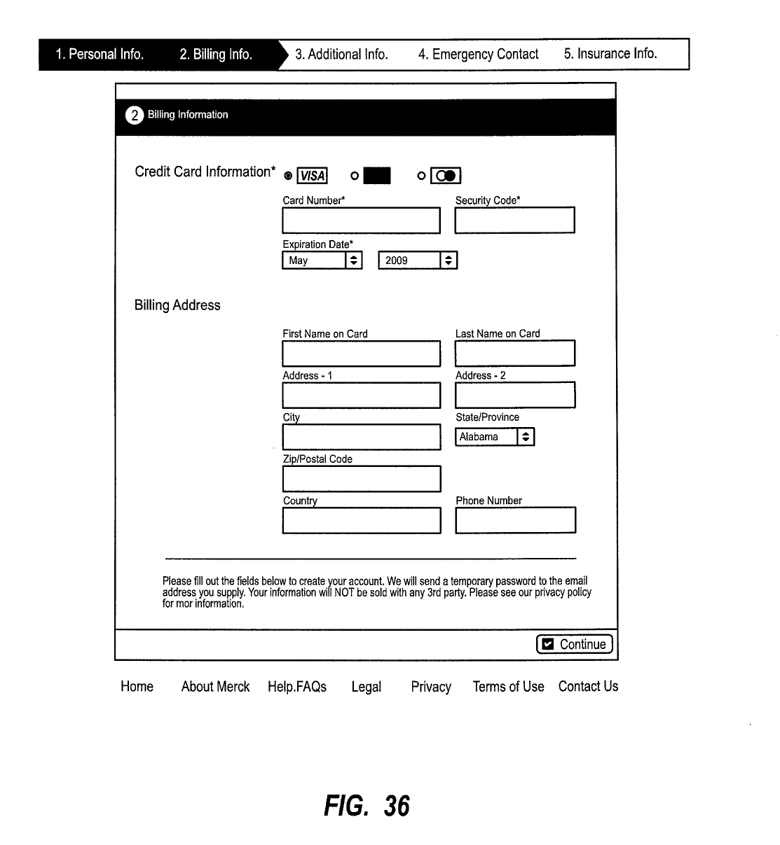

FIG. 36 is a screen shot of a registration interface, in accordance with one embodiment of the present invention. This section is available to new users courtesy of the Public Portal. These forms, however, are also available within the HCP Portal to allow for HCPs to pre-register Patients. The Registration and Enrollment screens can be in a wizard-style interface, alerting the user to which step of the process they are engaging.

In another embodiment, based on an institution's enterprise-level agreement, they may wish to offer promotional prices (up to 100% off) to the prices of new accounts. These can be offered through coupons, as examples.

As contemplated in one embodiment, during the enrollment process the Member will need to create an account with HealthVault or sign into HealthVault to synch their HealthVault data with the Healthy Circles application.

In addition, for members or subscribers, the member gateway will be divided into two separate areas—Patient/FCG Users and HCP Users. Patient/FCG Users will be directed to a HealthVault sign-in page. On the other hand, HCP Users will be directed to a Healthy Circles-proprietary sign-in form. Based on user credentials, the gateway will determine the user type and redirect them to the HCP Portal—permissions intact.

As previously described, public content is available, within the Public Portal, to all users, including unauthenticated, anonymous users. The intention of the public content is to promote and inform potential users (Members or Institutional) of Healthy Circles, also referred to as the Healthy Circles Platform. For instance, promotional material will direct users to a registration lead-in page where they will be briefed on the registration process and offered a link to continue. The Public Website also acts as the front door into the authenticated areas, in one embodiment.

As contemplated in one example, included in this area of the project are the following: Home page; 4-8 content pages; 2-5 minute product demo in various formats; Member sign in page; Registration lead-in; Help/FAQs; Terms of use/Privacy agreement, etc.

### Features of the Admin Portal

The Healthy Circles Admin Portal provides the Super Admin user with the ability to set system-wide specifications, create/manage users and monitor activity. In one case, as the Healthy Circles Platform itself has its own Institutional site, the Super Admin User would also have access to the majority of tools of the HCP Control Panel.

The following tools are available within the Admin Portal. The User Manager tool allows for the creation and management of administrative users. For instance, User groups and permissions are managed here. The Instance Manager tool is related to institutions, and provides an interface where super-users can assign and activate/deactivate private label-instances. The System Tracking Tools provides for tracking statistics relating to on site-usage and activity. The Control Panel Utilities tool is related to system performance and maintenance (e.g., CPanel-like utilities).

### Technical Specifications

As contemplated in embodiments, the following specifications outline the technical requirements of the Healthy Circles Platform. Scripting languages supported include, in part: .NET/C#; Adobe Flex; JavaScript (jQuery); HTML; and CSS, etc. The database platforms supported include, in part: the SQL Server; and HealthVault, etc. The supported web browsers include, in part: Internet Explorer Version 6.0 or higher; Mozilla; Safari Version 2.0 or higher, etc. The supported mobile phone service providers include, in part: AT&T; T-Mobile; Verizon; Sprint, etc. The supported mobile phone hand sets, include, in part: Windows Mobile; iPhone; Blackberry; Palm, etc.

### A Working Example of the Healthy Circles Platform Used for Monitoring a Disease

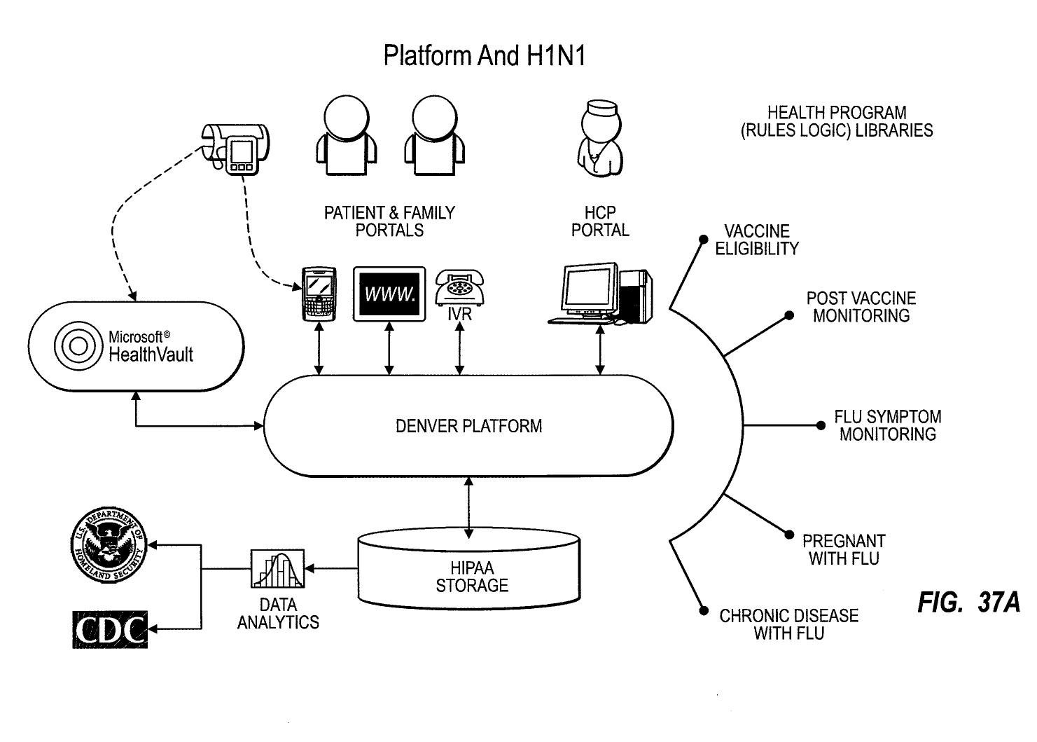

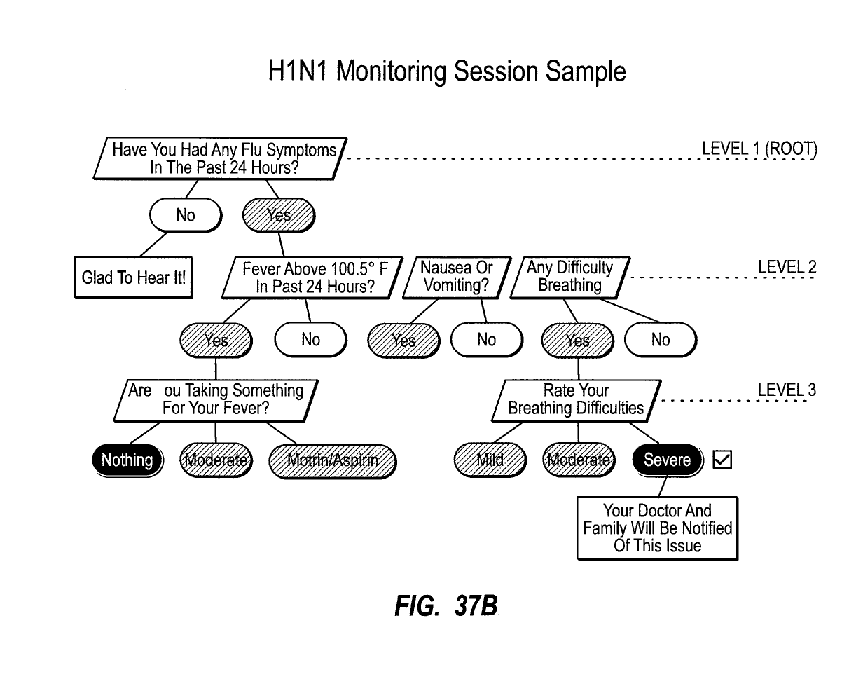

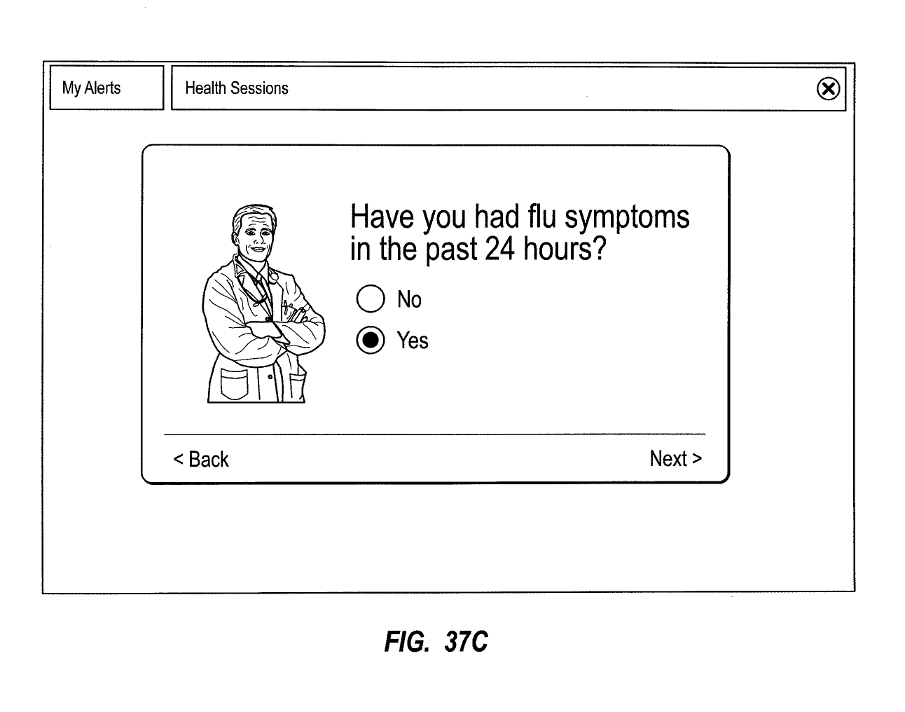

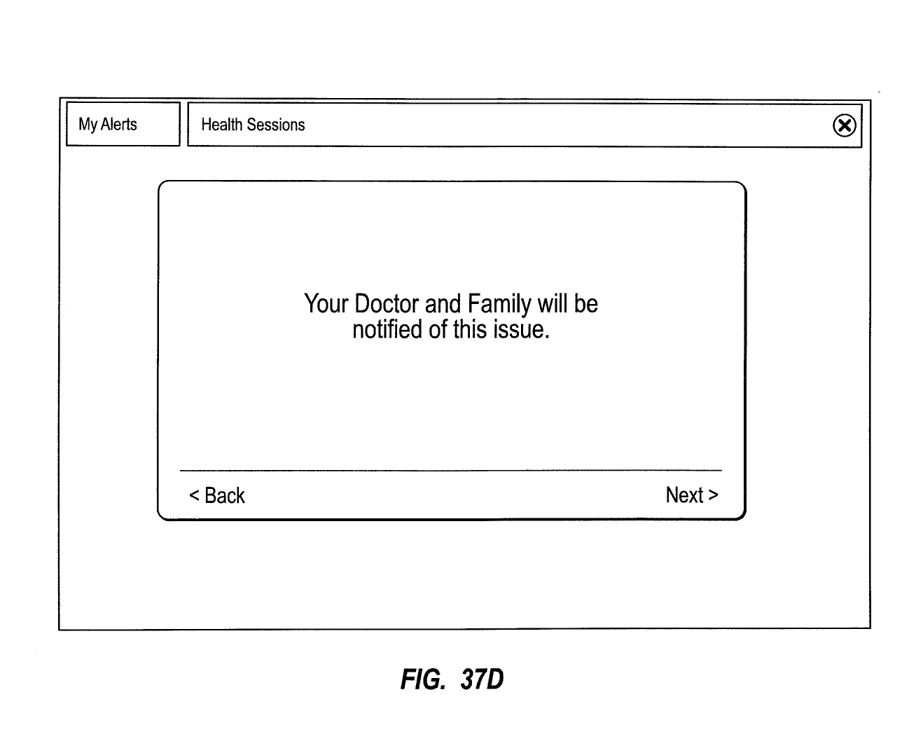

FIGS. 37A-D are illustrations of a system for implementing a disease monitoring system, in accordance with one embodiment of the present invention. As shown, the Healthy Circles Platform is ideally suited to monitoring the health and condition of the public at large. As a representative example, the progress of a flu during the flu season (e.g., H1N1 flu) can be monitored for a community using the Healthy Circles Platform.

FIG. 37A is an illustration of the Healthy Circles Platform configured to support the monitoring of the public's health and condition. The portals can be configured to allow individuals within the general public to access the Healthy Circles Platform. For instance, in one embodiment, a portal can exist through kiosks available to the general public. As such, the public is invited to participate in a program that is tailored to determining the condition of the participant, and specifically, if he or she is suffering from the flu. As shown, FIG. 37A includes portals for the public, individuals, and HCP. In addition, storage is provided for storing the results of the responses obtained from executing the program. Further, data analytics can be performed on the responses and results, and this analysis can be further provided to government and private agencies or entities.

As shown in FIG. 37A, depending on the participant, a variety of programs are offered that are related to tracking the spread of the flu. For instance, programs addressing issues related to vaccine eligibility, post vaccine monitoring, flu symptom monitoring, pregnancy with flu like symptoms, and chronic disease with the flu are just some of the programs available.

FIG. 37B illustrates a query group from a session that is monitoring for whether the participant has contracted the flu. For instance, questions in the logic tree ask whether the participant has had flu like symptoms recently, as is shown in the screen shot of FIG. 37C. The tree accommodates for special conditions, such as identifying when the participant is in extreme health danger to himself or to the public. For instance, when the participant indicates that he or she has breathing issues, the program is able to identify that condition, label it as being severe, and promptly notify that participant's doctor and corresponding FGCs. As an example, FIG. 37C is a screen shot presented to the participant indicating and notifying the participant that the doctor and FCGs will be notified.

### Social Networking Using the Healthy Circles Platform

The Healthy Circles Platform is well suited to supporting a social network of participants that are all participating within the context of a program. For instance, within a wellness program, a group or social network of participants may be part of a dieting group. All the participants in the group help each other through the dieting process. The Healthy Circles Platform is capable of supporting this support group. For instance, participants within the group all must execute or interface with a program tailored to monitoring the dieting process. For example, the program may ask whether the participant is within his or her maximum daily caloric intake. Results of queries in the program are available to all participants within the social network. As such, if one participant is not following the dieting guidelines, those program responses and results will be apparent to all the participants in the social network. As such, the other participants in the support group will be able to provide support and help the wayward participant get back on the dieting track.

This social network application of the Healthy Circles Platform is extendable to any type of activity or goal. For instance, a social network may utilize the Healthy Circles Platform for helping the social network achieve weight lifting goals. Another activity could help a social network plan for events using the Healthy Circles Platform, or to keep on track for project timelines in a work, social, or education environment, etc.

A system and method for an online platform distributing condition specific programs used for monitoring the health of a participant and for offering health services to participating subscribers is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A method for monitoring, comprising:
receiving a request for a health program over a communication network by a network access device associated with a participant, wherein said health program comprises a rules based logic tree used for purposes of monitoring a condition;
providing said health program to said network access device;
receiving one or more responses from said network access device;
determining a result based on said one or more responses to said at least one interactive logic tree; and
providing said one or more responses and said result to a monitoring agent.

2. The method of claim 1, further comprising:
accessing said program from a library of programs, each of which comprises a corresponding rules based logic tree used for purposes of monitoring a corresponding condition.

3. The method of claim 1, further comprising:
integrating said one or more responses and said result into a health record associated with said participant;
storing said health record; and
providing access to said health record to members of a health care team providing care to said participant.

4. The method of claim 1, further comprising:
performing an action based on said result.

5. The method of claim 4, further comprising:
determining a risk level of said condition based on said result; and
performing said action by alerting said monitoring agent of said result if said risk level is high.

6. The method of claim 4, further comprising:
determining an instruction used for treating said condition based on said result; and
sending said instruction to said network device associated with said participant.

7. The method of claim 1, further comprising:
assigning said health program by said monitoring agent to said participant for purposes of monitoring said participant.

8. The method of claim 1, further comprising:
sending a prompt to said participant to perform said health program.

9. The method of claim 1, further comprising:
receiving a second request for said health program by a second network access device associated with a second participant;
providing said health program to said second network access device;
receiving one or more responses from said second network access device;
determining a second result based on said one or more responses from said second network access device;
determining a first risk level of said condition for said participant based on said result;
determining a second risk level of said condition for said second participant based on said second result;
prioritizing said first risk level and said second level according to risk; and
listing said result and said second result by priority of risk.

10. The method of claim 1, further comprising:
receiving a second request for said health program by a second network access device associated with a second participant, wherein said health program is used for monitoring said condition comprising one or more symptoms of an infectious disease;
providing said health program to said second network access device;
receiving one or more responses from said second network access device;
determining a second result based on said one or more responses from said second network access device.

11. The method of claim 10, further comprising:
reporting said result and said second result to said monitoring agent comprising a government agency.

12. A platform for providing medical information, comprising:
a records manager for managing a first health record of a patient, wherein said records manager obtains information used in said first health record from at least one of a plurality of information sources related to said patient and members of a health care team providing care to said patient;
a data store for storing said first health record; and
a data exchange hub for providing access to said first health record to said patient and said members of said health care team.

13. The platform of claim 12, further comprising:
a translator for translating information in said first record into a common format, wherein said data stores said information in said first record using said common format.

14. The platform of claim 13, wherein said plurality of information sources is taken from a group consisting essentially of:
a first information source related to a member of said health care team sending said information to said records manager;
a second information source related to a member of said health care team sending said information upon request by said records manager;
a third information source related to said patient sending said information; and
a fourth information source comprising a device monitoring a condition of said patient.

15. The platform of claim 13, further comprising:
said records manager for managing a second health record of said patient, wherein said records manager obtains (receives or accesses) information used in said second health record from at least one of said plurality of information sources;
wherein said translator translates information used in said second health record into said common format, wherein said data store stores said information in said second health record using said common format.

16. The platform of claim 12, further comprising:
a program manager for providing access to a first health program by said patient, wherein said first health program comprises at least one corresponding interactive logic tree used for purposes of monitoring a first condition, wherein said at least one corresponding interactive logic tree reaches a first result based on one or more responses by said patient; and
an information integration engine for integrating said information comprising said one or more responses and said first result into said health record.

17. The platform of claim 16, further comprising:
said program manager for providing access to a second health program by said patient, wherein said second health program comprises at least one corresponding interactive logic tree used for purposes of monitoring a second condition, wherein said at least one corresponding interactive logic tree of said second health program reaches a second result based on responses by said patient to said second health program, and wherein said one or more response and said second result is included as information in said health record; and
a library coupled to said program manager for storing a plurality of health programs, including said first and second health programs.

18. The platform of claim 16, further comprising:
said program manager for providing access to said first health program by a second patient, wherein completion of said first health program by said second patient reaches a second result;
a priority engine for assigning a risk level to corresponding results achieved by said first and second patient when performing said first health program, and for prioritizing said corresponding results according to risk;
a triage dashboard for listing said corresponding results by priority of risk.

19. The platform of claim 16, further comprising:
an action module for performing an appropriate action in response to said first result.

20. The platform of claim 12, further comprising:
said records manager for managing a plurality of health records of a plurality of patients, wherein said plurality of health records comprises information related to conditions of said plurality of patients;
said data store for storing said plurality of health records;
a monitoring module for monitoring corresponding conditions of said plurality of patients;
a risk analysis module for assigning a risk level to corresponding conditions of said plurality of patients;
a priority engine for assigning a risk level to corresponding conditions of said plurality of patients; and
a triage dashboard for listing said corresponding conditions by priority of risk.

21. The platform of claim 20, further comprising:
a notification module for notifying a monitoring agent of said first result.

22. A system for monitoring, comprising:
a first network access device providing access to a communication network, said first network access device associated with a user;
a second network access device providing access said communication network, said second network access device associated with a monitoring agent;
a library of health programs for use in monitoring users;
a health program in said library of health programs assigned to said user, said program comprising at least one interactive logic tree used for purposes of monitoring a condition, wherein said at least one interactive logic tree reaches a result based on one or more responses by said user;
a data exchange hub providing access and control over said library of programs through said communication network, wherein said user accesses said program through said data exchange hub for purposes of interaction, and wherein said monitoring agent accesses said result and said one or more responses through said data exchange hub;
a data store for storing responses and results of said user in association with said program; and
an action module for performing an appropriate action based on said result.

23. The system of claim 22, wherein said library of programs includes a program for monitoring performance of said user.

24. The system of claim 22, wherein said result is grouped into one of a plurality of risk levels, comprising:
a low risk;
a medium risk; and
a high risk.

25. The system of claim 22, wherein said action module comprises a notification engine for notifying said monitoring agent of said result

26. The system of claim 22, wherein said data exchange hub further comprises:
an information integration engine for integrating said result into a health record of said user.

27. The system of claim 22, wherein said central platform further comprises:
a reminder engine for sending out a reminder to said first network access device that interaction with said health program by said user is overdue.

28. The system of claim 22, further comprising:
a third party content provider capable of accessing said data exchange hub for providing content within said health program.

29. The system of claim 28, wherein said content comprises advertising.
